(19) United States
(12) Patent Application Publication
(10) Pub. No.: US 2019/0328004 A1
(43) Pub. Date: Oct. 31, 2019

(54) METAL CHELATES AND COMPOSITIONS COMPRISING METAL CHELATES AS NUTRITIONAL AND/OR ANTIMICROBIAL COMPOSITIONS FOR ADMINISTRATION TO ANIMALS

(71) Applicants: Bruce Johnson, Teaneck, NJ (US); Kenneth W. Bafundo, Teaneck, NJ (US)

(72) Inventors: Bruce Johnson, Teaneck, NJ (US); Kenneth W. Bafundo, Teaneck, NJ (US)

(21) Appl. No.: 16/386,718

(22) Filed: Apr. 17, 2019

Related U.S. Application Data
(60) Provisional application No. 62/664,878, filed on Apr. 30, 2018.

(51) Int. Cl. A23K 20/105; A23K 20/163; A23K 20/28; A23K 20/189; A23K 20/147; A23K 10/30; A23K 10/18

(52) U.S. Cl. CPC A23K 20/105; A23K 20/163; A23K 20/28; A23K 10/18; A23K 20/147; A23K 10/30; A23K 20/189

(57) ABSTRACT

Disclosed herein are embodiments of a metal chelate, and compositions and/or combinations comprising the same. Also disclosed are embodiments of a method for making the metal chelate and a method for using the metal chelate. In some embodiments, the metal chelate is administered to an animal.

### CROSS REFERENCE TO RELATED APPLICATION

This application claims the benefit of U.S. Provisional Application No. 62/664,878, filed Apr. 30, 2018, which is incorporated herein by reference in its entirety.

### FIELD

The present disclosure concerns metal chelates for administration to an animal.

### BACKGROUND

Although only present in trace amounts, the presence of trace elements, such as metals in livestock species, significantly contributes to many biochemical and physiological processes. Prior studies have shown that the metal concentration gradients in different biological cells correlate with the general health of an animal and its resistance to certain diseases. However, absorption of these metals by the biological cells of the animals through dietary intake remains insufficient.

Furthermore, there also is a need for new antimicrobial compositions, particularly in view of the current increased microbial resistance to vaccines and in view of the continuing desire by consumers for antibiotic free meat products.

### SUMMARY

Presently disclosed embodiments address the need to alleviate metal deficiencies of animals, while simultaneously or alternatively inhibiting microbial growth, using compositions and/or combinations comprising disclosed metal complexes.

The foregoing and other objects, features, and advantages of the invention will become more apparent from the following detailed description.

### DETAILED DESCRIPTION

### I. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

When chemical structures are depicted or described, unless explicitly stated otherwise, all carbons are assumed to include sufficient hydrogen moieties in addition to any other moieties present, so that each carbon conforms to a valence of four.

A person of ordinary skill in the art will appreciate that compounds may exhibit the phenomena of tautomerism, conformational isomerism, geometric isomerism, and/or optical isomerism. For example, certain disclosed compounds can include one or more chiral centers and/or double bonds and as a consequence can exist as stereoisomers, such as double-bond isomers (i.e., geometric isomers), enantiomers, diasteromers, and mixtures thereof, such as racemic mixtures. As another example, certain disclosed compounds can exist in several tautomeric forms, including the enol form, the keto form, and mixtures thereof. As the various compound names, formulae and compound drawings within the specification and claims can represent only one of the possible tautomeric, conformational isomeric, optical isomeric, or geometric isomeric forms, a person of ordinary skill in the art will appreciate that, unless otherwise specified, the disclosed compounds encompass any tautomeric, conformational isomeric, optical isomeric, and/or geometric isomeric forms of the compounds described herein, as well as mixtures of these various different isomeric forms. In cases of limited rotation, e.g. around an amide bond, atropisomers are also possible and are also specifically included in the compounds of the invention.

Administering: Administration by any route to a subject. As used herein, administration typically but not necessarily refers to oral administration.

Aliphatic: A substantially hydrocarbon-based group or moiety. An aliphatic group or moiety can be acyclic, including alkyl, alkenyl, or alkynyl groups, cyclic versions thereof, such as cycloaliphatic groups or moieties including cycloalkyl, cycloalkenyl or cycloalkynyl, and further including straight- and branched-chain arrangements, and all stereo and position isomers as well. Unless expressly stated otherwise, an aliphatic group contains from one to twenty-five carbon atoms (C₁₋₂₅); for example, from one to fifteen (C₁₋₁₅), from one to ten (C₁₋₁₀) from one to six (C₁₋₆), or from one to four carbon atoms (C₁₋₄) for an acyclic aliphatic group or moiety. A person of ordinary skill in the art will understand that for an alkenyl or alkynyl moiety, the minimum number of carbon atoms is two. And for a cyclic aliphatic group or moiety, the number of carbon atoms must be at least three, such as from three to fifteen (C₃₋₁₅) from three to ten (C₃₋₁₀), from three to six (C₃₋₆), or from three to four (C₃₋₄) carbon atoms. An aliphatic group may be substituted or unsubstituted, unless expressly referred to as an “unsubstituted aliphatic” or a “substituted aliphatic.” An aliphatic group can be substituted with one or more substituents (up to two substituents for each methylene carbon in an aliphatic chain, or up to one substituent for each carbon of a —C═C— double bond in an aliphatic chain, or up to one substituent for a carbon of a terminal methine group).

Aromatic: A cyclic, conjugated group or moiety of, unless specified otherwise, from 5 to 15 ring atoms having a single ring (e.g., phenyl, or pyridinyl) or multiple condensed rings in which at least one ring is aromatic (e.g., indolyl), that is at least one ring, and optionally multiple condensed rings, have a continuous, delocalized π-electron system. Typically, the number of out of plane π-electrons corresponds to the Hückel rule (4n+2). The point of attachment to the parent structure typically is through an aromatic portion of the condensed ring system. For example,

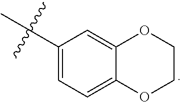 [SMILES: *c1ccc2c(c1)OCCO2]

However, in certain examples, context or express disclosure may indicate that the point of attachment is through a non-aromatic portion of the condensed ring system. For example

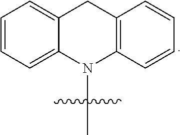 [SMILES: *N1c2ccccc2Cc2ccccc21]

An aromatic group or moiety may comprise only carbon atoms in the ring, such as in an aryl group or moiety, or it may comprise one or more ring carbon atoms and one or more ring heteroatoms comprising a lone pair of electrons (e.g. S, O, N, P, or Si), such as in a heteroaryl group or moiety. Unless otherwise stated, an aromatic group may be substituted or unsubstituted.

Aryl: An aromatic carbocyclic group of, unless specified otherwise, from 6 to 15 carbon atoms having a single ring (e.g., phenyl) or multiple condensed rings in which at least one ring is aromatic (e.g., benzodioxolyl). If any aromatic ring portion contains a heteroatom, the group is heteroaryl and not aryl. Aryl groups may be, for example, monocyclic, bicyclic, tricyclic or tetracyclic. Unless otherwise stated, an aryl group may be substituted or unsubstituted.

Amino acids: An organic acid containing both an amino group (—NH₂) and a carboxylic acid group (—COOH). The 20 amino acids that are naturally occurring protein constituents are α-amino acids, i.e., the —NH₂ group is attached to the carbon atom next to the —COOH group.

Antimicrobial: An agent that kills and/or inhibits the growth of microorganisms. As used herein, antimicrobials include antibiotics, antifungals, antivirals, and antiparasitics, including without limitation anticoccidials, or combinations thereof.

Binding agent or binder: A material or substance that is used to hold or draw together other materials to form a cohesive unit.

Carrier: A substance that is used as an additive in (or with) a combination, composition, or component as disclosed herein. As used herein, a carrier may be incorporated within particles of a combination, composition, or component, or it may be physically mixed with particles of a combination, composition, or component. A carrier can be used, for example, to modify non-biological properties of a combination or composition, such as flowability, stability during storage, exposure to moisture, etc. Examples of carriers are included herein.

Chelate: A chemical compound comprising a metal ion and a chelator (also referred to as chelating agent).

Co-administration: Administering two or more agents simultaneously or sequentially in any order to a subject to provide overlapping periods of time in which the subject is experiencing effects, beneficial and/or deleterious, from each agent. For example, if administration of a first agent results in deleterious side effects, as second agent may be administered to reduce and/or substantially prevent or inhibit those side effects. One or both of the agents may be a therapeutic agent. The agents may be combined into a single composition or dosage form, or they may be administered simultaneously or sequentially in any order as separate agents.

Colony forming units (CFU): “Colony forming units” refers to individual colonies of bacteria. A colony is a mass of individual bacteria growing together. For certain embodiments, a colony comprises substantially the same species, and may comprise, but does not necessarily comprise, substantially the same strain. CFU are a measure of the number of bacteria present in or on a surface of a sample. However, CFU is not necessarily a measure of individual cells or spores, as a colony may be formed from a single or a mass of cells or spores.

Combination: A combination includes two or more components that are administered such that the effective time period of at least one component overlaps with the effective time period of at least one other component. A combination, or a component thereof, may be a composition. In some embodiments, effective time periods of all components administered overlap with each other. In an exemplary embodiment of a combination comprising three components, the effective time period of the first component administered may overlap with the effective time periods of the second and third components, but the effective time periods of the second and third components independently may or may not overlap with one another. In another exemplary embodiment of a combination comprising three components, the effective time period of the first component administered overlaps with the effective time period of the second component, but not that of the third component; and the effective time period of the second component overlaps with those of the first and third components. A combination may be a composition comprising the components, a composition comprising one or more components and another separate component (or components) or composition(s) comprising the remaining component(s), or the combination may be two or more individual components. In some embodiments, the two or more components may comprise the same component administered at two or more different times, two or more different components administered substantially simultaneously or sequentially in any order, or a combination thereof.

Bacilli Combination: Refers to a combination, or a composition, such as a direct fed microbial (DFM) comprising a combination of Bacillus species. In certain embodiments, the Bacillus species comprises particular combinations of bacilli, such as Bacillus amyloliquefaciens, Bacillus subtilis, Bacillus licheniformis and Bacillus coagulans, and combinations thereof. In some disclosed embodiments, “Bacilli combination” refers to a composition for administration to a subject, particularly to an animal, including without limitation, mammals, avians (such as chickens and turkeys), and aquatic species, that consists of or consists essentially of any three or four of Bacillus amyloliquefaciens, Bacillus subtilis, Bacillus licheniformis and Bacillus coagulans. In other embodiments, “Bacilli combination” refers to Bacillus amyloliquefaciens, Bacillus subtilis, Bacillus licheniformis and Bacillus coagulans administered in combination without any other DFMs. A person of ordinary skill in the art will understand that the Bacilli combination may include additional residual material that is carried over from the production of any or all of the three or four Bacillus species, such as a dry milk product, and/or a carrier that does not materially affect the structure, function, novel and/or basic features of the Bacillus species.

CSL Combination: Refers to a combination, or a composition, of DFMs including only Bacillus coagulans, Bacillus subtilis and Bacillus licheniformis. In some disclosed embodiments, “CSL combination” refers to a composition for administration to a subject, particularly to an animal, and even more particularly to an avian, such as chickens and turkeys, that consists of or consists essentially of Bacillus coagulans, Bacillus subtilis and Bacillus licheniformis. In other embodiments, “CSL combination” refers to Bacillus coagulans, Bacillus subtilis and Bacillus licheniformis administered in combination without any other DFMs. A person of ordinary skill in the art will understand that the CSL combination may include additional residual material that is carried over from the production of any or all of the three Bacillus species, such as a dry milk product, and/or a carrier that does not materially affect the structure, function, novel and/or basic features of the three Bacillus species.

ASL Combination: Refers to a combination, or a composition, of DFMs including only Bacillus amyloliquefaciens, Bacillus subtilis and Bacillus licheniformis. In some disclosed embodiments, “ASL combination” refers to a composition for administration to a subject, particularly to an animal, and even more particularly to an avian, such as chickens and turkeys, that consists of or consists essentially of Bacillus amyloliquefaciens, Bacillus subtilis and Bacillus licheniformis. In other embodiments, “ASL combination” refers to Bacillus amyloliquefaciens, Bacillus subtilis and Bacillus licheniformis administered in combination without any other DFMs. A person of ordinary skill in the art will understand that the ASL combination may include additional residual material that is carried over from the production of any or all of the three Bacillus species, such as a dry milk product, and/or a carrier that does not materially affect the structure, function, novel and/or basic features of the three Bacillus species.

ASLC Combination: Refers to a combination, or a composition, of DFMs including only Bacillus amyloliquefaciens, Bacillus subtilis, Bacillus licheniformis and Bacillus coagulans. In some disclosed embodiments, “ASLC combination” refers to a composition for administration to a subject, particularly to an animal, and even more particularly to an avian, such as chickens and turkeys, that consists of or consists essentially of Bacillus amyloliquefaciens, Bacillus subtilis, Bacillus licheniformis and Bacillus coagulans. In other embodiments, “ASLC combination” refers to Bacillus amyloliquefaciens, Bacillus subtilis, Bacillus licheniformis and Bacillus coagulans administered in combination without any other DFMs. A person of ordinary skill in the art will understand that the ASLC combination may include additional residual material that is carried over from the production of any or all of the four Bacillus species, such as a dry milk product, and/or a carrier that does not materially affect the structure, function, novel and/or basic features of the four Bacillus species.

Direct fed microbial: A composition that contains live and/or viable microorganisms, typically bacteria and/or yeast, that provides a beneficial effect on an animal.

Excipient or carrier: A physiologically inert substance that is used as an additive in (or with) a combination, composition, or component as disclosed herein. As used herein, an excipient or carrier may be incorporated within particles of a combination, composition, or component, or it may be physically mixed with particles of a combination, composition, or component. An excipient or carrier can be used, for example, to dilute an active agent and/or to modify properties of a combination or composition. Examples of excipients and carriers include, but are not limited to, calcium carbonate, polyvinylpyrrolidone (PVP), tocopheryl polyethylene glycol 1000 succinate (also known as vitamin E TPGS, or TPGS), dipalmitoyl phosphatidyl choline (DPPC), trehalose, sodium bicarbonate, glycine, sodium citrate, and lactose.

Effective amount: A quantity or concentration of a specified compound, composition or combination sufficient to achieve an effect in a subject.

Feed efficiency: A measure of an animal's efficiency in converting feed mass into the desired output, e.g., weight gain, milk production. Feed efficiency also may be referred to as feed conversion ratio, feed conversion rate, or feed conversion efficiency. The feed efficiency is also known in the art as the feed conversion ratio, or feed conversion rate.

Feedstuff: As used herein, the term “feedstuff” refers to anything that may be consumed by an animal. The term “feedstuff” encompasses solid and liquid animal feeds (e.g., a feed ration), supplements (e.g., a mineral supplement, a protein supplement), a premix, water, feed additive carriers (e.g., molasses), and combinations thereof.

Glucocorticoid: A class of steroid hormones that bind to the glucocorticoid receptors in vertebrate animal cells. Exemplary endogenous glucocorticoids include cortisol (hydrocortisone) and corticosterone.

Halo, halide or halogen: Fluoro, chloro, bromo or iodo.

Haloaliphatic: An aliphatic moiety substituted with one or more halogens, including haloalkyl, haloalkenyl, or haloalkynyl groups, or cyclic versions thereof. —CF₃ is an exemplary haloaliphatic moiety.

Heteroaliphatic: An aliphatic compound or group having at least one heteroatom and at least one carbon atom, i.e., one or more carbon atoms from an aliphatic compound or group comprising at least two carbon atoms, has been replaced with an atom having at least one lone pair of electrons, typically nitrogen, oxygen, phosphorus, silicon, or sulfur. Heteroaliphatic compounds or groups may be substituted or unsubstituted, branched or unbranched, chiral or achiral, and/or acyclic or cyclic, such as a cycloheteroaliphatic group.

Heteroaryl: An aromatic group or moiety of, unless specified otherwise, from 5 to 15 ring atoms comprising at least one carbon atom and at least one heteroatom, such as N, S, O, P or Si. A heteroaryl group or moiety may comprise a single ring (e.g., pyridinyl) or multiple condensed rings (e.g., indolyl). Heteroaryl groups or moiety may be, for example, monocyclic, bicyclic, tricyclic or tetracyclic. Unless otherwise stated, a heteroaryl group or moiety may be substituted or unsubstituted.

Heterocyclyl: Aromatic and non-aromatic ring systems, and more specifically a stable three- to fifteen-membered ring moiety, comprising at least one carbon atom, and typically plural carbon atoms, and at least one, such as from one to five, heteroatoms. The heteroatom(s) may be nitrogen, phosphorus, oxygen, silicon or sulfur atom(s). The heterocyclyl moiety may be a monocyclic moiety, or may comprise multiple rings, such as in a bicyclic or tricyclic ring system, provided that at least one of the rings contains a heteroatom. Such a multiple ring moiety can include fused or bridged ring systems as well as spirocyclic systems; and any nitrogen, phosphorus, carbon, silicon or sulfur atoms in the heterocyclyl moiety can be optionally oxidized to various oxidation states. For convenience, nitrogens, particularly but not exclusively, those defined as annular aromatic nitrogens, are meant to include their corresponding N-oxide form, although not explicitly defined as such in a particular example. Thus, for a compound having, for example, a pyridinyl ring, the corresponding pyridinyl-N-oxide is included as another compound of the invention, unless expressly excluded or excluded by context. In addition, annular nitrogen atoms can be optionally quaternized. Heterocycle includes heteroaryl moieties, and cycloheteroaliphatic moieties, which are heterocyclyl rings which are partially or fully saturated. Examples of heterocyclyl groups include, but are not limited to, tetrahydropyrolyl, piperidinyl, piperazinyl, pyridinyl, indolyl, and morpholinyl.

Ligand: An ion or molecule that binds to a central metal atom or ion, such as a transition metal atom or a transition metal ion, to form a chelate. Ligands (also commonly referred to herein as a chelating agent or chelator) can be further characterized as monodentate, bidentate, tridentate, tetradentate, polydentate, etc., depending upon the number of donor atoms of the ion or molecule that bind to the central atom or ion. Examples of ligands may include, but are not limited to, amino acids and alpha and beta-hydroxy acids.

Mannans: A class of polysaccharides including the sugar mannose. The mannans family includes pure mannans (i.e., the polymer backbone consists of mannose monomers), glucomannan (the polymer backbone comprises mannose and glucose), and galactomannan (mannans or glucomannan in which single galactose residues are linked to the polymer backbone). Mannans are found in cell walls of some plant species and yeasts.

Mineral Clay: According to the AIPEA (Association Internationale pour l'Etude des Argiles (International Association for the Study of Clays)) and CMS (Clay Minerals Study) nomenclature committees, the term “mineral clay” refers to a mineral that imparts plasticity to a clay and hardens upon drying or firing. Mineral clays include aluminum silicates, such as aluminum phyllosilicates. Mineral clays usually include minor amounts of impurities, such as potassium, sodium, calcium, magnesium, and/or iron.

Oligopeptides: A peptide comprising plural amino acids, such as between two and twenty amino acids. In some embodiments, oligopeptides can include, or be referred to herein as, dipeptides, tripeptides, tetrapeptides, pentapeptides, etc., or alternatively as dimers, trimers, tetramers, pentamers, etc., depending upon the number of amino acids bonded together to form the peptide linkage.

Peptide: A compound comprising two or more amino acids linked in a chain, where the carboxylic acid group of one amino acid is joined to the amino group of another amino acid by an —OC—NH— bond.

Pharmaceutically acceptable: The term “pharmaceutically acceptable” refers to a substance that can be taken into a subject without significant adverse toxicological effects on the subject, including a non-human animal subject.

Polyphenols: A class of natural, synthetic, or semisynthetic organic chemicals characterized by the presence of plural phenolic

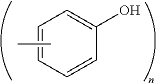

structural units.

Saponin: A class of chemical compounds, one of many secondary metabolites found in natural sources, with saponins found in particular abundance in various plant species. More specifically, they are amphipathic glycosides grouped, in terms of structure, by their composition. In certain embodiments, saponin comprises one or more hydrophilic glycoside moieties combined with a lipophilic triterpene and/or steroidal derivative.

Strain: A strain refers to two members of the same species having a discernible phenotypic and/or genetic difference.

Substituted: When used to modify a specified group or moiety, means that at least one, and perhaps two or more, typically, 1, 2, 3, or 4, hydrogen atoms of the specified group or moiety is independently replaced with the same or different substituent groups as defined herein, unless the context indicates otherwise or a particular structural formula precludes substitution. In a particular embodiment, a group, moiety or substituent may be substituted or unsubstituted, unless expressly defined as either “unsubstituted” or “substituted.” Accordingly, any of the groups specified herein may be unsubstituted or substituted. In particular embodiments, the substituent may or may not be expressly defined as substituted, but is still contemplated to be optionally substituted. For example, an “alkyl” substituent may be unsubstituted or substituted, but an “unsubstituted alkyl” may not be substituted. Unless otherwise specified herein, exemplary substituent groups include, but are not limited to, aliphatic, such as alkyl; haloalkyl, such as —CF₃; —N(R′)₂; aromatic, heteroaliphatic; halo; —OR′; —SR′; —CH₂OR′; —(C(R′)₂)ₘ—C(O)—R′, where m is from 0 to 4; —CN; —Si(R′)₃; —Si(OR′)₃; or combinations thereof; wherein each R′ independently is H, or aliphatic, such as alkyl.

Additionally, in embodiments where a group or moiety is substituted with a substituted substituent, the nesting of such substituted substituents is limited to three, thereby preventing the formation of polymers. Thus, in a group or moiety comprising a first group that is a substituent on a second group that is itself a substituent on a third group, which is attached to the parent structure, the first (outermost) group can only be substituted with unsubstituted substituents. For example, in a group comprising -(aryl-1)-(aryl-2)-(aryl-3), aryl-3 can only be substituted with substituents that are not themselves substituted.

Any group or moiety defined herein can be connected to any other portion of a disclosed structure, such as a parent or core structure, as would be understood by a person of ordinary skill in the art, such as by considering valence rules, comparison to exemplary species, and/or considering functionality, unless the connectivity of the group or moiety to the other portion of the structure is expressly stated, or is implied by context.

Therapeutic agent: An agent that is capable of providing a therapeutic effect, e.g., preventing a disorder, inhibiting a disorder, such as by arresting the development of the disorder or its clinical symptoms, or relieving a disorder by causing regression of the disorder or ameliorating its clinical symptoms.

Therapeutically effective amount: A quantity or concentration of a specified compound, composition or combination sufficient to achieve an effect in a subject.

The above definitions and the following general formulas are not intended to include impermissible substitution patterns (e.g., methyl substituted with 5 fluoro groups). Such impermissible substitution patterns are easily recognized by a person having ordinary skill in the art.

Additional information concerning various aspects of the present invention can be found in: PCT application Nos. PCT/US2015/053439, PCT/US2016/051080 and PCT/US2018/014978; U.S. application Ser. Nos. 15/359,342, 14/699,740, 14/606,862, 13/566,433, 13/872,935, and 62/621,196, and U.S. Patent Publication No. 2013/0017211, U.S. Patent Publication No. 2012/0156248, U.S. Patent Publication No. 2007/0253983, U.S. Patent Publication No. 2007/0202092, U.S. Patent Publication No. 2007/0238120, U.S. Patent Publication No. 2006/0239992, U.S. Patent Publication No. 2005/0220846, U.S. Patent Publication No. 2005/0180964, and Australian Patent Application No. 2011/201420. Each of these prior applications is incorporated herein by reference in its entirety.

### II. Chelates

This disclosure concerns embodiments of a combination and/or composition comprising one or more metal chelates disclosed herein. A metal chelate comprises at least one metal ion and at least one ligand associated with, such as binding to, the metal ion(s).

1) Metals

In some embodiments, the ligands described herein can chelate and/or coordinate with one or more biologically-, nutritionally- and/or biocidally-relevant metals to form a metal chelate. As understood by a person of ordinary skill in the art, relevant metals can be used, for example, as part of a nutritional or biological supplement; are known to be beneficial to animals; and/or are substantially non-toxic when administered in the amounts disclosed herein. Additionally, or alternatively, the metal may have a biocidal property, and may be administered as a metal chelate.

Exemplary metals may include, but are not limited to, iron, copper, zinc, manganese, chromium, calcium, potassium, sodium, magnesium, cobalt, nickel, molybdenum, vanadium, strontium, selenium, or a combination thereof. In some disclosed embodiments, the metal is selected to provide a metal ion having a valency of +1, +2, +3, or more.

For certain disclosed embodiments, the metal ion has a valency of two or three. In particular embodiments, the metal ion is iron (II) or iron (III).

2) Ligands

In some embodiments, each ligand independently that associates with the metal ion has a structure before association according to Formula I:

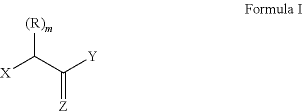

With reference to Formula 1:
m is 0, 1 or 2;
X can be selected from —C(R¹)₃, OH, CO₂R¹, CO₂H, OR², NH₂, NR²H, NR²R³, —(C(R¹)₂)ₙONO₂, —(C(R¹)₂)ₙNO₂, SH, SR² wherein each R¹, R² and R³ independently is selected from hydrogen, aliphatic, haloaliphatic, haloheteroaliphatic, heteroaliphatic, aromatic, aliphatic-aromatic, heteroaliphatic-aromatic or any combination thereof, and n is 1 to 6;
Y can be selected from NH₂, NHR³, NR³R⁴, SH, OR³, OH wherein R³ and R⁴ can independently be selected from aliphatic, haloaliphatic, haloheteroaliphatic, heteroaliphatic, aromatic, aliphatic-aromatic, heteroaliphatic-aromatic or any combination thereof;
Z can be selected from O, S, NH, NR⁵ wherein R⁵ can be selected from aliphatic, haloaliphatic, haloheteroaliphatic, heteroaliphatic, aromatic, aliphatic-aromatic, heteroaliphatic-aromatic or any combination thereof; and
each R independently is selected from halogen, aliphatic, haloaliphatic, haloheteroaliphatic, heteroaliphatic, aromatic, aliphatic-aromatic, heteroaliphatic-aromatic, or any combination thereof.

In some embodiments, m is 1 or 2, i.e. m is not 0. In some embodiments, when X=—C(R¹)₃, then X and one R¹ together with the atoms to which they are attached form a cyclic ring, such as an aliphatic, heteroaliphatic, aryl, or heteroaryl ring.

In some embodiments of Formula I, the ligand is an acid, such that Z is O and Y is OH. The acid may be an amino acid (X is NH₂, NR²H, or NR²R³) or a hydroxyl acid X is OH), such as an α-hydroxy acid, a β-hydroxy acid, or a γ-hydroxy acid.

Additional embodiments of ligands also can be used to form metal chelates according to the present invention. In particular embodiments, the disclosed ligands in can have a structure satisfying any one of the Formulas IA-IF Form below.

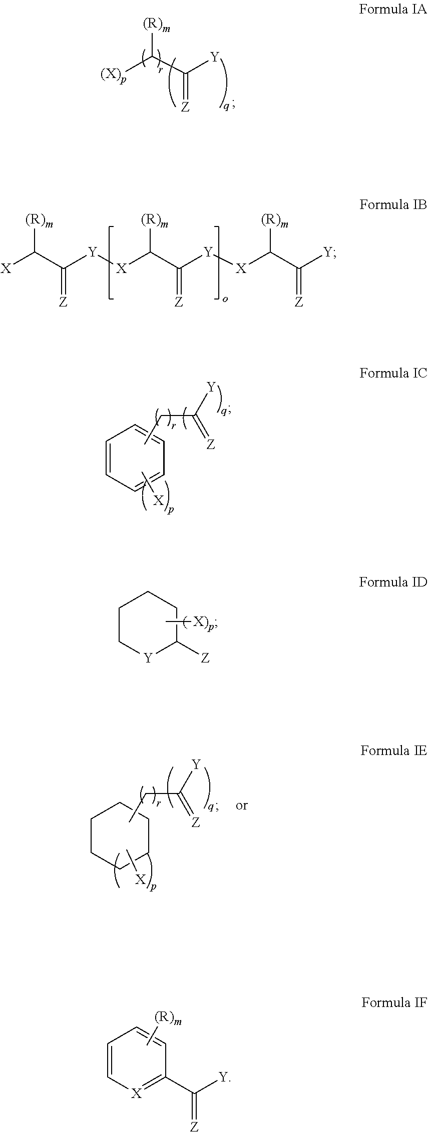

With reference to these formulas, Z and R as well as its corresponding m variable, are as recited above; X is —C(R¹)₃, OH, CO₂R¹, CO₂H, OR², NH₂, NR²H, NR²R³, —(C(R¹)₂)ₙONO₂, —(C(R¹)₂)ₙNO₂, SH, SR² wherein each R¹, R² and R³ independently is selected from hydrogen, aliphatic, haloaliphatic, haloheteroaliphatic, heteroaliphatic, aromatic, aliphatic-aromatic, heteroaliphatic-aromatic or any combination thereof, and n is 1 to 6; Y is NH, NR³, NH₂, NHR³, NR³R⁴, SH, OR³, OH wherein R³ and R⁴ can independently be selected from aliphatic, haloaliphatic, haloheteroaliphatic, heteroaliphatic, aromatic, aliphatic-aromatic, heteroaliphatic-aromatic or any combination thereof; or —Y—X— is —NR¹-bond-.

Additionally, or alternatively, with reference to any of formulas IA-IF above:

each r, p and q independently is 0, 1, 2, 3, 4, or 5; and

each o is 0, 1, 2, 3, 4, 5, 6, 7, 8, 9, 10, 11, 12, 13, 14, 15, 16, 17, 18, 19 or 20.

In particular disclosed embodiments of any of the above formulas, each R and R¹ independently is alkyl, alkenyl, alkynyl, heteroalkyl, heteroalkenyl, heterolkynyl, haloalkyl, haloalkenyl, haloalkynyl, haloheteroalkyl, haloheteroalkenyl, haloheteroalkynyl, aryl, heteroaryl, alkyl-aryl, alkeny-aryl, alkynyl-aryl, alkyl-heteroaryl, alkenyl-heteroaryl, alkynyl-heteroaryl, heteroalkyl-aryl, heteroalkenyl-aryl, heteroalkynyl-aryl, heteroalkyl-heteroaryl, heteroalkenyl-heteroaryl, heteroalkynyl-heteroaryl or any combination thereof.

With reference to formulas I and IA-IF, each ligand independently may be further substituted with one or more substituents such as, alkoxy, amide, amine, thioether, hydroxyl, thiol, acyloxy, silyl, cycloaliphatic, aryl, aldehyde, ketone, ester, carboxylic acid, acyl, acyl halide, cyano, halogen, sulfonate, nitro, nitroso, quaternary amine, pyridinyl, or (pyridinyl wherein the nitrogen atom is functionalized with an aliphatic or aryl group), alkyl halide, or any combinations thereof.

In some embodiments, the ligands disclosed herein can be hydroxy acids, such as, aliphatic hydroxy acids, cyclic hydroxy acids (such as, cyclic aliphatic hydroxy acids, aromatic hydroxy acids, etc.), carbohydrates, partially hydrolyzed or hydrolyzed proteins, amino acids, oligopeptides, or the like.

Exemplary aliphatic hydroxy acids may include, but are not limited to, α-hydroxy acids, β-hydroxy acids, γ-hydroxy acids, or any combinations thereof. Exemplary α-hydroxy acids include, but are not limited to, lactic acid, glycolic acid, citric acid, mandelic acid, tartaric acid, isoleucic acid, valic acid; and salts and/or hydrates thereof. In certain embodiments, cyclic hydroxy acids may include, but are not limited to, quinic acid, o-hydroxy benzoic acid, m-hydroxy benzoic acid, p-hydroxy benzoic acid, pyridine-2-carboxylic acids, or any combinations thereof. Sugar and/or carbohydrates also can be used as ligands. Exemplary carbohydrates may include, but are not limited to, amino sugars (e.g., D-glucosamine, etc.), monosaccharides (e.g., D-glucose, L-glucose, ribose, arabinose, xylose, lyxose, galactose, gulose, mannose, etc.), disaccharides (e.g., sucrose, lactose, etc.), trisaccharides, or poly saccharides, or any combinations thereof.

In some embodiments, the ligands disclosed herein can be amino acids. Exemplary amino acids may include, but are not limited to, alanine (also may be referred to herein as “Ala” or “A”), arginine (also may be referred to herein as “Arg” or “R”), asparagine (also may be referred to herein as “Asn” or “N”), aspartic acid (also may be referred to herein as “Asp” or “D”), cysteine (also may be referred to herein as “Cys” or “C”), glutamine (also may be referred to herein as “Gln” or “Q”), glutamic acid (also may be referred to herein as “Glu” or “E”), glycine (also may be referred to herein as “Gly” or “G”), histidine (also may be referred to herein as “His” or “H”), isoleucine (also may be referred to herein as “Ile” or “I”), leucine (also may be referred to herein as “Leu” or “L”), lysine (also may be referred to herein as “Lys” or “K”), methionine (also may be referred to herein as “Met” or “M”), phenylalanine (also may be referred to herein as “Phe” or “F”), proline (also may be referred to herein as “Pro” or “P”), serine (also may be referred to herein as “Ser” or “S”), threonine (also may be referred to herein as “Thr” or “T”), tryptophan (also may be referred to herein as “Trp” or “W”), tyrosine (also may be referred to herein as “Tyr” or “Y”), valine (also may be referred to herein as “Val” or “V”), selenocysteine (also may be referred to herein as “Sec” or “U”) and pyrrolysine (also may be referred to herein as “Pyl” or “0”).

Each amino acid may be the L-isoform, the D-isoform, or the amino acid may be a mixture of both D- and L-isoforms, and in some embodiments, may be a raceminc mixture of the L- and D-isoforms. The amino acids disclosed herein may be neutral dipolar ions, zwitter ions or any combinations thereof.

In other embodiments, the ligands may also be hydrolyzed proteins, partially hydrolyzed proteins or any combinations thereof, that are capable of chelating with one or more metal ions. The protein nay be synthetic or it may be obtained from natural sources. For example, the ligand may be obtained from enzymatic or chemical protein digestion from vegetable sources, such as soybean.

In some embodiments, the peptides disclosed herein may be, or may include, oligopeptides which include two or more amino acid moieties linked in a chain, where the carboxylic acid moiety of one amino acid moiety is joined to the amino group of another amino acid to form an —C(O)—NH— (peptide) bond. A person of ordinary skill in the art will understand that a peptide, such as an oligopeptide, or a protein, that is derived from two or more amino acids, comprises amino acid moieties where the carboxylic acid moiety from a first amino acid and the amino moiety from a second amino acid together form a peptide bond (e.g. —C(O)—NH—).

In some embodiments, the oligopeptides disclosed herein may comprise from two amino acid moieties to about twenty amino acid moieties. In certain embodiments, the oligopeptides may include, but are not limited to, dipeptides, tripeptides, tetrapeptides, pentapeptides, hexapeptides, heptapeptides, octapeptides, nonapeptides, decapeptides, or any combinations thereof. The peptides may be prepared from naturally occurring proteins or synthesized. In some embodiments, the oligopeptide is a homopeptide, where the peptide comprises, consists essentially of, or consists of, amino acid moieties that are derived from the same amino acid. In other embodiments, the oligopeptide is a heteropeptide that comprises at least two different amino acid moieties derived from at least two different amino acids.

Exemplary peptides may include, but are not limited to, one or more combinations of amino acids, such as a homo- or heterodimers (such as, Gly-Gly (i.e., G-G), Gly-Leu (i.e., G-L), Ala-Phe (i.e., A-F), etc.), a homo- or heterotrimers (such as Phe-Ile-Val (i.e., F-I-V), Leu-Pro-Trp (i.e., L-P-W), Pro-Leu-Gly (i.e., P-L-G), Gly-Gly-Gly (i.e., G-G-G), etc.), a homo- or heterotetramers (such as, Gly-Lys-Val-Ser (i.e., G-K—V-S), Met-Thr-Cys-Gln (i.e., M-T-C-Q), etc.), a homo- or heteropentamers (such as, Lys-Gly-Arg-Trp-Phe (i.e., L-G-R-W-F), Ala-Leu-Pro-Gly-Ala (i.e., A-L-P-G-A), etc.), a homo- or heterohexamers (such as, Gly-Phe-Arg-His-Gly-Gly (i.e., G-F-R-H-G-G)), a homo- or heteroheptamers (such as, Ala-Phe-Phe-Ile-Val-Gly-Gly (i.e., A-F-F-I-V-G-G)), or an homo- or heterooctamers (such as, Gly-Lys-Val-Ser-Pro-Leu-Gly-Pro (i.e., G-L-V-S-P-L-G-P)).

Exemplary ligands satisfying any one or more of Formulas I, and IA-IF are provided below.

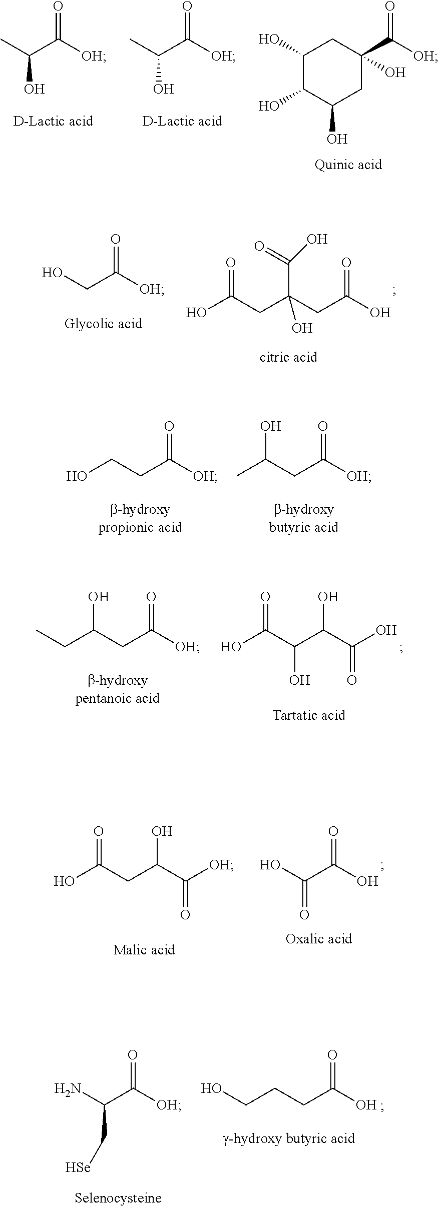

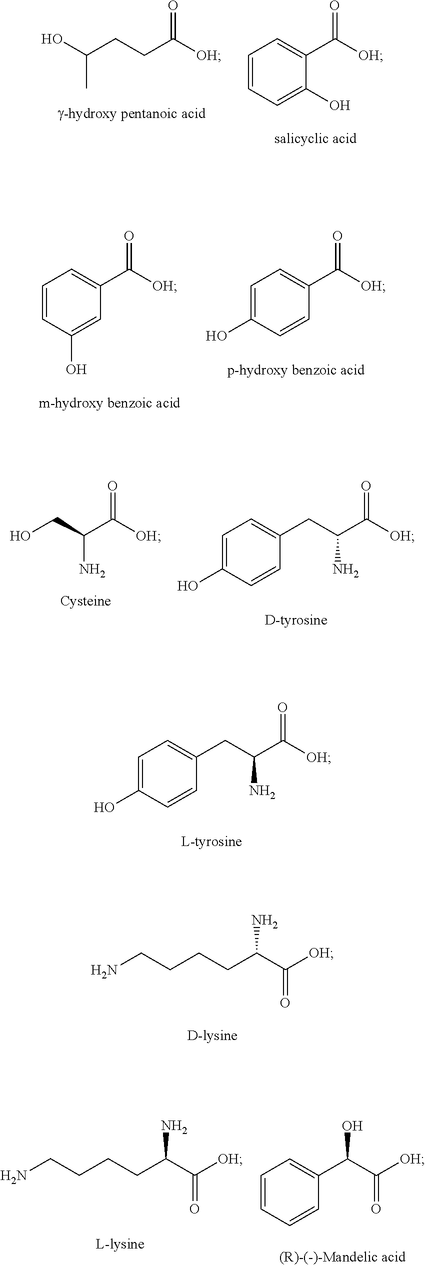

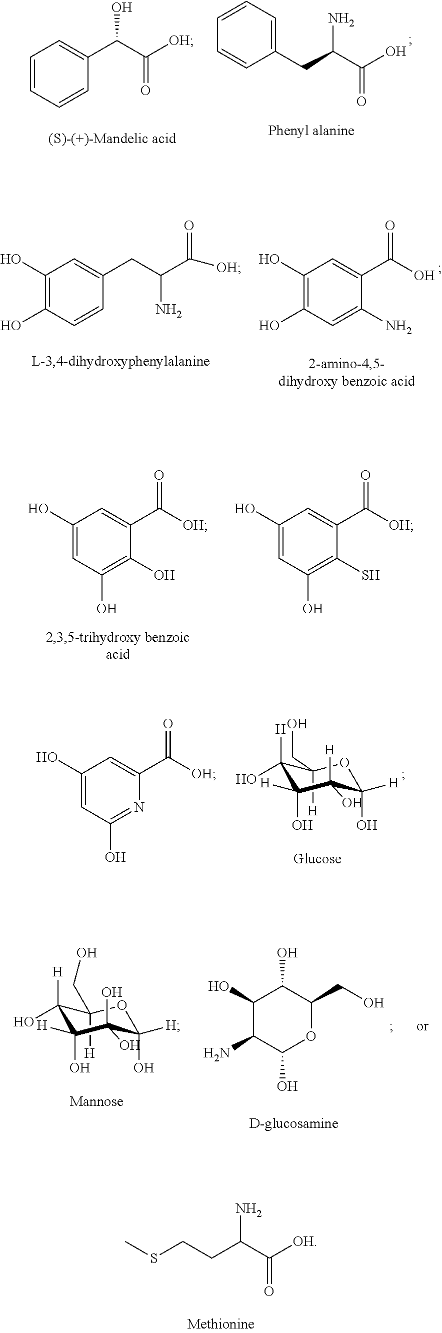

3) Metal Chelates

In further embodiments, the metal chelates disclosed herein can have a structure satisfying Formula II.

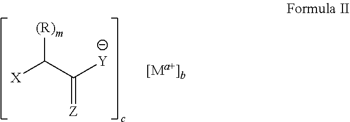

With reference to Formula II, X, Y, Z, R and R¹ as well as the corresponding m variable are as recited above with respect to Formula I, and M is a metal ion as previously described.

Additionally, or alternatively, with reference to Formula II above:

a is from 1 to 6 or more, such as from 2 or 3;

b is 1 or 2; and

c is 1, 2 or 3

In particular disclosed embodiments, the metal chelate disclosed in Formula II can have a structure satisfying any of the Formulas IIA-IIF below.

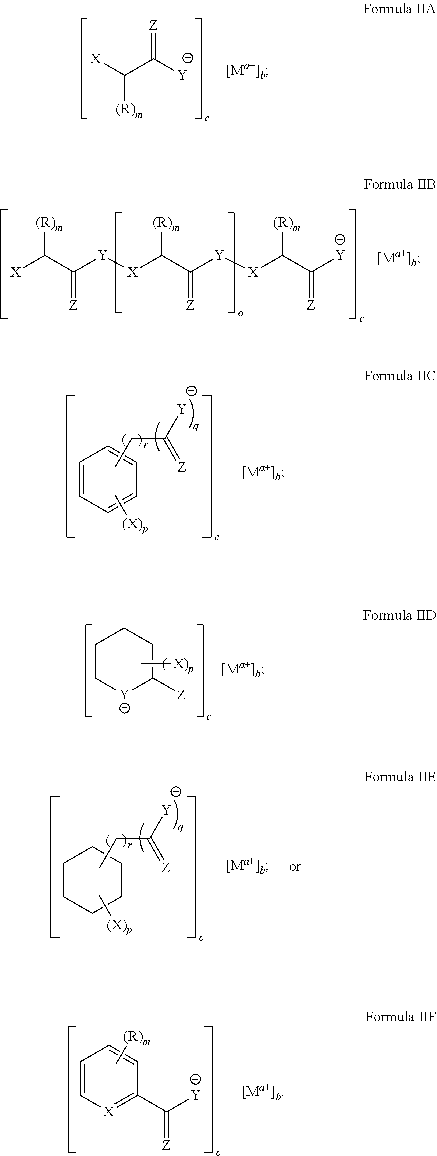

With reference to these formulas, X, Y, Z and R as well as their corresponding integer variables, m, o, p, q, r, a, b and c can be as recited above with respect to formulas IA-IF.

A person of ordinary skill in the art will understand that the Formulas II, Formulas IIA-IIF are stereoambiguous. That is, these formulas do not indicate the relative or absolute stereochemistry of the potential stereoisomers; nevertheless, all such stereoisomers are within the scope of the disclosed metal chelates.

The metal chelate may further comprise one or more counterions. The number and nature of the counterion(s) may be selected to result in a charge-neutral metal chelate. Suitable counterions include, but are not limited to, sodium, potassium, lithium, calcium, magnesium, chloride, bromide, iodine, fluoride, sulfate, carbonate, nitrate, hydroxide, or a combination thereof.

Further, in certain embodiments, a metal chelates disclosed herein may be formed using two or more different ligands. That is, an exemplary metal chelate disclosed herein may comprise a metal atom or its ion that binds with, for example, two lactic acid molecules and one oxalic acid molecule.

In some embodiments, the metal chelates disclosed herein can be metal complexes of aliphatic hydroxy acids, metal complexes of cyclic hydroxy acids (such as, cyclic aliphatic hydroxy acids, aromatic hydroxy acids, etc.), metal complexes of carbohydrates, metal complexes of partially hydrolyzed or hydrolyzed proteins (such as, metal proteinates), metal complexes of amino acids, metal complexes of oligopeptides, salts and/or hydrates thereof; and any combinations thereof. In certain embodiments, the metal chelates disclosed herein can be iron (II) complexes of aliphatic hydroxy acids, iron (II) complexes of cyclic hydroxy acids (including, cyclic aliphatic hydroxy acids, aromatic hydroxy acids, etc.), iron (II) complexes of carbohydrates, iron (II) complexes of partially hydrolyzed or hydrolyzed proteins, iron (II) complexes of amino acids, iron (II) complexes of oligopeptides, or any combinations thereof. In certain embodiments, the metal chelates disclosed herein can be iron (III) complexes of aliphatic hydroxy acids, iron (III) complexes of cyclic hydroxy acids (such as, cyclic aliphatic hydroxy acids, aromatic hydroxy acids, etc.), iron (III) complexes of carbohydrates, iron (III) complexes of partially hydrolyzed or hydrolyzed proteins, iron (III) complexes of amino acids, iron (III) complexes of oligopeptides, or any combinations thereof.

In certain embodiments, metal complexes of the aliphatic hydroxy acids may include, but are not limited to, metal complexes of α-hydroxy acids, metal complexes of β-hydroxy acids, metal complexes of γ-hydroxy acids, or any combinations thereof. In particular disclosed embodiments, iron (II) complexes of the aliphatic hydroxy acids may include, but are not limited to, iron (II) complexes of α-hydroxy acids, iron (II) complexes of β-hydroxy acids, iron (II) complexes of γ-hydroxy acids, or any combinations thereof. Exemplary iron (II) complexes of α-hydroxy acids include, but are not limited to, ferrous lactate, ferrous glycolate, ferrous citrate, ferrous mandelate, ferrous tartrate, iron (II) salicylate, iron (II) p-hydroxy benzoate, ferrous complex of isoleucic acid, ferrous valate; salts and/or hydrates thereof. In particular disclosed embodiments, iron (III) complexes of the aliphatic hydroxy acids may include, but are not limited to, iron (III) complexes of α-hydroxy acids, iron (III) complexes of β-hydroxy acids, iron (III) complexes of γ-hydroxy acids, or any combinations thereof. Exemplary iron (III) complexes of α-hydroxy acids include, but are not limited to, ferric lactate, ferric glycolate, ferric citrate, ferric mandelate, ferric tartrate, ferric complex of isoleucic acid, ferric valate; salts and/or hydrates thereof. In certain embodiments, metal complexes of cyclic hydroxy acids (i.e., iron (II) complexes of cyclic hydroxy acids) may include, but are not limited to, ferrous quinate, ferrous complex of o-hydroxy benzoic acid, ferrous complex of m-hydroxy benzoic acid, ferrous complex of p-hydroxy benzoic acid, ferrous complex of pyridine-2-carboxylic acids, or any combinations thereof. Exemplary iron (III) complexes of cyclic hydroxy acids may include, but are not limited to, ferric quinate, ferric complex of o-hydroxy benzoic acid, ferric complex of m-hydroxy benzoic acid, ferric complex of p-hydroxy benzoic acid, iron (III) γ-hydroxy butyrate, ferric β-hydroxy butyrate, iron(III) m-hydroxy benzoate, iron (III) γ-hydroxy pentanoate, iron (III) β-hydroxy pentanoate, ferric β-hydroxy propionate, iron (III) p-hydroxy benzoate, iron (III) salicylate, ferric complex of pyridine-2-carboxylic acids, or any combinations thereof. Exemplary iron (II) complex of carbohydrates may include, but are not limited to, iron (II) complex of amino sugars (e.g., D-glucosamine, etc.), iron (II) complex of monosaccharides (e.g., D-glucose, L-glucose, ribose, arabinose, xylose, lyxose, galactose, gulose, mannose, etc.), iron (II) complex of disaccharides (e.g., sucrose, lactose, etc.) or any combinations thereof. Exemplary iron (III) complex of carbohydrates may include, but are not limited to, iron (III) complex of amino sugars (e.g., D-glucosamine, etc.), iron (III) complex of monosaccharides (e.g., D-glucose, L-glucose, ribose, arabinose, xylose, lyxose, galactose, gulose, mannose, etc.), iron (III) complex of disaccharides (e.g., sucrose, lactose, etc.) or any combinations thereof.

Exemplary iron (II) complex of amino acids may include, but are not limited to, iron (II) complex of alanine, iron (II) complex of arginine, iron (II) complex of asparagine, iron (II) complex of aspartic acid, iron (II) complex of cysteine, iron (II) complex of glutamine, iron (II) complex of glutamic acid, iron (II) complex of glycine, iron (II) complex of histidine, iron (II) complex of isoleucine, iron (II) complex of leucine, iron (II) complex of lysine, iron (II) complex of methionine, iron (II) complex of phenylalanine, iron (II) complex of proline, iron (II) complex of serine, iron (II) complex of threonine, iron (II) complex of tryptophan, iron (II) complex of tyrosine, iron (II) complex of valine, iron (II) complex of selenocysteine and iron (II) complex of pyrrolysine. In some embodiments, the iron (II) complex is not ferrous sulfate and tyrosine to form in-vivo ferrous-tyrosine complex. In some embodiments, the iron (II) complex is not ferrous sulfate and L-DOPA to form in-vivo ferrous-L-DOPA complex. In some embodiments, the iron (II) complex is not ferrous sulfate and L-phenylalanine to form in-vivo ferrous-L-phenylalanine complex. In some embodiments, the iron (II) complex is not ferrous sulfate and quinic acid to form in-vivo ferrous-quinate complex.

Exemplary iron (III) complex of amino acids may include, but are not limited to, iron (III) complex of alanine, iron (III) complex of arginine, iron (III) complex of asparagine, iron (III) complex of aspartic acid, iron (III) complex of cysteine, iron (III) complex of glutamine, iron (III) complex of glutamic acid, iron (III) complex of glycine, iron (III) complex of histidine, iron (III) complex of isoleucine, iron (III) complex of leucine, iron (III) complex of lysine, iron (III) complex of methionine, iron (III) complex of phenylalanine, iron (III) complex of proline, iron (III) complex of serine, iron (III) complex of threonine, iron (III) complex of tryptophan, iron (III) complex of tyrosine, iron (III) complex of valine, iron (III) complex of selenocysteine, and iron (III) complex of pyrrolysine. Although in some embodiments, the disclosed iron (II)/amino acid complexes, or iron (III)/amino acid complexes of the present disclosure comprise L-isoform of the amino acid moieties, D-isoform amino acid moieties, or a combination of both D- and L-isoforms.

In some embodiments, the metal-chelated peptides disclosed herein may be, or may include, metal-chelated oligopeptides which include two or more amino acids linked in a chain, where the carboxylic acid group of one amino acid and the amino group of another amino acid together form a peptide (—OC—NH—) bond. In some embodiments, the metal-chelated oligopeptides disclosed herein may comprise from two amino acids to about twenty amino acids. In certain embodiments, the metal-chelated oligopeptides may include, but are not limited to metal-chelated dipeptides, metal-chelated tripeptides, metal-chelated tetrapeptides, metal-chelated pentapeptides, metal-chelated hexapeptides, metal-chelated heptapeptides, metal-chelated octapeptides, metal-chelated nonapeptides, metal-chelated decapeptides, or any combinations thereof. In particular disclosed embodiments, the iron (II)-chelated oligopeptides may include, or may be, iron (II)-chelated dipeptides, iron (II)-chelated tripeptides, iron (II)-chelated tetrapeptides, iron (II)-chelated pentapeptides, iron (II)-chelated hexapeptides, iron (II)-chelated heptapeptides, iron (II)-chelated octapeptides, or any combinations thereof. Exemplary iron (II)-chelated peptides may include, but are not limited to, iron (II)-chelated Gly-Gly, Gly-Leu, iron (II)-chelated Ala-Phe, iron (II)-chelated Phe-Ile-Val, iron (II)-chelated Leu-Pro-Trp, iron (II)-chelated Pro-Leu-Gly, iron (II)-chelated Gly-Gly-Gly, iron (II)-chelated Gly-Lys-Val-Ser, iron (II)-chelated Met-Thr-Cys-Gln, iron (II)-chelated Lys-Gly-Arg-Trp-Phe, iron (II)-chelated Ala-Leu-Pro-Gly-Ala, iron (II)-chelated Gly-Phe-Arg-His-Gly-Gly, iron (II)-chelated Ala-Phe-Phe-Ile-Val-Gly-Gly, iron (II)-chelated Gly-Lys-Val-Ser-Pro-Leu-Gly-Pro.

In particular disclosed embodiments, the iron (III)-chelated oligopeptides may include, or may be, iron (III)-chelated dipeptides, iron (III)-chelated tripeptides, iron (III)-chelated tetrapeptides, iron (III)-chelated pentapeptides, iron (III)-chelated hexapeptides, iron (III)-chelated heptapeptides, iron (III)-chelated octapeptides, or any combinations thereof. Exemplary iron (III)-chelated peptides may include, but are not limited to, iron (III)-chelated Gly-Gly, Gly-Leu, iron (III)-chelated Ala-Phe, iron (III)-chelated Phe-Ile-Val, iron (III)-chelated Leu-Pro-Trp, iron (III)-chelated Pro-Leu-Gly, iron (III)-chelated Gly-Gly-Gly, iron (III)-chelated Gly-Lys-Val-Ser, iron (III)-chelated Met-Thr-Cys-Gln, iron (III)-chelated Lys-Gly-Arg-Trp-Phe, iron (III)-chelated Ala-Leu-Pro-Gly-Ala, iron (III)-chelated Gly-Phe-Arg-His-Gly-Gly, iron (III)-chelated Ala-Phe-Phe-Ile-Val- Gly-Gly, iron (III)-chelated Gly-Lys-Val-Ser-Pro-Leu-Gly-Pro.

Exemplary chelates satisfying any one or more of Formulas II, and IIA-IIF are provided below.

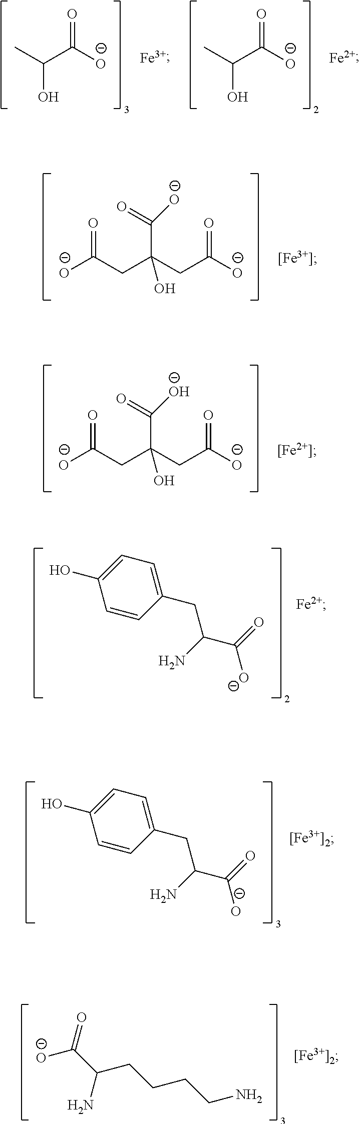

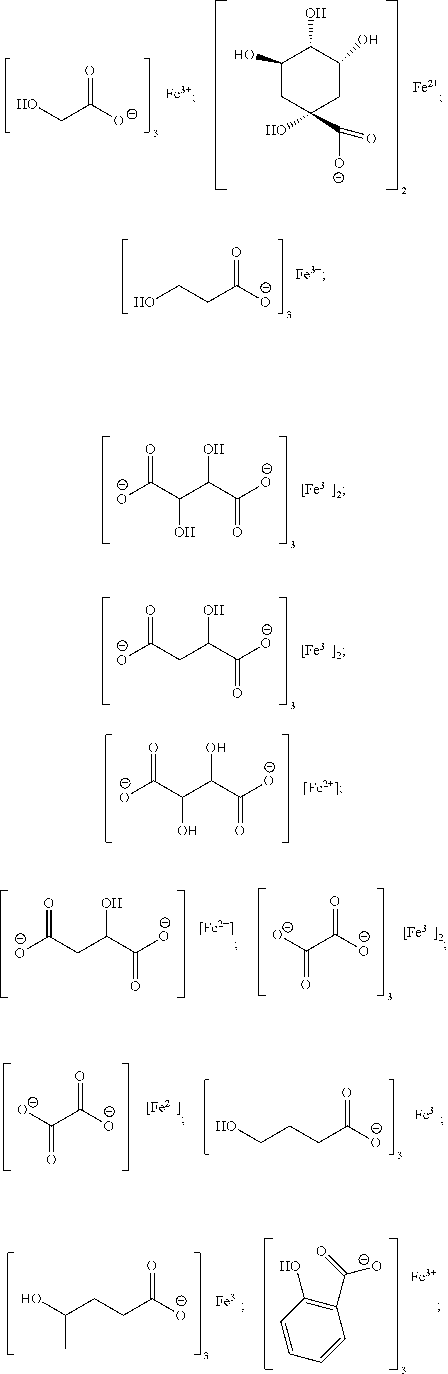

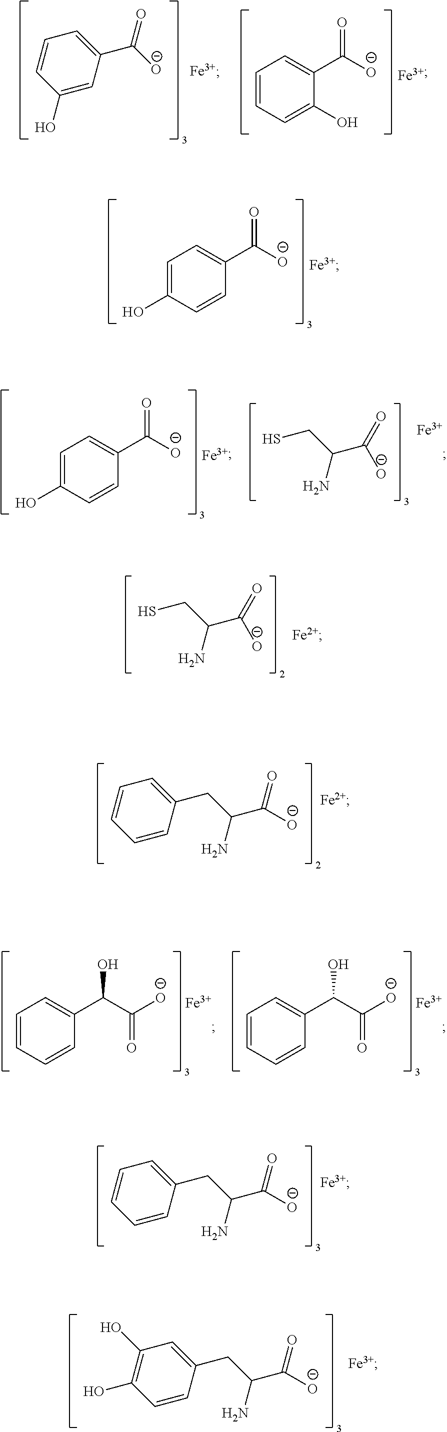

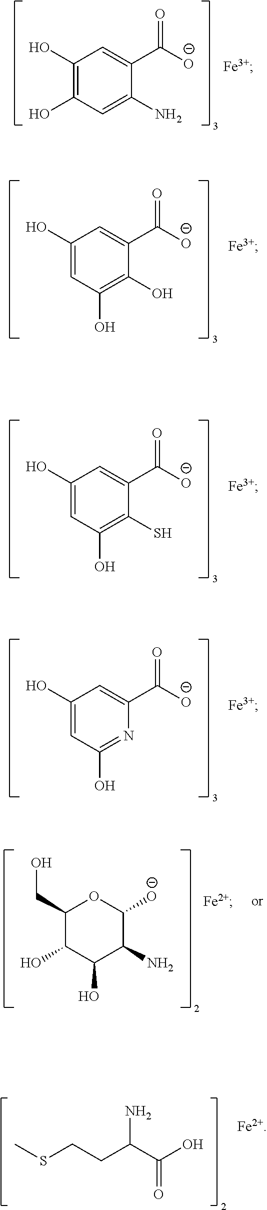

In particular embodiments, the metal chelate is ferric tyrosinate, ferric citrate, ferric lactate, ferric lysine, ferric proteinate with hydrolyzed soy protein, or a combination thereof.

### D. Sources of Metal Chelates

1) Synthetic Metal Chelates

In one embodiment, the metal chelates disclosed herein can be made by reacting the ligands disclosed herein with one or more metals, such as a metal complex, metal salt, metal hydrate, metal in a solution, or any combinations thereof. In particular disclosed embodiments, M (II) and M (III) chelates, such as iron (II) and iron (III) chelates, can be made by contacting one or more disclosed ligands with iron (II) or iron (III) complexes, salts, hydrates, or any combinations thereof, in any order.

A representative method for making metal chelate embodiments is described below in Scheme 1.

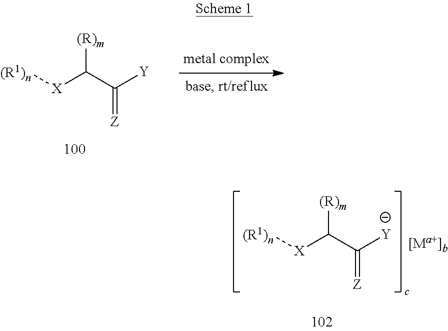

With reference to Scheme 1, each of the X, Y, Z, R and R¹ and the corresponding m variables are as recited herein. In some embodiments, ligand 100 can be treated with a metal complex in the presence of a base either at room temperature or with heating, and optionally under reflux conditions, to obtain the desired metal chelate 102. Exemplary metal complexes may include, halides, hydroxides, sulfates, carbonates, nitrates, phosphates, lactates, etc. With reference to iron, suitable iron (II) complexes include, but are not limited, iron (II) complexes, such as iron (II) halides (e.g., FeCl₂, FeBr₂, etc.), Fe(OH)₂, FeSO₄, Fe(HSO₄)₂, Fe(NO₃)₂, Fe(acetylacetonate)₂ (referred to as Fe(acac)₂), Fe(acetate)₂, Fe(lactate)₂, Fe (II) phosphate, or the like. Exemplary metal complexes may include, but are not limited, iron (III) complexes, such as iron (III) halides (e.g., FeCl₃, FeBr₃, etc.), Fe(OH)₃, Fe₂(SO₄)₃, Fe(HSO₄)₃, Fe(NO₃)₃, Fe(acetylacetonate)₃ (referred to as Fe(acac)₃), Fe(acetate)₃, Fe(lactate)₃, Fe (III) phosphate, or the like. In one embodiment, the base utilized in Scheme 1 may include, or may be, organic bases or inorganic bases. Exemplary bases may include, but are not limited to, amines (such as, primary amine, secondary amine, or tertiary amine (e.g., triethyl amine, trimethyl amine, or diethyl isopropyl amine, etc.)), a heterocyclic aromatic amine (such as, N-methyl morpholine or pyridine), an alkoxide (e.g., an alkali metal alkoxide, such as sodium methoxide, sodium ethoxide, etc.), a hydroxide salt (e.g., an ammonium or alkali metal hydroxide (such as, lithium hydroxide, sodium hydroxide, potassium hydroxide)), a carbonate or bicarbonate salt (e.g., Na₂CO₃ or NaHCO₃), or the like.

Additional metal embodiments that can be used to make metal chelates are illustrated below in Schemes 2-7. With reference to Schemes 2-7, each of the illustrated variables are as recited for any of the formulas disclosed herein, and “rt/reflux” refers to room temperature or with heating at a temperature from greater than room temperature to a reflux temperature.

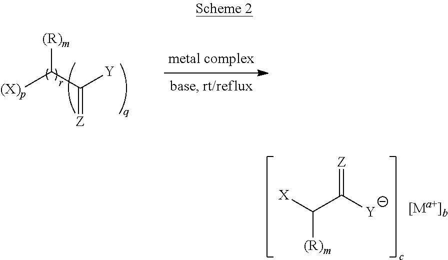

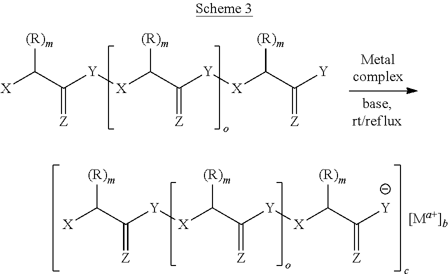

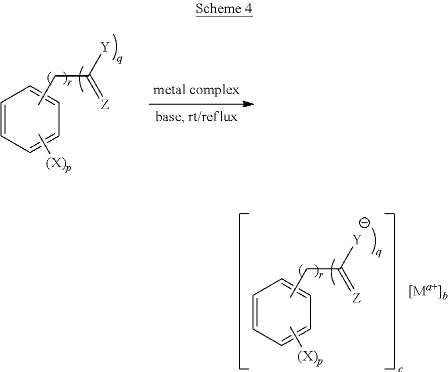

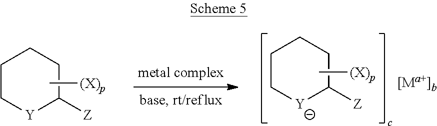

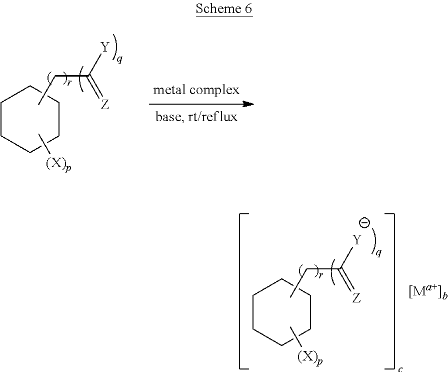

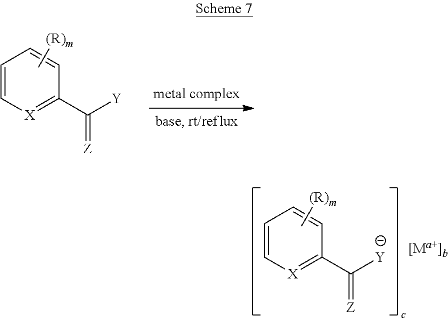

Exemplary embodiments of the above-described methods depicted in Schemes 2-7 are provided in Schemes 8.

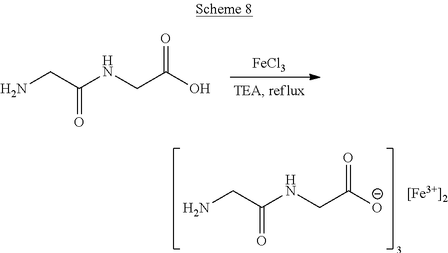

2) Isolated Metal Chelates

Additionally, or alternatively, the metal chelates disclosed herein can be made using or isolated from naturally occurring products. In some embodiments, the metal chelated peptides disclosed herein can be isolated from naturally occurring products, such as, animal products, plant products, or any combinations thereof. In particular disclosed embodiments, iron (III) chelated peptide, such as iron (III)-chelated Ser-Cys-His can be isolated and purified from Alaskan pollock skin. In another particular disclosed embodiments, the ligand can be an oligopeptide isolated from naturally occurring products, such as animal or plant products, such as soybean protein hydrolysates. One example of an iron (III) chelate from soybean is iron (III)-chelated with His-Glu-Asp-Cys.

### III. Additional Components

The metal chelates disclosed herein can also be administered in combination with one or more additional components, or as compositions comprising one or more additional components. The additional component may be any component or composition that can be administered to a subject, particularly an animal, such as a land animal (such as, bovines and swine), an avian, including poultry, such as chickens and turkeys, and/or an aquatic animal, such as fish and shellfish, in combination with the metal chelates disclosed herein. Exemplary additional components include, by way of example and without limitation, a carrier, a probiotic, a vitamin, a feed, a feed supplement, a growth promotant, a preservative, an antimicrobial, a vaccine, a copper salt, a direct-fed microbial (DFM), or a combination thereof. The additional component(s) will comprise from 1 wt % to 99 wt %, and the metal chelate will comprise from 99 wt % to 1% of the total weight of the composition or combination. Preferably, the additional component(s) will comprise from 10 wt % to 90 wt %, and the metal chelates will comprise from 90 wt % to 10 wt % of the total weight of the composition or combination. Yet even more preferably, the additional component(s) will comprise 20 wt % to 80 wt % and the metal chelates will comprise from 80 wt % to 20 wt % of the total weight of the composition or combination.

A. Carrier

In some embodiments, the metal chelates may be mixed with and/or dispersed in a carrier to form a dispersed composition. The carrier(s) may be selected to provide a non-biological benefit to the composition, compared to a metal chelate without a carrier, such as, but not limited to, achieving or improving a readily flowable state, and/or improving stability during storage and/or transport. Suitable carriers that may be used in combination with a metal chelate combination include, but are not limited to, plant material, such as beet pulp, ground corn, corn syrup solids, plant fiber, rice hulls, soluble plant fiber, wheat middlings, microcrystalline cellulose; carbonates, such as metal carbonates, such as calcium carbonate, potassium carbonate; sulfates, such as metal sulfates, such as potassium sulfate, sodium sulfate; lactates, including metal lactates, such as calcium lactate; oxides, including metal oxides, such as calcium oxide; propionates, including metal propionates, such as calcium propionate; stearates, including metal stearates, such as calcium stearate; phosphates, such as dicalcium phosphate dehydrate, monocalcium phosphate, sodium tripolyphosphate, or tetra sodium pyrophosphate; minerals, such as dolomite, silicon dioxide, silica, limestone, or vermiculite; clays, such as bentonite, montmorillonite, kaolin; sugars, such as glucose, sucrose, dextrose, fructose, or a combination thereof; maltodextrin; salt, such as sodium chloride; carrageenan; cellulose; guar gum; polyols; sodium alumino silicate; urea; animal protein products; forage products; grain products; plant protein products; processed grain products; roughage products; molasses products; or combinations thereof.

Animal protein products may include, but are not limited to, blood meal; animal by-product meal; buttermilk, including condensed buttermilk and dried buttermilk; casein; dried hydrolyzed casein; cheese rind; crab meal; fish products, including fish by-products, fish liver and glandular meal, fish meal, fish protein concentrates, fish residue meal, and dried and/or condensed fish solubles; fleshings hydrolysate; hydrolyzed hair; hydrolyzed leather meal; hydrolyzed poultry by-product aggregate; hydrolyzed poultry feathers; leather hydrolysate; meat and bone meal; meat and bone meal tankage; meat meal; meat meal tankage; dried meat solubles; dried lactalbumin; dried feed grade milk; dried milk protein; poultry by-products and/or by-products meal; poultry hatchery by-product; shrimp meal; skimmed milk, including condensed, condensed cultured, dried, or dried cultured skimmed milk; whey, including condensed, condensed cultured, condensed hydrolyzed, dried, or dried hydrolyzed whey; condensed and/or dried whey product; condensed and/or dried whey solubles; or a combination thereof.

Forage products may include, but are not limited to, alfalfa products, such as dehydrated meal, optionally in pellet form, ground hay, or suncured meal, optionally in pellet form; coastal bermudagrass hay; dehydrated corn plant; dehydrated silage; flax plant product; ground grass; lespedeza meal and/or stem meal; ground soybean hay; or combinations thereof.

Grain products may include, but are not limited to, barley, corn, grain sorghum, mixed feed oats, oats, triticale, wheat, ground brown rice, ground or ground paddy rough rice, broken or chipped rice, brewers rice, rye, or a combination thereof. The grain products may be in any suitable form, such as whole, ground, cracked, screen cracked, flaked, kibbled, toasted, and/or heat processed.

Plant protein products may include, but are not limited to, dried beans; canola meal; coconut meal; cottonseed, such as flakes, cake, meal, low gossypol meal, and/or whole pressed cottonseed; guar meal; dried kelp; linseed meal; peanut meal; peas; potato protein; dried seaweed meal; safflower meal; soy protein concentrate; soybean feed; ground soybeans; soybean meal, optionally kibbled; heat processed soybeans; ground, extruded whole soybeans; soy flour; soy grits; sunflower meal, optionally dehulled; yeast, such as active dried yeast, brewers dried yeast, culture yeast, dried yeast, primary dried yeast, torula dried yeast, and/or Candida dried yeast; or a combination thereof.

The processed grain by-products may be aspirated grain fractions; brewers dried grains; buckwheat middlings; condensed distillers solubles; condensed fermented corn extracts; corn bran; corn flour; corn germ meal; corn gluten feed and/or meal; corn grits; distillers dried grains, optionally with solubles; distillers dried solubles, flour, grain sorghum germ cake, meal, grits, and/or mill feed; meal hominy feed; malt sprouts; oat groats; feeding oat meal; pearl barley by-product; peanut skins; rice bran; rice polishings; rye middlings; gelatinized or partially aspirated sorghum grain flour; wheat bran, flour, shorts, germ meal, defatted germ meal, middlings, mill run and/or red dog; or a combination thereof.

Roughage products may include, but are not limited to, almond hulls; dried apple pectin pulp; dried apple pomace; bagasse; barley hulls; barley mill by-product; dried, plain beet pulp; buckwheat hulls; dried citrus meal; dried citrus pulp; citrus seed meal; corn cob fractions; cottonseed hulls; flax straw by-product; ground corn cob; psyllium seed husk; malt hulls; clipped oat by-product; oat hulls; oat mill by-product; peanut hulls; rice hulls; rice mill by-product; rye mill run; soybean hulls, mill feed, and/or mill run; sunflower hulls; ground straw; dried tomato pomace; or a combination thereof.

Molasses products may be beet molasses; dried beet molasses product; dried beet pulp molasses; cane molasses; citrus molasses; molasses yeast condensed solubles; concentrated separator by-product; condensed molasses fermentation solubles; starch molasses; molasses distillers condensed solubles; molasses distillers dried solubles; or a combination thereof.

B. Probiotic Compositions and/or combinations comprising the metal chelates disclosed herein may also comprise a probiotic, such as a Bacilli combination. In one example, the Bacilli combination is a probiotic combination or a composition comprising plural bacilli. In certain particular embodiments, the composition and/or combination comprises three or four direct-fed microbials (DFMs) selected from Bacillus coagulans, Bacillus subtilis, Bacillus licheniformis and Bacillus amyloliquefaciens. An ASL combination is a combination or composition comprising the DFMs Bacillus amyloliquefaciens, Bacillus subtilis and Bacillus licheniformis. In some embodiments, an ASL combination comprises, consists essentially of, or consists of Bacillus amyloliquefaciens, Bacillus subtilis and Bacillus licheniformis and no additional DFMs. An ASLC combination is a combination or composition comprising the DFMs Bacillus amyloliquefaciens, Bacillus subtilis, Bacillus licheniformis and Bacillus coagulans. In some embodiments, an ASLC combination comprises, consists essentially of, or consists of Bacillus amyloliquefaciens, Bacillus subtilis, Bacillus licheniformis and Bacillus coagulans, but no other additional DFMs.

In some embodiments, a Bacilli composition and/or combination, such as a CSL composition and/or combination, an ASL composition and/or combination, or an ASLC composition and/or combination, when combined with the metal chelates and administered to a subject may provide a substantial benefit to the subject compared to a subject that is not administered such compositions and/or combinations. With particular reference to poultry, a Bacilli combination provides a substantial benefit with respect to one or more of feed conversion rate, average body weight, average body weight gain, body weight coefficient of variation, bird mortality, lesion scores, Salmonella/E. Coli/Clostridium perfingens (CP) incidence, and/or oocysts in fecal matter relative to poultry fed none, one, or two of these bacilli in any combination.

1. Bacillus Strains

A person of ordinary skill in the art will appreciate that any strain, or combinations of strains, of Bacillus coagulans, Bacillus subtilis, Bacillus licheniformis and/or Bacillus amyloliquefaciens can be used in the Bacilli combination. As used herein the terms “Bacillus amyloliquefaciens,” “Bacillus coagulans,” “Bacillus subtilis” and “Bacillus licheniformis” independently may refer to a single strain of the respective Bacillus species, or to multiple strains, such as 2, 3, 4, 5, 6, 7, 8, 9, 10 or more strains, of each respective Bacillus species. Solely by way of example and without limitation, certain acceptable exemplary strains of each Bacillus species are listed below.

2. Bacillus coagulans Strains

Bacillus coagulans Hammer ATCC® BAA-738™ strain LMG 17453, Logan B0934, NCTC 3992, Vitek #202384, Bacillus coagulans Hammer ATCC® 7050™ strain NRS 609, NCIB 9365, NCTC 10334, DSM 1, CCM 2013, WDCM 00002, Bacillus coagulans Hammer ATCC® 8038™ strain NCA 43P, NCIB 8080, NRS 770, DSM 2312 deposited with ATCC as Bacillus thermoacidurans by Berry, Bacillus coagulans Hammer ATCC® 10545™ strain NRS 784, NCIB 8041, DSM 2311, CCM 1082, deposited with ATCC as Bacillus dextrolacticus by Andersen and Werkman, Bacillus coagulans Hammer ATCC® 11014™ strain NRS T27, 78G, DSM 2383, Bacillus coagulans Hammer ATCC® 11369™ strain C, DSM 2384 deposited with ATCC as Bacillus dextrolacticus by Andersen and Werkman, Bacillus coagulans Hammer ATCC® 12245™ strain NCA 308, DSM 2308, NCIB 8870, Bacillus coagulans Hammer ATCC® 15949™ strain NCA 4259, DSM 2385, Bacillus coagulans Hammer ATCC® 23498™ strain M-39, DSM 2314, NCIB 10276 deposited with ATCC as Bacillus racemilacticus by Nakayama and Yanoshi, Bacillus coagulans Hammer ATCC® 31284™ deposited with ATCC as Lactobacillus sporogenes by Horowitz-Wiassowa and Nowotelnow, Ganeden Biotech Inc.'s GBI-30 strain, ATCC Designation Number PTA-6086, Bacillus coagulans Hammer ATCC® 53595™ strain PM-1000, Bacillus coagulans Hammer strain DSM 2350, NRRL-NRS 2012, Bacillus coagulans Hammer strain DSM 2356, NCIB 8523, N. R. Smith (NRS) 798, B. Hammer Iowa State College 200, Bacillus coagulans Hammer strain DSM 30760, Bacillus coagulans Hammer strain STI09070 (IMET), 1032-005, Bacillus coagulans Hammer strain STI09076 (IMET), 1141-003, Bacillus coagulans Hammer strain STI09080 (IMET), 1136-014, Bacillus coagulans Hammer strain STI09208 (IMET), 491-25, Bacillus coagulans Hammer strain STI09210 (IMET), 485-59, Bacillus coagulans Hammer strain NCIB 700460, Thl, Bacillus coagulans Hammer strain NCIB 701099, BG5, TH27 (205), Bacillus coagulans Hammer strain NCIB 701159, 254, and Bacillus coagulans Hammer strain NCIB 701164, 259.

3. Bacillus licheniformis Strains

Bacillus licheniformis (Weigmann) Chester ATCC® 6598™ strain NRS 745 deposited with ATCC as Bacillus subtilis by (Ehrenberg) Cohn, Bacillus licheniformis (Weigmann) Chester ATCC® 6634™ strain NRS 304, Bacillus licheniformis (Weigmann) Chester ATCC® 8480™ strain NRS 1128, Bacillus licheniformis (Weigmann) Chester ATCC® 9259™, Bacillus licheniformis (Weigmann) Chester ATCC® 9789™ strain AMNH 723, ATCC 102, ATCC 4527, ATCC 8243, ATCC 9800, NCTC 2586, NCTC 6346, NRS 243, NRS 978, W. Ford 1, DSM 8785, DSM 46308, BU 171, CCDB b-30, CCEB 631, CCM 2205, CN 1060, HNCMB 101012, IFO 12195, IFO 12196, IMET 11025, NBRC 12195, NBRC 12196, NCDO 735, NCDO 835, NCIB 6346, NCIB 8059, NCIB 8061, OUT 8367, OUT 8368, Smith 243, Smith 978, HankeyB13 deposited with ATCC as Bacillus subtilis by (Ehrenberg) Cohn, Bacillus licheniformis (Weigmann) Chester ATCC® 9945™ strain NRS 712, NCIB 8062 deposited with ATCC as Bacillus subtilis by (Ehrenberg) Cohn, Bacillus licheniformis (Weigmann) Chester ATCC® 9945A™ strain CD-2, NCIB 11709, Bacillus licheniformis (Weigmann) Chester ATCC® 10716™ strain ATCC 11944, BS 2181, Boots 1343, CCM 2181, FDA BT1, NCIB 8874, NRS 1330, Tracy I, DSM 603, IFO 12199, NBRC 12199, Bacillus licheniformis (Weigmann) Chester ATCC® 11945™ strain 1331, FDA BT3, Bacillus licheniformis (Weigmann) Chester ATCC® 11946™ strain 1333, B-1001, Bacillus licheniformis (Weigmann) Chester ATCC® 12139™ strain CSC deposited with ATCC as Bacillus subtilis by (Ehrenberg) Cohn, Bacillus licheniformis (Weigmann) Chester ATCC® 12713™ strain PRL B479, NRRL B-1001, Bacillus licheniformis (Weigmann) Chester ATCC® 12759™ strain ATCC 11560, Damodaron P-8, LMG 7560, NRS 1415, Vitek #200148, NCIB 8549, HankeyB133, P8, Bacillus licheniformis (Weigmann) Chester ATCC® 12759-MINI-PACK™ strain ATCC 11560, Damodaron P-8, LMG 7560, NRS 1415, Vitek #200148, Bacillus licheniformis (Weigmann) Chester ATCC® 13438™ Strain NCTC 8233, M. II strain, Bacillus licheniformis (Weigmann) Chester ATCC® 14409™ strain 620, NRS 1114, NCIB 1042, deposited with ATCC as Bacillus abysseus by ZoBell and Upham, Bacillus licheniformis (Weigmann) Chester ATCC® 14580™ strain (Gibson) 46, NCIB 9375, NCTC 10341, NRS 1264, DSM 13, CCM 2145, IFO 12200, NBRC 12200, WDCM 00068, Bacillus licheniformis (Weigmann) Chester ATCC® 14580D-5™ strain designation: Genomic DNA from Bacillus licheniformis Strain 46 [ATCC® 14580™], Bacillus licheniformis (Weigmann) Chester ATCC® 14594™, Bacillus licheniformis (Weigmann) Chester ATCC® 21038™ strain L-065, Bacillus licheniformis (Weigmann) Chester ATCC® 21039™, Bacillus licheniformis (Weigmann) Chester ATCC® 21415™ strain NS 1 deposited with ATCC as Bacillus subtilis by (Ehrenberg) Cohn, Bacillus licheniformis (Weigmann) Chester ATCC® 21417™ strain M deposited with ATCC as Bacillus subtilis (Ehrenberg) Cohn, Bacillus licheniformis (Weigmann) Chester ATCC® 21418™ deposited with ATCC as Bacillus subtilis by (Ehrenberg) Cohn, Bacillus licheniformis (Weigmann) Chester ATCC® 21424™ strain DSM 1969, Bacillus licheniformis (Weigmann) Chester ATCC® 21610™ strain B-201-7 deposited with ATCC as Bacillus subtilis (Ehrenberg) Cohn, Bacillus licheniformis (Weigmann) Chester ATCC® 21667™ strain FD 23612, Bacillus licheniformis (Weigmann) Chester ATCC® 21733™ strain DSM 1913 deposited with ATCC as Bacillus subtilis by (Ehrenberg) Cohn, Bacillus licheniformis (Weigmann) Chester ATCC® 25972™ strain 749/C, DSM 8782, DSM 46217, IMET10723, NCIB 9443, Bacillus licheniformis (Weigmann) Chester ATCC® 27326™ strain OM-81, Bacillus licheniformis (Weigmann) Chester ATCC® 27811™ strain 584, FERM-P 1038, Bacillus licheniformis (Weigmann) Chester ATCC® 31667™ strain DG 14, Bacillus licheniformis (Weigmann) Chester ATCC® 31972™ strain PM-3, Bacillus licheniformis (Weigmann) Chester ATCC® 33632™ strain (IOC) 2390, NCIB 11672, Bacillus licheniformis (Weigmann) Chester ATCC® 39326™, Bacillus licheniformis (Weigmann) Chester ATCC® 53757™ strain PWD-1, Bacillus licheniformis (Weigmann) Chester ATCC® 53926™ strain E312, Bacillus licheniformis (Weigmann) Chester ATCC® 55768™ strain O.W.U. 138B [OWU 138B], Bacillus licheniformis (Weigmann) Chester strain DSM 15, C, Bacillus licheniformis (Weigmann) Chester strain DSM 392, Bacillus licheniformis (Weigmann) Chester strain DSM 394, Bacillus licheniformis (Weigmann) Chester strain DSM 7259, NRRL-NRS 1263, Bacillus licheniformis (Weigmann) Chester strain DSM 7459, Bacillus licheniformis (Weigmann) Chester strain DSM 11258, Bacillus licheniformis (Weigmann) Chester strain DSM 11259, Bacillus licheniformis (Weigmann) Chester strain DSM 12369, Bacillus licheniformis (Weigmann) Chester strain DSM 12370, Bacillus licheniformis (Weigmann) Chester strain DSM 26543, Bacillus licheniformis (Weigmann) Chester strain DSM 28096, Bacillus licheniformis (Weigmann) Chester strain DSM 28591, Bacillus licheniformis (Weigmann) Chester strain DSM 30523, Bacillus licheniformis (Weigmann) Chester strain DSM 30535, Bacillus licheniformis (Weigmann) Chester strain DSM 30542, Bacillus licheniformis (Weigmann) Chester strain DSM 30585, Bacillus licheniformis (Weigmann) Chester strain DSM 30615, Bacillus licheniformis (Weigmann) Chester strain DSM 30620, Bacillus licheniformis (Weigmann) Chester strain DSM 30624, Bacillus licheniformis (Weigmann) Chester strain DSM 30643, Bacillus licheniformis (Weigmann) Chester strain DSM 30654, Bacillus licheniformis (Weigmann) Chester strain DSM 30724, Bacillus licheniformis (Weigmann) Chester strain DSM 30766, Bacillus licheniformis (Weigmann) Chester strain DSM 30769, Bacillus licheniformis (Weigmann) Chester strain DSM 30778, Bacillus licheniformis (Weigmann) Chester strain DSM 30779, Bacillus licheniformis (Weigmann) Chester strain DSM 30865, Bacillus licheniformis (Weigmann) Chester strain DSM 30926, Bacillus licheniformis (Weigmann) Chester strain DSM 30959, Bacillus licheniformis (Weigmann) Chester strain DSM 30960, Bacillus licheniformis (Weigmann) Chester strain DSM 30961, Bacillus licheniformis (Weigmann) Chester strain DSM 30976, Bacillus licheniformis (Weigmann) Chester strain DSM 31019, Bacillus licheniformis (Weigmann) Chester strain DSM 100653, Bacillus licheniformis (Weigmann) Chester strain DSM 100655, Bacillus licheniformis (Weigmann) Chester strain DSM 103059, Bacillus licheniformis (Weigmann) Chester strain NCIB 1525, 1229, Bacillus licheniformis (Weigmann) Chester strain NCIB 6816, Glaxo 417, Bacillus licheniformis (Weigmann) Chester strain NCIB 7224, Loos, Bacillus licheniformis (Weigmann) Chester strain NCIB 8536, P1, Bacillus licheniformis (Weigmann) Chester strain NCIB 8537, Ho, Bacillus licheniformis (Weigmann) Chester strain NCIB 9536, Gibson 1319, NRS 1553, Bacillus licheniformis (Weigmann) Chester strain NCIB 9667, 1, Bacillus licheniformis (Weigmann) Chester strain NCIB 9668, 2, Bacillus licheniformis (Weigmann) Chester strain NCIB 9669, 3, Bacillus licheniformis (Weigmann) Chester strain NCIB 10689, Bacillus licheniformis (Weigmann) Chester strain NCIB 11143, Bacillus licheniformis (Weigmann) Chester strain NCIB 11643, YNS7712R, Bacillus licheniformis (Weigmann) Chester strain NCIB 13497, Bacillus licheniformis (Weigmann) Chester strain NCIB 14014, DA33, Bacillus licheniformis B 1 (NRRL Deposit Number B-50907), Bacillus subtilis B2 (Deposit Number B-50908), Bacillus licheniformis RW25 (NRRL Deposit Number B-50911), Bacillus licheniformis RW32 (NRRL Deposit Number B-50912), and Bacillus licheniformis RW41 (NRRL Deposit Number B-50913), Bacillus licheniformis BL21 (NRRL B-50134), Bacillus licheniformis 3-12a (NRRL B-50504), Bacillus licheniformis 4-2a (NRRL B-50506), Bacillus licheniformis 842 (NRRL B-50516), Bacillus licheniformis DSM 5749 (BioPlus® 2B, Chr. Hansen Bio Systems), and Bacillus licheniformis OBT618 (ATCC PTA-122188).

4. Bacillus subtilis Strains

Bacillus subtilis (Ehrenberg) Cohn ATCC®82™ strain AMC, ATCC 8037, NRS 315, Bacillus subtilis (Ehrenberg) Cohn ATCC®82D-5™ strain designation: Genomic DNA from Bacillus subtilis strain AMC [ATCC® 82™], Bacillus subtilis (Ehrenberg) Cohn ATCC®465™ strain NRS 743, Bacillus subtilis (Ehrenberg) Cohn ATCC®4529™ strain 3, ATCC 8013, NCTC 2588, NRS 1004 deposited with ATCC as Bacillus vulgatus by Trevisan, Bacillus subtilis (Ehrenberg) Cohn ATCC®4925™ strain NRS 740 deposited with ATCC as Bacillus nigrificans by Fabian and Nienhuis, Bacillus subtilis (Ehrenberg) Cohn ATCC®4944™ strain NCTC, NRS 1106 deposited with ATCC as Bacillus parvus, Bacillus subtilis subspecies subtilis (Ehrenberg) Cohn ATCC® 6051™ strain Marburg strain, ATCC 6051-U, CCM 2216, CCRC 10255, CCUG 163B, CFBP 4228, CIP 52.65, DSM 10, IAM 12118, IFO 12210, IFO 13719, IFO 16412, IMET 10758, JCM 1465, LMG 7135, NCAIM B.01095, NCCB 32009, NCCB 53016, NCCB 70064, NCFB 1769, NCIB 3610, NCTC 3610, NRRL B-4219, NRS 1315, NRS 744, VKM B-501, NBRC 13719 deposited with ATCC as Bacillus subtilis (Ehrenberg) Cohn, Bacillus subtilis (Ehrenberg) Cohn ATCC®605 l1A™ strain P31K6, Bacillus subtilis bacteriophage phi-e ATCC®6051-B1™ strain Phi-e deposited with ATCC as phi e, Bacillus subtilis (Ehrenberg) Cohn ATCC®6460™ strain NRS 259 deposited with ATCC as Bacillus aterrimus by Lehmann and Neumann, Bacillus subtilis (Ehrenberg) Cohn ATCC®6461™ strain NRS 275, CN 2192, NCIB 8055 deposited with ATCC as Bacillus aterrimus by Lehmann and Neumann, Bacillus subtilis subspecies spizizenii Nakamura et al. ATCC® 6633™ strain NRS 231, DSM 347, CCM 1999, IAM 1069, NCIB 8054, NCTC 10400, WDCM 00003 deposited with ATCC as Bacillus subtilis (Ehrenberg) Cohn, Bacillus subtilis subspecies spizizenii Nakamura et al. ATCC® 6633D-5™ strain designation: Genomic DNA from Bacillus subtilis subspecies spizizenii strain NRS 231 [ATCC®6633™] deposited with ATCC as Bacillus subtilis (Ehrenberg) Cohn, Bacillus subtilis subspecies spizizenii Nakamura et al. ATCC® CRM-6633™ strain NRS 231 deposited with ATCC as Bacillus subtilis (Ehrenberg) Cohn, Bacillus subtilis subspecies spizizenii Nakamura et al. ATCC® 6633-MINI-PACK™ strain NRS 231 deposited with ATCC as Bacillus subtilis (Ehrenberg) Cohn, Bacillus subtilis (Ehrenberg) Cohn ATCC®6984™ strain NRS 747 deposited with ATCC as Bacillus vulgatus subspecies hydrolyticus, Bacillus subtilis (Ehrenberg) Cohn ATCC®7003™ strain NRS 730, Bacillus subtilis (Ehrenberg) Cohn ATCC®7058™ strain NRS 351, Bacillus subtilis (Ehrenberg) Cohn ATCC®7059™ strain NRS 352, Bacillus subtilis (Ehrenberg) Cohn ATCC®7060™ strain NRS 659, Bacillus subtilis (Ehrenberg) Cohn ATCC®7067™ strain NRS 238, ATCC 7974, ATCC 8012, Bacillus subtilis (Ehrenberg) Cohn ATCC®7480™ strain NRS 1107 deposited with ATCC as Bacillus endoparasiticus by (Benedek) Benedek, Bacillus subtilis (Ehrenberg) Cohn ATCC®8188™ strain ATCC 8450, NRS 773 deposited with ATCC as Tyrothrix minimus, Bacillus subtilis (Ehrenberg) Cohn ATCC®8473™ strain NRS 762, Bacillus subtilis (Ehrenberg) Cohn ATCC®9466™ strain designation: FDA strain PCI 220 [BUCSAV 170, NCIB 8159, NRRL B-558, NRS 1088], Bacillus subtilis (Ehrenberg) Cohn ATCC®9524™ strain 3R9675, NRS 1109, Bacillus subtilis (Ehrenberg) Cohn ATCC®9799™ strain NCTC 6276, NRS 1125, Bacillus subtilis (Ehrenberg) Cohn ATCC®9858™ strain NRS 237, NCIB 8063, Bacillus subtilis (Ehrenberg) Cohn ATCC®9943™ strain NRS 979, Bacillus subtilis (Ehrenberg) Cohn ATCC®10774™ strain BU169, NCIB 8872, Bacillus subtilis (Ehrenberg) Cohn ATCC®10783™ strain NRRL B-543, Bacillus subtilis (Ehrenberg) Cohn ATCC® 11774™ strain NCTC 8236, DSM 2109, Bacillus subtilis (Ehrenberg) Cohn ATCC®11838™ strain AMC 46-A-6 (strain I), NCIB 8850, Bacillus subtilis (Ehrenberg) Cohn ATCC®12100™ strain NCA 1558, ND 957, Bacillus subtilis (Ehrenberg) Cohn ATCC®12432™ strain MB 32, 56R188, ATCC 13597, NCIB 8993, Bacillus subtilis (Ehrenberg) Cohn ATCC®12695™ strain 51-52, Bacillus subtilis (Ehrenberg) Cohn ATCC®12711™ strain PRL B92, Ra, Bacillus subtilis (Ehrenberg) Cohn ATCC®13542™ Bacillus subtilis (Ehrenberg) Cohn ATCC®13933™ strain NRRL B-1471, Bacillus subtilis (Ehrenberg) Cohn ATCC®13952™ strain 1346, Bacillus subtilis (Ehrenberg) Cohn ATCC®14410™ strain 625, NRS 1115 deposited with ATCC as Bacillus borborokoites by ZoBell and Upham, Bacillus subtilis (Ehrenberg) Cohn ATCC®14415™ strain 569, NRS 1120 deposited with ATCC as Bacillus submarinus by ZoBell and Upham, Bacillus subtilis (Ehrenberg) Cohn ATCC®14416™ strain 576, NRS 1121 deposited with ATCC as Bacillus thalassokoites by ZoBell and Upham, Bacillus subtilis (Ehrenberg) Cohn ATCC®14593™ strain IAM 1145, Bacillus subtilis (Ehrenberg) Cohn ATCC®14617™ strain A-1625, Bacillus subtilis (Ehrenberg) Cohn ATCC®14660™ strain C30-1, Bacillus subtilis (Ehrenberg) Cohn ATCC®14662™ strain C30-109, Bacillus subtilis (Ehrenberg) Cohn ATCC®14807™ strain MB-155, Bacillus subtilis (Ehrenberg) Cohn ATCC®15040™ strain SX-67, Bacillus subtilis (Ehrenberg) Cohn ATCC®15041™ strain SX-92, Bacillus subtilis (Ehrenberg) Cohn ATCC®15134™ deposited with ATCC as Bacillus uniflagellatus by Mann, Bacillus subtilis (Ehrenberg) Cohn ATCC®15183™ strain 309, Bacillus subtilis (Ehrenberg) Cohn ATCC®15244™ strain 3369, Bacillus subtilis (Ehrenberg) Cohn ATCC®15245™ strain 3349, 1AM 1-3 deposited with ATCC as Bacillus natto by Sawamura, Bacillus subtilis (Ehrenberg) Cohn ATCC®15476™ strain M-4-45, Bacillus subtilis (Ehrenberg) Cohn ATCC®15477™ strain M-24-1 deposited with ATCC as Bacillus pumilus by Meyer and Gottheil, Bacillus subtilis (Ehrenberg) Cohn ATCC®15561™ strain K-X-1, A-1, Bacillus subtilis (Ehrenberg) Cohn ATCC®15563™ strain Marburg, Bacillus subtilis bacteriophage SP8 ATCC®15563-B1™ strain SP8 deposited with ATCC as SP8 bacteriophage, Bacillus subtilis (Ehrenberg) Cohn ATCC®15575™ strain SB 19, Bacillus subtilis (Ehrenberg) Cohn ATCC®15811™ strain 5380, Bacillus subtilis (Ehrenberg) Cohn ATCC®15818™ strain RIA 445, Bacillus subtilis (Ehrenberg) Cohn ATCC®15819™ strain RIA 447, Bacillus subtilis (Ehrenberg) Cohn ATCC® 15841™, Bacillus subtilis bacteriophage S-a ATCC®15841-B1™ strain S-a deposited with ATCC as S-a bacteriophage, Bacillus subtilis (Ehrenberg) Cohn ATCC®19659™ strain PRD 66, IFO 13722, Bacillus subtilis (Ehrenberg) Cohn ATCC®19659-MINI-PACK™ strain PRD 66, IFO 13722, Bacillus subtilis (Ehrenberg) Cohn ATCC®21008™ strain 182-H-86 deposited with ATCC as Bacillus pumilus by Meyer and Gottheil, Bacillus subtilis (Ehrenberg) Cohn ATCC®21183™ strain 5221, Bacillus subtilis (Ehrenberg) Cohn ATCC®21228™ strain SC 8548, SO-4, DSM 1970, Bacillus subtilis (Ehrenberg) Cohn ATCC®21331™ strain IFO 35, Bacillus subtilis (Ehrenberg) Cohn ATCC®21332™ strain IAM 1213, Bacillus subtilis (Ehrenberg) Cohn ATCC®21394™ strain 4-3-Ky, DSM 1971 deposited with ATCC as Bacillus subtilis subspecies sakainensis, Bacillus subtilis (Ehrenberg) Cohn ATCC®21555™ strain Y 13, Bacillus subtilis (Ehrenberg) Cohn ATCC®21556™, Bacillus subtilis (Ehrenberg) Cohn ATCC®21742™ strain AHr-5, Bacillus subtilis (Ehrenberg) Cohn ATCC®21770™ strain SP-3 deposited with ATCC as Bacillus cereus by Frankland and Frankland, Bacillus subtilis (Ehrenberg) Cohn ATCC®21951™ strain 716, IFO 13322 deposited with ATCC as Bacillus pumilus by Meyer and Gottheil, Bacillus subtilis (Ehrenberg) Cohn ATCC®23059™ strain W23, Bacillus subtilis (Ehrenberg) Cohn ATCC®23856™ strain EMG 50, SB 19, Bacillus subtilis (Ehrenberg) Cohn ATCC®23857™ strain 168, Bacillus subtilis (Ehrenberg) Cohn ATCC®23857D-5™ strain Designation: Genomic DNA from Bacillus subtilis strain 168 [ATCC® 23857™], Bacillus subtilis (Ehrenberg) Cohn ATCC®23858™ strain EMG 52, Bacillus subtilis (Ehrenberg) Cohn ATCC®23859™ strain EMG 53, Bacillus subtilis (Ehrenberg) Cohn ATCC®25369™ strain 24028 deposited with ATCC as Bacillus pulvifaciens by Nakamura, Bacillus subtilis (Ehrenberg) Cohn ATCC®27328™ strain C, Bacillus subtilis (Ehrenberg) Cohn ATCC®27370™ strain 168 M, Bacillus subtilis bacteriophage SPO1 ATCC®27370-B1™ strain SPO1 deposited with ATCC as SPO1, Bacillus subtilis (Ehrenberg) Cohn ATCC®27505™ strain K49, HER 1346 deposited with ATCC as Bacillus subtilis subspecies amyloliquefaciens, Bacillus subtilis (Ehrenberg) Cohn ATCC®27689™ strain SB 168 (trp-), Bacillus subtilis (Ehrenberg) Cohn ATCC®29056™ strain SB 100, Bacillus subtilis (Ehrenberg) Cohn ATCC®29233™ strain X6, Bacillus subtilis (Ehrenberg) Cohn ATCC®31002™ strain Ahr.AUr-9, FERM-1998, Bacillus subtilis (Ehrenberg) Cohn ATCC®31028™ strain FD 6404 deposited with ATCC as Bacillus globigii by Migula, Bacillus subtilis (Ehrenberg) Cohn ATCC®31091™ strain 1054, IFO 13586, Bacillus subtilis (Ehrenberg) Cohn ATCC®31094™ strain 1097, IFO 13621, Bacillus subtilis (Ehrenberg) Cohn ATCC®31098™ strain 1027, IFO 13585 deposited with ATCC as Bacillus pumilus by Meyer and Gottheil, Bacillus subtilis subspecies subtilis (Ehrenberg) Nakamura et al. ATCC®31578™ strain DSM 6223, RUB 331, Bacillus subtilis (Ehrenberg) Cohn ATCC®31954™ strain MO7S-16/11, Bacillus subtilis (Ehrenberg) Cohn ATCC®33234™ strain NCIB 10106, Bacillus subtilis (Ehrenberg) Cohn ATCC®35021™ strain 5230, NRS 6, Bacillus subtilis (Ehrenberg) Cohn ATCC®35854™ strain NRRL B-3411, Bacillus subtilis (Ehrenberg) Cohn ATCC®35946™ strain OSU 75, Bacillus subtilis subspecies subtilis (Ehrenberg) Nakamura et al. ATCC®37014™ strain DSM 6224, BD170, pSA2100, Bacillus subtilis subspecies subtilis (Ehrenberg) Nakamura et al. ATCC®37015™ strain DSM 4514, BD170, NCIB 11624, pUB 110, Bacillus subtilis subspecies subtilis (Ehrenberg) Nakamura et al. ATCC®37108™ strain DSM 4873, BGSC 1E32, BR151, pPL608, Bacillus subtilis subspecies subtilis (Ehrenberg) Nakamura et al. ATCC®37128™ strain DSM 4554, BGSC 1E18, pE194, Bacillus subtilis subspecies subtilis (Ehrenberg) Nakamura et al. ATCC®39090™ strain DSM 6198, BGSC 1S53, Bacillus subtilis (Ehrenberg) Cohn ATCC®39320™ strain MB 4488, Bacillus subtilis (Ehrenberg) Cohn ATCC®39374™ strain MB 3575, Bacillus subtilis (Ehrenberg) Cohn ATCC®39706™ strain B1-20, Bacillus subtilis (Ehrenberg) Cohn ATCC®43223™ strain ABM261, Bacillus subtilis (Ehrenberg) Cohn ATCC®49343™ strain IMVS 0101, Bacillus subtilis (Ehrenberg) Cohn ATCC®49760™ deposited with ATCC as Bacillus globigii by Migula, Bacillus subtilis (Ehrenberg) Cohn ATCC®49822™ deposited with ATCC as Bacillus globigii by Migula, Bacillus subtilis (Ehrenberg) Cohn ATCC®55033™ strain SMS274, Bacillus subtilis (Ehrenberg) Cohn ATCC®55060™ strain MB 4974, Bacillus subtilis (Ehrenberg) Cohn ATCC®55405™ strain 300, Bacillus subtilis subspecies inaquosorum ATCC®55406™ strain DA33 deposited with ATCC as Bacillus licheniformis (Weigmann) Chester, Bacillus subtilis (Ehrenberg) Cohn ATCC®55422™ strain SC 15257, Bacillus subtilis (Ehrenberg) Cohn ATCC®55614™ strain 1.2, AQ153, Bacillus subtilis (Ehrenberg) Cohn ATCC®55675™ strain BPO1, Bacillus subtilis subspecies subtilis (Ehrenberg) Nakamura et al. strain DSM 402, BRC 111470, NCIB 10106, Bacillus subtilis subspecies spizizenii Nakamura et al. strain DSM 618, Bacillus subtilis subspecies spizizenii Nakamura et al. strain DSM 1087, Bacillus subtilis (Ehrenberg) Cohn strain DSM 1088, IFO 13169, NBRC 13169, OUT 8353, Bacillus subtilis (Ehrenberg) Cohn strain DSM 1089, IFO 3026, NBRC 3026, OUT 8350, Bacillus subtilis subspecies subtilis (Ehrenberg) Nakamura et al. strain DSM 1090, OUT 8424, Bacillus subtilis subspecies subtilis (Ehrenberg) Nakamura et al. strain DSM 1091, OUT 8425, Bacillus subtilis (Ehrenberg) Cohn strain DSM 1092, IFO 3009, NBRC 3009, OUT 8235, Bacillus subtilis subspecies subtilis (Ehrenberg) Nakamura et al. strain DSM 3256, IAM 1213, Bacillus subtilis subspecies subtilis (Ehrenberg) Nakamura et al. strain DSM 3257, IAM 1259, Bacillus subtilis (Ehrenberg) Cohn strain DSM 3258, IAM 1260, Bacillus subtilis (Ehrenberg) Cohn strain DSM 4181, NCA 72-52, SA 22, Bacillus subtilis subspecies subtilis (Ehrenberg) Nakamura et al. strain DSM 4393, pC194, SB202, Bacillus subtilis (Ehrenberg) Cohn strain DSM 4449, natto 3335 UM4, Bacillus subtilis (Ehrenberg) Cohn strain DSM 4450, natto 3335 UM8, pLS20, pBC16, Bacillus subtilis (Ehrenberg) Cohn strain DSM 4451 Bacillus subtilis (Ehrenberg) Cohn strain DSM 4515, DB163, pGR71, Bacillus subtilis (Ehrenberg) Cohn strain DSM 4608, BR157, pMW1, Bacillus subtilis subspecies subtilis (Ehrenberg) Nakamura et al. strain DSM 4750, 1E7, BGSC 1E7, pE194-cop6, Bacillus subtilis subspecies subtilis (Ehrenberg) Nakamura et al. strain DSM 4751, 1E34, BGSC 1E34, pAM77, Bacillus subtilis subspecies subtilis (Ehrenberg) Nakamura et al. strain DSM 4871, BD426, BGSC 1E21, pBD8, Bacillus subtilis subspecies subtilis (Ehrenberg) Nakamura et al. strain DSM 4872, BD466, BGSC 1E24, pBD10, Bacillus subtilis subspecies subtilis (Ehrenberg) Nakamura et al. strain DSM 4874, BGSC 1E38, pMK3, YB886, Bacillus subtilis subspecies subtilis (Ehrenberg) Nakamura et al. strain DSM 5213, BGSC 1A40, BR 151, Bacillus subtilis subspecies subtilis (Ehrenberg) Nakamura et al. strain DSM 5214, BD 393, BGSC 1A511, Bacillus subtilis subspecies subtilis (Ehrenberg) Nakamura et al. strain DSM 5545, BGSC 1A459/SU+III, Bacillus subtilis subspecies subtilis (Ehrenberg) Nakamura et al. strain DSM 5547, Bacillus subtilis (Ehrenberg) Cohn strain DSM 5552, Bacillus subtilis (Ehrenberg) Cohn strain DSM 5611, NRRL B-360, Bacillus subtilis subspecies subtilis (Ehrenberg) Nakamura et al. strain DSM 5660, NRRL B-362, Bacillus subtilis subspecies spizizenii Nakamura et al. strain DSM 6395, BGSC 2A2, W23 2A2, WB 672, Bacillus subtilis (Ehrenberg) Cohn strain DSM 6397, BGSC 1A2, SB 491, Bacillus subtilis subspecies spizizenii Nakamura et al. strain DSM 6399, BGSC 2A1, SB 623

Bacillus subtilis subspecies spizizenii Nakamura et al. strain DSM 6405, BGSC 2A3, W23 SR, Bacillus subtilis subspecies subtilis (Ehrenberg) Nakamura et al. strain DSM 6887, BGSC 1A309, NP40, Bacillus subtilis subspecies subtilis (Ehrenberg) Nakamura et al. strain DSM 6889, 1A658, BGSC 1A658, DA 65 Bacillus subtilis subspecies spizizenii Nakamura et al. strain DSM 8439, CCM 2268, IAM 12021, Bacillus subtilis (Ehrenberg) Cohn strain DSM 13019, SSI MK1, Bacillus subtilis subspecies spizizenii Nakamura et al. strain DSM 15029, NRRL B-23049, Bacillus subtilis subspecies inaquosorum Rooney et al. strain DSM 21200, Bacillus subtilis (Ehrenberg) Cohn strain DSM 21393, Bacillus subtilis subspecies inaquosorum Rooney et al. strain DSM 22148, KCTC 13429, Bacillus subtilis (Ehrenberg) Cohn strain DSM 23521, Bacillus subtilis (Ehrenberg) Cohn strain DSM 23778, Bacillus subtilis (Ehrenberg) Cohn strain DSM 25152, Bacillus subtilis (Ehrenberg) Cohn strain DSM 28592, Bacillus subtilis (Ehrenberg) Cohn strain DSM 30512, Bacillus subtilis (Ehrenberg) Cohn strain DSM 30529, Bacillus subtilis (Ehrenberg) Cohn strain DSM 30533, Bacillus subtilis (Ehrenberg) Cohn strain DSM 30534, Bacillus subtilis (Ehrenberg) Cohn strain DSM 30540, Bacillus subtilis (Ehrenberg) Cohn strain DSM 30541, Bacillus subtilis (Ehrenberg) Cohn strain DSM 30551, Bacillus subtilis (Ehrenberg) Cohn strain DSM 30558, Bacillus subtilis (Ehrenberg) Cohn strain DSM 30562, Bacillus subtilis (Ehrenberg) Cohn strain DSM 30570, Bacillus subtilis (Ehrenberg) Cohn strain DSM 30581, Bacillus subtilis (Ehrenberg) Cohn strain DSM 30597, Bacillus subtilis (Ehrenberg) Cohn strain DSM 30642, Bacillus subtilis (Ehrenberg) Cohn strain DSM 30651, Bacillus subtilis (Ehrenberg) Cohn strain DSM 30652, Bacillus subtilis (Ehrenberg) Cohn strain DSM 30671, Bacillus subtilis (Ehrenberg) Cohn strain DSM 30676, Bacillus subtilis (Ehrenberg) Cohn strain DSM 30677, Bacillus subtilis (Ehrenberg) Cohn strain DSM 30682, Bacillus subtilis (Ehrenberg) Cohn strain DSM 30711, Bacillus subtilis (Ehrenberg) Cohn strain DSM 30723, Bacillus subtilis (Ehrenberg) Cohn strain DSM 30801, Bacillus subtilis (Ehrenberg) Cohn strain DSM 30924, Bacillus subtilis (Ehrenberg) Cohn strain DSM 30925, Bacillus subtilis (Ehrenberg) Cohn strain DSM 30927, Bacillus subtilis (Ehrenberg) Cohn strain DSM 30928, Bacillus subtilis (Ehrenberg) Cohn strain DSM 30929, Bacillus subtilis (Ehrenberg) Cohn strain DSM 30941, D1, Bacillus subtilis (Ehrenberg) Cohn strain DSM 30942, D-FC1, Bacillus subtilis (Ehrenberg) Cohn strain DSM 31008, Bacillus subtilis (Ehrenberg) Cohn strain DSM 31009, Bacillus subtilis (Ehrenberg) Cohn strain DSM 31010, Bacillus subtilis (Ehrenberg) Cohn strain DSM 31020, Bacillus subtilis (Ehrenberg) Cohn strain DSM 31021, Bacillus subtilis (Ehrenberg) Cohn strain DSM 31033, Bacillus subtilis (Ehrenberg) Cohn strain DSM 100605, Bacillus subtilis (Ehrenberg) Cohn strain DSM 100612, Bacillus subtilis (Ehrenberg) Cohn strain DSM 100613, Bacillus subtilis (Ehrenberg) Cohn strain DSM 100614, Bacillus subtilis (Ehrenberg) Cohn strain DSM 103044, Bacillus subtilis (Ehrenberg) Cohn strain DSM 103047, Bacillus subtilis (Ehrenberg) Cohn strain DSM 103051, Bacillus subtilis (Ehrenberg) Cohn strain DSM 103758, Bacillus subtilis AM0904 (NRRL Deposit Number B-50914), Bacillus subtilis AM0911 (NRRL Deposit Number B-50915), Bacillus subtilis NP122 (NRRL Deposit Number B-50910), Bacillus subtilis NP119B (NRRL Deposit Number B-50909), Bacillus subtilis BS18 (NRRL B-50633), Bacillus subtilis BS278 (NRRL 50634), Bacillus subtilis 4-7d (NRRL B-50505), Bacillus subtilis 3-5h (NRRL B-50507), Bacillus subtilis AGTP BS3BP5 (NRRL B-50510), Bacillus subtilis BS918 (NRRL B-50508), Bacillus subtilis AGTP BS1013 (NRRL-50509), Bacillus subtilis AGTP 944 (NRRL B-50548), Bacillus subtilis AGTP BS442 (NRRL B-50542), Bacillus subtilis AGTP BS1069 (NRRL B-50544), Bacillus subtilis AGTP BS521 (NRRL B-50545), Bacillus subtilis B27 (NRRL B-50105), Bacillus subtilis 3A-P4 (PTA-6506), Bacillus subtilis 22C-P1 (PTA-6508), Bacillus subtilis BL21 (NRRL B-50134), Bacillus subtilis strain GB03, Bacillus subtilis strain QST713, Bacillus subtilis DSM 5750 (BioPlus® 2B, Chr. Hansen Bio Systems).

5. Bacillus amyloliquefaciens Strains

Bacillus amyloliquefaciens (Fukumoto) Priest et al. (ATCC® 23350™), Bacillus amyloliquefaciens (Fukumoto) Priest et al. (ATCC® 23842™), Bacillus amyloliquefaciens SB 3296 (PTA-7548), Bacillus amyloliquefaciens (Fukumoto) Priest et al. (ATCC® 23843™), Bacillus amyloliquefaciens SB3297 (PTA-7549), Bacillus amyloliquefaciens (Fukumoto) Priest et al. (ATCC® BAA-390™), Bacillus amyloliquefaciens (Fukumoto) Priest et al. (ATCC® 23845™), Bacillus amyloliquefaciens (Fukumoto) Priest et al. (ATCC® 23844™), Bacillus amyloliquefaciens (Fukumoto) Priest et al. (ATCC® 31592™), Bacillus amyloliquefaciens (Fukumoto) Priest et al. (ATCC® 53495™), Bacillus amyloliquefaciens (Fukumoto) Priest et al. (ATCC® 49763™), Bacillus amyloliquefaciens: SB 3276 (PTA-7541), Bacillus amyloliquefaciens: PMBP-M7 (vial labeled BCRC PMBP-M7) (PTA-5819), Bacillus amyloliquefaciens SB 3284 (PTA-7545), Bacillus amyloliquefaciens SB 3288 (PTA-7546), Bacillus amyloliquefaciens MF215 (SB3446) (PTA-7790), Bacillus amyloliquefaciens SB 3283 (PTA-7544), Bacillus amyloliquefaciens MF 225 (SB 3448) (PTA-7791), Bacillus sp. (ATCC® 70038™, Deposited As Bacillus amyloliquefaciens (Fukumoto) Priest et al.).

C. Additional DFM(s)

The disclosed metal chelates can also be administered to an animal in combination with one or more additional DFMs. The additional DFM(s) may be any DFM suitable for administration to the particular animal. In some embodiments, the animal is a poultry, particularly a chicken or a turkey, and the additional DFM is a DFM that provides a benefit to the poultry. The additional DFM may be, by way of example and without limitation, an additional Bacillus species, Lactobacillus, Enterococcus, Bifidobacterium, Propionibacterium, Streptococcus, Pediococcus, yeast, or a combination thereof.

Exemplary additional DFMs include, but are not limited to, Bacillus alcalophilus, Bacillus alvei, Bacillus aminovorans, Bacillus aneurinolyticus, Bacillus anthracis, Bacillus aquaemaris, Bacillus atrophaeus, Bacillus boroniphilus, Bacillus brevis, Bacillus caldolyticus, Bacillus centrosporus, Bacillus cereus, Bacillus circulans, Bacillus firmus, Bacillus flavothermus, Bacillus fusiformis, Bacillus galliciensis, Bacillus globigii, Bacillus infernus, Bacillus larvae, Bacillus laterosporus, Bacillus lentus, Bacillus megaterium, Bacillus mesentericus, Bacillus mucilaginosus, Bacillus mycoides, Bacillus natto, Bacillus pantothenticus, Bacillus polymyxa, Bacillus pseudoanthracis, Bacillus pumilus, Bacillus schlegelii, Bacillus sphaericus, Bacillus sporothermodurans, Bacillus stearothermophilus, Bacillus thermoglucosidasius, Bacillus thuringiensis, Bacillus vulgatis, Bacillus weihenstephanensis, Lactobacillus acidophilis, Lactobacillus plantarum, Lactobacillus casei, Lactobacillus gallinarum, Lactobacillus lactis, Lactobacillus salivarius, Lactobacillus reuteri, Lactobacillus bulgaricus, Bifidobacterium pseudolongum, Bifidobacterium thermophilium, Bifidobacterium longum, Bifidobacterium lactis, Bifidobacterium animalis, Bifidobacterium bifidum, Bifidobacterium infantis, Streptococcus bovis, Streptococcus faecium, Enterococcus faecium, Enterococcus faecalis, Enterococcus diacetylactis, Saccharomyces cerevisiae, Saccharomyces boulardii Aspergillus oryzae, Aspergillus niger, Selenomonas ruminantium, Megasphaera elsdenii, Propionibacterium freudenreichii, Propionibacterium shermanii, Propionibacterium acidipropionici, Propionibacterium fensenii, Prevotella bryantii, Pediococcus acidilactici, Pediococcus cerevisiae, or a combination thereof. In certain embodiments, Bacillus pumilus may be administered in combination with the Bacilli combination.

D. Copper Species

Disclosed compositions and/or combinations comprising metal chelates may also be mixed with a copper species such as a copper species that provides a copper ion. The copper species may be a copper salt. Exemplary copper species include, but are not limited to, copper chloride, copper bromide, copper iodide, copper sulfate, copper sulfite, copper bisulfite, copper thiosulfate, copper phosphate, monobasic copper phosphate, dibasic copper phosphate, copper hypophosphite, copper dihydrogen pyrophosphate, copper tetraborate, copper borate, copper carbonate, copper bicarbonate, copper metasilicate, copper citrate, copper malate, copper methionate, copper succinate, copper lactate, copper formate, copper acetate, copper butyrate, copper propionate, copper benzoate, copper tartrate, copper ascorbate, copper gluconate, or a combination thereof, preferably copper sulfate, copper acetate, copper citrate, copper methionate, or a combination thereof. A copper species, such as a copper salt, may be provided separately, or individually, or it may be provided as part of a composition, such as a feed or a feed supplement.

E. Vitamins

Metal chelate compositions and/or compositions disclosed herein may also be used in combination with or administered as a composition with one or more vitamins. Exemplary vitamins include, but are not limited to, one or more of Vitamin A, Vitamin B 1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (including folic acid), Vitamin B 12 (various cobalamins; commonly cyanocobalamin in vitamin supplements), Vitamin C (ascorbic acid or a salt thereof, such as sodium ascorbate or calcium sorbate), Vitamin D (vitamin D₁, vitamin D₂, vitamin D₃, vitamin D₄, vitamin D₅, 25-hydroxy vitamin D₃, 25-dihydroxy vitamin D₃, or combinations thereof), Vitamin E, Vitamin K (K1 and K2 (i.e. MK-4, MK-7)), and biotin, and derivatives, salts and/or analogs thereof.

F. Feed

Disclosed metal chelate combinations and/or compositions may also be used in combination with a feed, or be used to form a feed composition. The feed may be any feed suitable for administration to an animal. The metal chelate may be administered in combination with the feed, such as by forming a mixture of the metal chelate and the feed, or by administering the metal chelate and the feed sequentially, in any order. For example, if the animal is poultry, then the metal chelate may be used as a composition comprising or in combination with a poultry feed, such as a poultry basal diet. The feed may comprise corn, alfalfa, peas, soybean meal, soybean oil, wheat, oats, sorghum, barley, rye, rice hulls, canola, corn oil, limestone, salt (for example, sodium chloride), distillers dried grains with solubles (DDGS), dicalcium phosphate, sodium sesquicarbonate, methionine source, lysine source, L-threonine, mineral oil, biotin, folic acid, kelp, menadione dimethylpyrimidinol bisulfite, calcium aluminosilicate, or any combination thereof. The feed may also comprise one or more additional components. Additional components may be used for any desired purpose, such as a substantially biologically inert material added, for example, as a filler, or to provide a desired beneficial effect. For example, the feed may include a carbonate (including a metal carbonate such as calcium carbonate); a trace mineral (such as, but not limited to, chloride, fluoride, iodide, chromium, copper, zinc, iron, magnesium, manganese, molybdenum, phosphorus, potassium, sodium, sulfur, selenium, or a combination thereof); a bulking agent; a carrier; a colorant; a taste enhancer; a preservative; one or more vitamins; or a combination thereof. The preservative may be benzoic acid or a salt thereof, e.g. sodium benzoate; lactic acid or a salt thereof, e.g. sodium lactate, potassium lactate or calcium lactate; propionic acid or a salt thereof, e.g. sodium propionate; ascorbic acid or a salt thereof, e.g. sodium ascorbate; gallic acid or a salt thereof e.g. sodium gallate; sulfur dioxide and/or sulfites; nitrites; nitrates; choline, or a salt thereof, such as an anion salt of choline, e.g. choline halide, such as chloride, bromide, iodide, fluoride, or choline hydroxide; or any combination thereof. The one or more vitamins may include vitamin A; vitamin B₁, such as thiamine mononitrate; vitamin B₂, such as riboflavin-5-phosphate; vitamin B₃, such as niacin or niacinamide; vitamin B₅, such as pantothenic acid or d-calcium pantothenate; vitamin B₆, such as pyridoxine or pyridoxine hydrochloride; vitamin B₁₂; vitamin C, such as ascorbic acid, sodium ascorbate, or calcium sorbate; vitamin D; vitamin E; vitamin K, or a combination thereof. Vitamin D may comprise vitamin D₁, vitamin D₂, vitamin D₃, vitamin D₄, vitamin D₅, 25-hydroxy vitamin D₃, 25-dihydroxy vitamin D₃, or combinations thereof.

The feed, such as a poultry feed, may also include fats and/or oils, such as tallow, optionally derived from the rendering of beef offal; lard, optionally derived from the rendering of pork offal; poultry fat, optionally derived from poultry offal; feed grade animal fat, optionally derived from a mixture of rendered beef, pork, and/or poultry raw material; yellow grease, optionally derived from reprocessed restaurant grease and/or cooking oil; and/or blended animal-vegetable fat, which may include blends of different types and/or amounts of animal fats and vegetable oils from restaurant grease. Additionally, or alternatively, the feed may include protein sources, such as canola, fish meal, field peas, meat and bone meal, soybeans, and/or cereal by-products.

G. Feed Supplements

Disclosed metal chelate compositions and/or combinations may, additionally or alternatively, comprise feed supplements. In some embodiments, the metal chelate is mixed with the feed supplement to form a mixture or composition comprising the metal chelate and the feed supplement(s). In other embodiments, the metal chelate is administered in combination with a feed supplement.

i. Yucca and/or Quiliaja or Extracts Thereof

Additionally, or alternatively, a disclosed combination comprising a metal chelate can be administered in combination with a feed supplement, such as Yucca and/or Quillaja plant material, or extracts thereof. Examples of Yucca include, but are not limited to, Yucca aloifolia, Yucca angustissima, Yucca arkansana, Yucca baccata, Yucca baileyi, Yucca brevifolia, Yucca campestris, Yucca capensis, Yucca carnerosana, Yucca cernua, Yucca coahuilensis, Yucca constricta, Yucca decipiens, Yucca declinata, Yucca de-smetiana, Yucca elata, Yucca endlichiana, Yucca faxoniana, Yucca filamentosa, Yucca filifera, Yucca flaccida, Yucca gigantean, Yucca glauca, Yucca gloriosa, Yucca grandiflora, Yucca harrimaniae, Yucca intermedia, Yucca jaliscensis, Yucca lacandonica, Yucca linearifolia, Yucca luminosa, Yucca madrensis, Yucca mixtecana, Yucca necopina, Yucca neomexicana, Yucca pallida, Yucca periculosa, Yucca potosina, Yucca queretaroensis, Yucca reverchonii, Yucca rostrata, Yucca rupicola, Yucca schidigera, Yucca schottii, Yucca sterilis, Yucca tenuistyla, Yucca thompsoniana, Yucca treculeana, Yucca utahensis, Yucca valida or combinations thereof. In certain embodiments, the Yucca is or comprises Yucca schidigera.

Examples of Quillaja include, but are not limited to, Quillaja brasiliensis, Quillaja lanceolata, Quillaja lancifolia, Quillaja molinae, Quillaja petiolaris, Quillaja poeppigii, Quillaja saponaria, Quillaja sellowiana, Quillaja smegmadermos or combinations thereof. In certain embodiments, the Quillaja is or comprises Quillaja saponaria.

A person of ordinary skill in the art will appreciate that, as used herein, a plant name may refer to the plant as a whole, or to any part of the plant, such as the roots, stem or trunk, bark, leaves, flower, flower stems, seeds, or a combination thereof. These plant parts may be used fresh, or dried, and may be whole, pulverized, or comminuted. The plant name may also refer to extracts from any part or parts of the plant, such as chemical extracts, or extracts obtained by pressing, or any other methods of concentrating or extracting oils or other extracts known to those in the art or that are hereafter discovered. Plant extracts may include compounds that are saponins, triterpenoids, polyphenols, antioxidants or resveratrol, or combinations thereof.

Disclosed metal chelate compositions and/or combinations may be used with Yucca and/or Quillaja, or may comprise a composition comprising Yucca and/or Quillaja that may also include carriers and binding agents suitable to formulate the Yucca and/or Quillaja for administration to an animal. In certain embodiments, such a composition can be a commercially available product, such as a composition comprising Yucca schidigera and Quillaja saponaria, sold under the trademark NUTRAFITO PLUS by Desert King International and/or MAGNI-PHI by Phibro Animal Health Corporation. Such compositions may comprise 85% Quillaja saponaria and 15% Yucca schidigera or 90% Quillaja saponaria and 10% Yucca schidigera.

2. Silica, Mineral Clay, Glucan and Mannans

Additionally, or alternatively, disclosed compositions and/or combinations comprising a metal chelate can be used with a feed supplement comprising silica, mineral clay, glucan and mannans. The feed supplement may further comprise an endoglucanohydrolase, either endogenously or as an affirmatively added ingredient. As used herein, weight % for endoglucanohydrolase is based on a 70,000 unit/gram endoglucanohydrolase product. The endoglucanohydrolase may be 3-1,3 (4)-endoglucanohydrolase.

In any embodiments disclosed herein, the feed supplement may comprise, consist essentially of, or consist of, glucan (e.g., β-1,3 (4)glucan), silica, mineral clay and mannans. In some embodiments, the feed supplement comprises, consists essentially of, or consists of, glucan (e.g., β-1,3 (4)glucan), silica, mineral clay, mannans and endoglucanohydrolase. In any embodiments disclosed herein, the glucan and mannans may be provided, at least in part, by yeast cell wall or an extract thereof. Thus, in some embodiments, the feed supplement may comprise, consist essentially of, or consist of, silica, mineral clay and yeast cell wall or an extract thereof, or the feed supplement may comprise, consist essentially of, or consist of, silica, mineral clay, yeast cell wall or an extract thereof, and endoglucanohydrolase. Similarly, endoglucanohydrolase may, in certain disclosed embodiments, be provided by yeast cell wall or a yeast cell wall extract.

Suitable sources of silica include, but are not limited to, sand, diatomaceous earth, and synthetic silica. In one embodiment, quartz may be used. In certain embodiments, the mannans comprise glucomannan.

The components of the feed supplement are prepared by methods commonly known in the art and can be obtained from commercial sources. β-1,3 (4)-endoglucanohydrolase may be produced from submerged fermentation of a strain of Trichoderma longibrachiatum. Diatomaceous earth is available as a commercially-available product with from 70% to 95% silica (SiO₂) and with its remaining components not assayed but primarily ash (minerals) as defined by the Association of Analytical Chemists (AOAC, 2002). The mineral clays (e.g., aluminosilicates) used in this feed supplement may be any of a variety of commercially-available clays including, but not limited to, montmorillonite clay, bentonite and zeolite. Glucan, mannans, and/or endoglucanohydrolase can be obtained from plant cell walls, yeast or yeast cell wall or an extract thereof (e.g., Saccharomyces cerevisiae, Candida utilis), certain fungi (e.g., mushrooms), algae, and bacteria. In certain embodiments, yeast can be administered affirmatively to provide glucan, mannans and endoglucanohydrolase endogenously.

In one embodiment, the feed supplement comprises, consists essentially of, or consists of, 1-40 wt % silica, 0.5-25 wt % glucan and mannans, and 40-92 wt % mineral clay, in amounts relative to each other. In another embodiment, the feed supplement comprises, consists essentially of, or consists of, 5-40 wt % silica, 0.5-15 wt % glucan and mannans, and 40-80 wt % mineral clay, in amounts relative to each other. In another embodiment, the feed supplement comprises, consists essentially of, or consists of, 20-40 wt % silica, 0.5-10 wt % glucan and mannans, and 50-70 wt % mineral clay, in amounts relative to each other. In another embodiment, the feed supplement comprises, consists essentially of, or consists of, 15-40 wt % silica, greater than zero to 15 wt % glucans, greater than zero to 10 wt % mannans, and 50-81 wt % mineral clay, in amounts relative to each other. In another embodiment, the feed supplement comprises, consists essentially of, or consists of, 15-40 wt % silica, 0.5-5.0 wt % glucans, 0.5-8.0 wt % mannans, and 50-81 wt % mineral clay, in amounts relative to each other. In another embodiment, the feed supplement comprises, consists essentially of, or consists of, 20-30 wt % silica, 0.5-3.5 wt % glucans, 0.5-6.0 wt % mannans, and 60-70 wt % mineral clay, in amounts relative to each other.

In some embodiments, 3-glucans and mannans are obtained from yeast or yeast cell wall or an extract thereof. The feed supplement may comprise, consist essentially of, or consist of, 1-40 wt % silica, 1-30 wt % yeast cell wall or an extract thereof, and 40-92 wt % mineral clay, in amounts relative to each other. In one embodiment, the feed supplement comprises, consists essentially of, or consists of, 10-40 wt % silica, 5-20 wt % yeast cell wall or an extract thereof, and 40-80 wt % mineral clay, in amounts relative to each other. In another embodiment, the feed supplement comprises, consists essentially of, or consists of, 15-30 wt % silica, 5-15 wt % yeast cell wall or an extract thereof, and 50-70 wt % mineral clay, in amounts relative to each other.

In any of the above embodiments, the feed supplement may further comprise an endoglucanohydrolase, such as β-1,3 (4)-endoglucanohydrolase. The feed supplement may include from 0.025 wt % endoglucanohydrolase to 5 wt % endoglucanohydrolase or more, such as from 0.05 wt % to 3 wt % β-1,3 (4)-endoglucanohydrolase, relative to the amounts of silica, mineral clay, glucan, mannans, and/or yeast, yeast cell wall, or yeast cell wall extract present in the feed supplement. In one embodiment, the feed supplement comprises, consists essentially of, or consists of, 0.1-3 wt % β-1,3 (4)-endoglucanohydrolase, 20-40 wt % silica, 0.5-20 wt % glucan and mannans, and 50-70 wt % mineral clay, in amounts relative to each other. In another embodiment, the feed supplement comprises, consists essentially of, or consists of, 0.1-3 wt %, β-1,3 (4)-endoglucanohydrolase, 20-40 wt % silica, 0.5-10 wt % glucan and mannans, and 50-70 wt % mineral clay, in amounts relative to each other. Alternatively, the feed supplement may comprise, consist essentially of, or consist of, 0.1-3 wt % β-1,3 (4)-endoglucanohydrolase, 1-40 wt % silica, 5-30 wt % yeast cell wall or an extract thereof, and 40-92 wt % mineral clay, in amounts relative to each other. In one embodiment, the feed supplement comprises, consists essentially of, or consists of, 0.1-3 wt % β-1,3 (4)-endoglucanohydrolase, 10-40 wt % silica, 5-20 wt % yeast cell wall or an extract thereof, and 40-80 wt % mineral clay, in amounts relative to each other. In another embodiment, the feed supplement comprises, consists essentially of, or consists of, 0.1-3 wt % β-1,3 (4)-endoglucanohydrolase, 15-30 wt % silica, 5-15 wt % yeast cell wall or an extract thereof, and 50-70 wt % mineral clay, in amounts relative to each other.

In any of the above embodiments, the silica may be provided by diatomaceous earth. In any of the above embodiments, the glucans may be β-glucans. In some embodiments, the β-glucans can be obtained from yeast, or other materials, such as fungi, algae, bacteria, or the like. In any of the above embodiments, the mannans may comprise glucomannan.

The glucan and mannans (or yeast or yeast cell wall or an extract thereof) can be prepared by a method known to a person of ordinary skill in the art. Yeast cell wall or an extract thereof may have a feed supplement comprising 0-15% moisture and 85-100% dry matter. The dry matter may comprise 10-65% protein, 0-25% fats, 0-3% phosphorus, 5-30% β-glucan, 5-35% mannans, and 0-15% ash. In an independent embodiment, a commercial source of 3-1,3 (4) glucan and glucomannan derived from primary inactivated yeast (Saccharomyces cerevisiae) with the following chemical feed supplement can be used: moisture 2-5%; proteins 40-50%; fats 3-8%; phosphorus 0-2%; mannans 10-16%; β-1,3-(4) glucan 10-20%; and ash 2-12%.

In another independent embodiment, the yeast cell wall or an extract thereof comprises moisture 1-7% and dry matter 93-99%, and the dry matter may comprise proteins 18-28%, fats 10-17%, phosphorus 0-2%, mannans 20-30%, β-1,3-(4) glucan 18-28%, and ash 2-5%.

In an independent embodiment of the feed supplement, silica, glucan and mannans, and mineral clay are combined at 1-40%, 0.5-25% and 40-92% by weight, respectively. In an independent embodiment of the feed supplement and/or combination, β-1,3 (4)-endoglucanohydrolase, diatomaceous earth, yeast cell wall or an extract thereof, and mineral clay are combined at 0.05-3%, 1-40%, 1-20% and 40-92% by weight, respectively. In an independent feed supplement and/or combination, 3-1,3 (4)-endoglucanohydrolase, diatomaceous earth, yeast cell wall or an extract thereof, and mineral clay are combined at 0.1-3%, 5-40%, 2-15% and 40-80% by weight, respectively. In another independent embodiment of the feed supplement and/or combination, 3-1,3 (4)-endoglucanohydrolase, diatomaceous earth, yeast cell wall or an extract thereof, and mineral clay are combined at 0.1-3%, 30-40%, 4-15% and 50-65% by weight, respectively.

The feed supplement may further comprise one or more additional components. Additional components may be used for any desired purpose, such as a substantially biologically inert material added, for example, as a filler, or to provide a desired beneficial effect. For example, the feed supplement may include a carbonate (including a metal carbonate such as calcium carbonate); a trace mineral, such as, but not limited to, chloride, fluoride, iodide, chromium, copper, zinc, iron, magnesium, manganese, molybdenum, phosphorus, potassium, sodium, sulfur, selenium, or a combination thereof, a bulking agent; a micro tracer, such as iron particles coated with a dye; yeast; allicin; alliin; allinase; algae; a polyphenol or plant material comprising polyphenol; a carrier; a colorant; a taste enhancer; a preservative; an oil; a vitamin; a sorbic acid or a salt thereof, or a combination thereof. The yeast may be yeast culture, active yeast, a live yeast, a dead yeast, yeast extract, or a combination thereof. The preservative may be benzoic acid or a salt thereof, e.g. sodium benzoate; lactic acid or a salt thereof, e.g. sodium lactate, potassium lactate or calcium lactate; propionic acid or a salt thereof, e.g. sodium propionate; ascorbic acid or a salt thereof, e.g. sodium ascorbate; gallic acid or a salt thereof e.g. sodium gallate; sulfur dioxide and/or sulfites; nitrites; nitrates; choline, or a salt thereof, such as an anion salt of choline, e.g. choline halide, such as chloride, bromide, iodide, fluoride, or choline hydroxide; or any combination thereof. The oil may be mineral oil, corn oil, soybean oil, or a combination thereof. The sorbic acid or salt thereof may be potassium sorbate, sodium sorbate, ammonium sorbate, or a combination thereof. The vitamin may be vitamin A, vitamin B₁, vitamin B₂, vitamin B₃, vitamin B₅, vitamin B₆, vitamin B₁₂, vitamin C, vitamin D, vitamin E, vitamin K, or a combination thereof.

In some embodiments, the feed supplement does not comprise additional components. In other embodiments, the feed supplement comprises from greater than zero to 40% or more by weight additional components, such as from 0.1% to 40% by weight, or from 0.2% to 35% by weight additional components. In certain embodiments, the feed supplement comprises from 0.1% to 5% by weight additional components, such as from 0.2% to 3% by weight. In other embodiments, the feed supplement comprises from 5% to 20% by weight additional components, such as from 10% to 15% by weight. And in further embodiments, the feed supplement comprises from 20% to 40% by weight additional components, such as from 30% to 35% by weight additional components.

In some embodiments, the feed supplement comprises, consists essentially of, or consists of, silica, mineral clay, glucan, mannans, and endoglucanohydrolase; silica, mineral clay, glucan, mannans, endoglucanohydrolase, micro tracers and mineral oil; silica, mineral clay, glucan, mannans, endoglucanohydrolase, micro tracers, mineral oil, and vitamins; silica, mineral clay, glucan, mannans, endoglucanohydrolase, micro tracers, mineral oil, vitamins, and potassium sorbate; silica, mineral clay, glucan, mannans, endoglucanohydrolase, vitamins, and active yeast; silica, mineral clay, glucan, mannans, endoglucanohydrolase, micro tracers, mineral oil, and active yeast; silica, mineral clay, glucan, mannans, endoglucanohydrolase, and mineral oil; silica, mineral clay, glucan, mannans, endoglucanohydrolase, vitamins, and calcium carbonate; silica, mineral clay, glucan, mannans, endoglucanohydrolase, micro tracers, and wheat fiber; or silica, mineral clay, glucan, mannans, endoglucanohydrolase, and micro tracers. In any of these embodiments, the glucan and mannans may be provided by yeast, yeast cell wall, or yeast cell wall extract.

In some embodiments, the feed supplement does not comprise a peroxide compound. In some embodiments, the feed supplement does not comprise hydrogen peroxide. In some embodiments, the feed supplement does not comprise carbamide peroxide. In some embodiments, the feed supplement does not comprise urea. In some embodiments, the feed supplement does not comprise hydrogen peroxide and urea.

In certain embodiments, the feed supplement is a powdered supplement. In other embodiments, the feed supplement is a granulated supplement. The granulated feed supplement may comprise silica, mineral clay, glucan and/or mannans, and optionally endoglucanohydrolase as discussed above. The granulated feed supplement may have a bulk loose density of from 40 lb/ft³ to 150 lb/ft³. In some embodiments, each granule in the granular composition comprises silica, mineral clay, glucan and/or mannans, and optionally endoglucanohydrolase, in relative amounts substantially the same as a relative amount of each ingredient in the composition as whole. Each granule in the granular composition may comprise, consist essentially of, or consist of, silica, mineral clay, glucan, mannans and endoglucanohydrolase. Alternatively, or additionally, each granule may comprise a substantially homogenous blend of silica, mineral clay, glucan and mannans, and optionally endoglucanohydrolase. The composition may comprise greater than 40% by weight granules having at least one dimension between 0.149 mm (100 mesh, U.S. standard mesh size) and 4.76 mm (4 mesh), and in some embodiments, the composition comprises greater than 90% by weight granules having at least one dimension between 0.149 mm (100 mesh) and 2 mm (10 mesh). And/or the composition may comprise from greater than 0% to 100% granules by weight and from 0% to no more than 60%, such as no more than 10%, particles by weight, the granules having at least one dimension between 10 mesh (2.00 mm) and 100 mesh (0.149 mm), and the particles having at least one dimension of less than (i.e., smaller than) 100 mesh (0.149 mm). In any embodiments, the granular composition comprises plural granules, each granule comprising silica, mineral clay, glucan and mannans, the granules having a size that when administered to an animal increases expression of interleukin 10 receptor 1 (IL 10RB) for a time period subsequent to administration, such as subsequent to the onset of administration, relative to an animal that does not receive the composition. In some embodiments the time period may be from the start of administration to from 28 days to at least 42 days. And/or the composition may have a mineral coefficient of variation of from 0% to 10%, or a proximate coefficient of variation of from 0% to 20%, or both. Additional information concerning the granular feed supplement can be found in U.S. application No. 62/449,959 which is incorporated herein by reference in its entirety.

In some embodiments, the feed supplement is administered daily to an animal at time intervals believed or determined to be effective for achieving a beneficial result. The feed supplement may be administered in a single dose daily or in divided doses throughout the day. The amount may be from greater than zero to 500 grams per animal per day, such as from 0.5 grams to 250 grams, from 5 grams to 200 grams, or from 10 grams to 70 grams per animal per day. Alternatively, the feed supplement may be fed or administered in an amount of from greater than zero to 1000 mgs or more per kilogram of the animal's body weight per day, such as from greater than zero to 500 mgs per kilogram body weight. In other embodiments, the feed supplement is fed or administered per weight of animal feed. The feed supplement may be fed or administered in an amount of from greater than zero to 150 kg per ton (2000 pounds) of feed, such as from 0.1 kg to 100 kg per ton of feed. Alternatively, the feed supplement may be fed or administered in an amount of from greater than zero to 20 grams per kilogram of feed, such as from greater than zero to 10 grams of feed.

3. Allicin, Alliin and/or Alliinase

Additionally, or alternatively, a combination and/or a composition comprising a metal chelate can be administered in combination with a feed supplement comprising allicin, alliin, alliinase, or any combination thereof. Allicin (diallyl thiosulfate; 2-Propene-1-sulfinothioic acid S-2-propenyl ester) is a compound found in garlic, such as raw garlic.

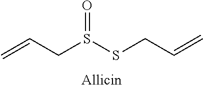

When extracted, it may be an oily, yellowish liquid. Allicin may have medicinal and/or health benefits when consumed by animals. Benefits of allicin include, but are not limited to, an immunity booster; a blood thinner; an anti-oxidant; an anti-bacterial agent, such as against E. coli; an anti-inflammatory; an anti-viral; an anti-fungal; or may alleviate symptoms of bacterial, viral or fungal infections. Allicin is typically produced from alliin ((2R)-2-amino-3-[(S)-prop-2-enylsulfinyl]propanoic acid) in damaged garlic cells by the action of the enzyme alliinase.

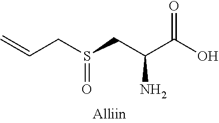

When the garlic cells are damaged, such as by chopping, crushing, or cooking the garlic, the alliinase enzyme converts the alliin into allicin. Allicin, alliin, and/or alliinase may be provided as whole garlic cloves or bulbs; crushed, mashed, or chopped garlic; a garlic extract; and/or as a synthesized or isolated compound.

4. Yeast

Additionally, or alternatively, a combination and/or composition comprising metal chelate can be administered in combination with a feed supplement comprising live microorganisms, such as yeast. The yeast may be a yeast culture, a live yeast, a dead yeast, yeast extract, or a combination thereof. The yeast may be a baker's yeast, a brewer's yeast, a distiller's yeast, a probiotic yeast or a combination thereof. Exemplary yeast's include, but are not limited to, Saccharomyces cerevisiae, Saccharomyces boulardii, Saccharomyces pastorianus, Brettanomyces bruxellensis, Brettanomyces anomalus, Brettanomyces custersianus, Brettanomyces naardenensis, and Brettanomyces nanus, Candida stellata, Schizosaccharomyces pombe, Torulaspora delbrueckii, or Zygosaccharomyces bailii.

5. Polyphenols

In some embodiments, a combination and/or composition comprising a metal chelate may further comprise a feed supplement comprising additives, such as, polyphenols, that are useful for the prevention and inhibition of inflammatory processes, thereby improving animal gut health which, in turn, improves both animal health and performance. The polyphenol may be provided by a plant extract from a polyphenol-containing plant material. The plant material also may include non-polyphenol compounds, including polyphenol degradation products, such as gallic acid and trans-caftaric acid. Degradation can occur, for example, through oxidative and/or biological processes. Both the polyphenols and the non-polyphenol compounds may have biological activity. The plant extract may be prepared from a single plant material or from a combination of plant materials. Suitable plant materials from which a plant extract can be obtained include, but are not limited to, apples, blackberries, black chokeberries, black currants, black elderberries, blueberries, cherries, cranberries, grapes, green tea, hops, onions, Quillaja, plums, pomegranates, raspberries, strawberries, and Yucca.

In some embodiments, the plant extract is prepared from a pressed plant material, such as grape pomace, a dried plant material, such as tea, or a combination thereof. Pomace may be obtained substantially immediately post-pressing or as an ensiled product, i.e., pomace collected and stored for up to several months post-pressing. Suitable plants have a plurality of polyphenols and/or other non-polyphenolic compounds including, but not limited to, non-polyphenolic organic acids (such as gallic acid and/or trans-caftaric acid), flavanols, gallate esters, flavanodiols, phloroglucinol, pyrogallol, and catechol. In some embodiments, the plant extract is prepared from Pinot noir pomace, Pinot gris pomace, or green tea.

In some embodiments, pressed or dried plant material is ground to a fine powder prior to, or during, extraction. Pressed plant materials may be frozen to facilitate grinding. Polyphenols and other non-polyphenolic compounds may be extracted for administration. For example, polyphenols and other non-polyphenolic compounds may be extracted from the powder using a solution comprising a polar solvent, such as water, an alcohol, an ester, or a combination thereof. In some embodiments, the solution comprises a water-miscible alcohol, ester, or combination thereof, such as a lower alkyl alcohol, lower alkyl ester, or a combination thereof. In some embodiments, the solution is water or an aqueous solution comprising 25-99% solvent, such as 25-95% solvent, 30-80% solvent, or 50-75% solvent, and water. In certain embodiments, the solution is an aqueous solution comprising methanol, ethanol, isopropanol, ethyl acetate, or a combination thereof. The solution may be acidified by addition of an acid. The acid may prevent or minimize oxidative degradation of biologically-active polyphenols and other non-polyphenolic compounds in the extract. The acid may be any suitable acid, such as a mineral acid (e.g., hydrochloric acid), or an organic acid such as citric acid or acetic acid. In some embodiments, the solution comprises from 0.01% to 1% acid, such as 0.02-0.5%, 0.025-0.25%, or 0.05-0.15%. In some examples, the solution includes 0.1% hydrochloric acid.

Extraction may be performed at a temperature ranging from 0-100° C. In some embodiments, extraction is performed at a temperature ranging from 20-70° C., or at ambient temperature. Extraction may be performed for a duration ranging from several minutes to several days. To increase extraction efficiency, the plant material and solution may be mixed or agitated during extraction, such as by grinding the plant material during extraction, stirring the mixture, shaking the mixture, or homogenizing the mixture. In some embodiments, the extraction may be repeated one or more times with fresh solution to increase recovery of polyphenols and other non-polyphenolic compounds from the plant material. The liquid phases from each extraction cycle are then combined for further processing.

The liquid phase can be recovered, and the residual solids, or pulp, are discarded. Recovering the liquid phase may comprise decanting the liquid from the remaining solids and/or filtering the liquid phase to remove residual solids. The solvent (alcohol, ester, or combination thereof) can be removed from the liquid solution by any suitable means, such as evaporation (e.g., roto-evaporation), to produce an aqueous extract containing the biologically-active components in a mildly acidic solution.

In certain embodiments where the plant material includes a significant amount of oils, or lipids, an initial extraction of nonpolar components may be performed before extracting the polyphenols and other polar, non-polyphenolic compounds. Nonpolar components may be extracted by homogenizing the plant material in a nonpolar solvent, e.g., hexanes, heptanes, or a combination thereof. The solvent layer including the extracted nonpolar components is separated from the plant material and discarded.

The aqueous plant extract may be further purified by suitable means, e.g., extraction, chromatographic methods, distillation, etc., to remove non-polyphenolic compounds and/or to increase the concentration of polyphenols relative to other compounds in the extract.

The aqueous plant extract may be dried, for example by freeze-drying or other low-temperature drying methods, and ground to a powder to provide a dried plant extract. In some embodiments, the dried plant extract comprises 0.01 wt % to 25 wt % total polyphenols, such as 0.01 wt % to 10 wt %, 0.01 wt % to 5 wt %, 0.01 wt % to 2.5 wt %, 0.01 wt % to 1 wt %, 0.01 wt % to 0.5 wt %, 0.02 to 0.25 wt %, or 0.03-0.1 wt % total polyphenols. In certain embodiments, the dried plant extract further comprises non-polyphenolic compounds. For example, the dried plant extract may comprise 0.01-1 mg/g gallic acid, such as 0.05-0.5 mg/g or 0.09-0.25 mg/g gallic acid, and/or 0.001-0.1 mg/g trans-caftaric acid, such as 0.005-0.05 mg/g or 0.01-0.025 mg/g trans-caftaric acid.

The aqueous plant extract may be concentrated to a smaller volume, e.g., by evaporation, and used as an aqueous plant extract. In other embodiments, the aqueous plant extract is mixed with a carrier before drying and grinding. Suitable carriers include, for example, diatomaceous earth, silica, maltodextrin, ground grain (e.g., corn), meals (e.g., soybean or cottonseed meal) by-products (e.g., distiller's dried grains, rice hulls, wheat mill run), clays (e.g., bentonite), and combination thereof. The plant extract may be combined with a carrier in a ratio ranging from 10:1 to 1:10 by weight, such as from 5:1 to 1:5. For example, the plant extract may be mixed with diatomaceous earth in a ratio of 3:1 by weight.

Additionally, or alternatively, the additional components may comprise corn, soybean meal, wheat, wheat fiber, barley, rye, rice hulls, canola, limestone, salt, distillers dried grains with solubles (DDGS), dicalcium phosphate, sodium sesquicarbonate, methionine source, lysine source, L-threonine, biotin, folic acid, kelp, menadione dimethylpyrimidinol bisulfite, calcium aluminosilicate, or any combination thereof.

Additional information concerning feed supplement and/or additional components can be found in PCT application No. PCT/US2015/053439, and U.S. application Ser. Nos. 15/359,342, 14/699,740, 14/606,862, and 62/449,959 each of which is incorporated herein by reference in its entirety.

H. Preservatives

In some embodiments, disclosed metal chelate compositions and/or combinations may comprise sorbic acid or a salt thereof. Sorbic acid, or a salt thereof, may act as a preservative, such as by inhibiting mold and/or yeast growth. The salt may be any suitable salt of sorbic acid, and in some embodiments, is a group I, group II, or organic salt of sorbic acid. Suitable salts include, but are not limited to, potassium sorbate, sodium sorbate, or ammonium sorbate.

I. Antimicrobial

Disclosed metal chelate compositions and/or combinations may, additionally or alternatively, comprise an antimicrobial. The antimicrobial may be an antibiotic, an antifungal, an antiparasitic, an antiviral, or a combination thereof. An antibiotic may be a tetracycline, a penicillin, a cephalosporin, a polyether antibiotic, a glycopeptide, an orthosomycin, or a combination thereof. The antibiotic may be selected from, by way of example, and without limitation, virginiamycin, Bacitracin MD, Zinc Bacitracin, Tylosin, Lincomycin, Flavomycin, bambermycins, Terramycin, Neo-Terramycin, florfenicol, oxolinic acid, oxytetracycline, hydrogen peroxide (Perox-Aid® 35%), bronopol (2-bromo-2-nitro-1,3-propanediol, Pyceze®), sulfadimethozine, ormetoprim, Sulfadiazine, Trimethoprim, or a combination thereof. In some embodiments, the antibiotic is not, or does not comprise, hydrogen peroxide. In some embodiments, the antibiotic is virginiamycin, Bacitracin MD, Zinc Bacitracin, Tylosin, Lincomycin, Flavomycin, bambermycins, Terramycin, Neo-Terramycin, florfenicol, oxolinic acid, oxytetracycline, bronopol (2-bromo-2-nitro-1,3-propanediol, Pyceze®), sulfadimethozine, ormetoprim, Sulfadiazine, Trimethoprim, or a combination thereof.

An antifungal may be selected from, by way of example, formalin, formalin-F, bronopol (2-bromo-2-nitro-1,3-propanediol, Pyceze®), or a combination thereof. Exemplary antiparasitics may be selected from an anticoccidal, copper sulfate, fenbendazole, formalin, formalin-F, hyposalinity, hadaclean A, praziquantel, emamectin benzoate (SLICE®), or a combination thereof.

Suitable anticoccidial agents include, but are not limited to, ionophores and chemical anticoccidial products. Ionophores can include, but are not limited to, Monensin, Salinomycin, Lasalocid, Narasin, Maduramicin, Semduramicin, or combinations thereof.

Chemical anticoccidial products can include, but are not limited to, Nicarbazin, Maxiban, Diclazuril, Toltrazuril, Robenidine, Stenorol, Clopidol, Decoquinate, DOT (zoalene), Amprolium, or combinations thereof.

J. Vaccines

Disclosed metal chelate compositions and/or combinations may, additionally or alternatively, comprise vaccines. Suitable vaccines can be selected from live coccidiosis vaccines, such as COCCIVAC (e.g., a composition comprising live oocysts of Eimeria acervulina, Eimeria mivati, Eimeria maxima, Eimeria mitis, Eimeria tenella, Eimeria necatrix, Eimeria praecox, Eimeria brunetti, Eimeria hagani, or combinations thereof), LivaCox (a composition comprising 300-500 live sporulated oocysts of each attenuated line of Eimeria acervulina, E. maxima and E. tenella in a 1% w/v aqueous solution of Chloramine B); ParaCox (a composition comprising live sporulated oocysts derived from E. acervulina HP, E. brunetti HP, E. maxima CP, E. maxima MFP, E. mitis HP, E. necatrix HP, E. praecox HP, E. tenella HP, and combinations thereof); Hatch Pack Cocci III (a composition comprising oocysts derived from Eimeria acervulina, Eimeria maxima, Eimeria tenella, or combinations thereof); INOVOCOX (a composition comprising oocysts derived from Eimeria acervulina, Eimeria maxima, Eimeria tenella, and a sodium chloride solution); IMMUCOX (a composition comprising live oocysts derived from Eimeria acervulina, Eimeria maxima, Eimeria necatrix, Eimeria tenella, and combinations thereof), Advent, or combinations thereof. Vaccines may also comprise live oocysts of the Eimeria genus, for example, Eimeria aurati, Eimeria baueri, Eimeria lepidosirenis, Eimeria leucisci, Eimeria rutile, Eimeria carpelli, Eimeria subepithelialis, Eimeria funduli and/or Eimeria vanasi. Vaccines may also comprise oocysts from the genus Epeimeria, a new genus of coccidia infecting fishes.

Other suitable vaccines include, but are not limited to, ALPHA DIP® 2000, ALPHA DIP® Vibrio, ALPHA MARINE® Vibrio, ALPHA DIP® ERM Salar, ALPHA JECT Micro® 1 ILA, ALPHA JECT Micro® 7ILA, ALPHA JECT® Panga, ALPHA JECT® 1000, ALHPA JECT® 2000, ALPHA JECT® 3000, ALPHA JECT® 3-3, ALPHA JECT® 4000, ALPHA JECT® 4-1, ALPHA JECT® 5-1, ALPHA JECT® 5-3, ALPHA JECT® 6-2, ALPHA JECT® micro 1 ISA, ALPHA JECT® micro 2, ALPHA JECT® micro 4, Apex®-IHN, AQUAVAC® ERM Oral, AQUAVAC® ERM immersion, AQUAVAC® FNM Injectable, AQUAVAC® IPN Oral, AQUAVAC® RELERA™, AQUAVAC® Vibrio Oral, AQUAVAC® Vibrio Pasteurella injection, AQUAVAC® Vibrio immersion and injectable, AQUAVAC-COL™ immersion, AQUAVAC-ESC™ immersion, Birnagen Forte 2, Ermogen, Forte Micro, Forte V II, Forte V1, Fry Vacc 1, Furogen Dip, ICTHIOVAC JG injection, ICTHIOVAC® PD immersion, Lipogen DUO, Lipogen Forte, Microvib, Norvax® Compact PD injection, Norvax® Minova 4WD, Norvax® Minova 6 injection, Norvax® STREP Si immersion and injection, Premium Forte Plus, Premium Forte Plus ILA, Renogen, Vibrogen 2, or a combination thereof.

K. Growth Promotants

Disclosed metal chelate compositions and/or combinations may, additionally or alternatively, further comprise growth promotants that can, for example, help increase the efficiency of animal production, such as by increasing the rate of weight gain, improved feed efficiency and/or product output. A growth promotant may also increase the quality of a product, such as increase the quality of meat produced. Growth promotants can include, but are not limited to, β-agonists, antibiotics, antimicrobials, steroids and hormones. In some embodiments, a growth promotant may be a compound that has one or more other uses and is used as a growth promotant at a lower dose than the dose for the primary application. For example, an antibiotic or antimicrobial compound may also be useful as a growth promotant when used at a sub-therapeutic dose. Exemplary growth promotants include, but are not limited to, 3-agonists such as ractopamine and zilpaterol; somatotropin such as bovine somatotropin (bST) and recombinant bovine somatotropin (rbST); ionophores such as monesin, lasalocid, laidlomycin, salinomycin and narasin; hormones such as oestrogen, progesterone, testosterone and analogs thereof; estradiol benzoate; tetracyclines, such as oxytetracycline, chlortetracycline, tetracycline, demeclocycline, doxycycline, lymecycline, meclocycline, methacycline, minocycline, rolitetracycline, and salts thereof, for example, hydrochloride, hydrobromide, hydroiodide, calcium, sodium, potassium, magnesium, or lithium salts; arsanilic acid; 4-hydroxy-3-nitrobenzenearsonic acid, erythromycin thiocyanate, tylosin phosphate, melengestrol acetate, iodinated casein, ethopabate, oleandomycin, penicillin G procaine, chlortetracycline, sulfathiazole, bambermycins, bacitracin, virginiamycin, chlortetracycline calcium complex, or salt and/or combinations thereof.

### IV. Method of Using

A. Animals

Embodiments of the disclosed combination and/or composition are fed and/or administered to an animal, such as a human or non-human animal. The animal may be a land animal, an aquatic animal, an avian, or an amphibian. The animal may be a mammal, or a non-mammal. The non-human animal can be an animal raised for human consumption or a domesticated animal. Examples of animals that can be fed and/or administered the disclosed combination include, but are not limited to, ruminant species, such as a sheep, goat, cow, deer, bison, buffalo, elk, alpaca, camel or llama; ungulates, such as a horse, donkey, or pig; avians, such as chickens, including laying hens and broilers, turkey, goose, duck, Cornish game hen, quail, partridge, pheasant, guinea-fowl, ostrich, emu, swan, or pigeon; aquatic animals, such as an aquaculture species, such as fish (e.g., salmon, trout, tilapia, sea bream, carp, cod, halibut, snapper, herring, catfish, flounder, hake, smelt, anchovy, lingcod, moi, perch, orange roughy, bass, tuna, mahi mahi, mackerel, eel, barracuda, marlin, Atlantic ocean perch, Nile perch, Arctic char, haddock, hoki, Alaskan Pollock, turbot, freshwater drum, walleye, skate, sturgeon, Dover sole, common sole, wolfish, sablefish, American shad, John Dory, grouper, monkfish, pompano, lake whitefish, tilefish, wahoo, cusk, bowfin, kingklip, opah, mako shark, swordfish, cobia, croaker, or hybrids thereof, and the like), crustaceans (e.g., lobster, shrimp, prawns, crab, krill, crayfish, barnacles, copepods, and the like), or molluscs (e.g., squid, octopus, abalone, conchs, rock snails, whelk, clams, oysters, mussels, cockles, and the like). Additionally, or alternatively, the animal may be a companion animal, such as canines; felines; rabbits; rodents, such as a rat, mouse, hamster, gerbil, guinea pig or chinchilla; birds, such as parrots, canaries, parakeets, finches, cockatoos, macaws, parakeets or cockatiel; reptiles, such as snakes, lizards, tortoises or turtles; fish; crustaceans; and amphibians, such as frogs, toads and newts.

B. Administration of Metal Chelates

The metal chelates disclosed herein can be administered at any effective dose as will be understood by a person of ordinary skill in the art. For example, the metal chelate composition and/or combination may be administered in an amount effective as a food supplement or in an amount effective as a biocidal agent. By way of example, the metal chelate may be administered to an animal, such as a human or non-human animal, alone such that the animal ingests and/or absorbs a total amount of the metal chelate (or an equivalent number of moles of the metal chelate) from about 1 mg to about 200 g per kg of the average body weight of the animal, such as, 5 mg to 150 g, 10 mg to 100 g, 50 mg to 50 g, 100 mg to 10 g, 500 mg to 50 g, or 1 g to 5 g. Exemplary amount includes, but is not limited to, 1 mg, 2 mg, 3 mg, 4 mg, 5 mg, 10 mg, 50 mg, 100 mg, 500 mg, 1 g, 5 g, 10 g, 50 g, 100 g, 150 g, or 200 g per kg of the average body weight of the animal. Additionally, or alternatively, the metal chelates may be combined with one or more additional components in an amount from about 0.001 to 20 g of the metal chelate per kg of feed, such as 0.002 to 15 g/kg, or at least about 0.002 g/kg, 0.005 g/kg, 0.01 g/kg, 0.02 g/kg, 0.05 g/kg, 0.1 g/kg, 0.5 g/kg, 1 g/kg, 2 g/kg, 5 g/kg, 10 g/kg, 15 g/kg of the feed. A person of ordinary skill in the art will understand that when one or more metal chelates disclosed herein are administered, either alone or in combination, with one or more additional components will result in the above amounts absorbed by the animal.

C. Embodiments of a Combination

The metal chelates disclosed herein can be combined with one or more additional components disclosed herein to obtain a composition and/or combination that can be fed and/or administered to an animal, such as a human or non-human animal. As described above, in some embodiments, the metal chelates disclosed herein can be metal complexes of aliphatic hydroxy acids, metal complexes of cyclic hydroxy acids (such as, cyclic aliphatic hydroxy acids, aromatic hydroxy acids, etc.), metal complexes of carbohydrates, metal complexes of partially hydrolyzed or hydrolyzed proteins (such as, metal proteinates), metal complexes of amino acids, metal complexes of oligopeptides; salts and/or hydrates or any combinations thereof. In particular disclosed embodiments, the metal chelates disclosed herein can be iron (II) or iron (III) complexes of aliphatic hydroxy acids, iron (II) or iron (III) complexes of cyclic hydroxy acids (such as, cyclic aliphatic hydroxy acids, aromatic hydroxy acids, etc.), iron (II) or iron (III) complexes of carbohydrates, iron (II) or iron (III) complexes of partially hydrolyzed or hydrolyzed proteins, iron (II) or iron (III) complexes of amino acids, iron (II) or iron (III) complexes of oligopeptides, or any and all combinations thereof.

In some embodiments, the combination comprises one or more metal chelates, and one or more of allicin, alliin, allinase, algae, silica, mineral clay, glucan, mannans, endoglucanohydrolase, yeast, one or more vitamins, Yucca, Quillaja, polyphenol, one or more probiotics, an antimicrobial, a vaccine, sorbic acid or a salt thereof, or a growth promotant. In certain embodiments, the combination comprises one or more metal chelates, one or more of allicin, alliin, allinase, or algae, and silica, mineral clay, glucan, and mannans, and optionally may further comprise endoglucanohydrolase and/or yeast. In other embodiments, the combination comprises one or more metal chelates, one or more of allicin, alliin, allinase, or algae, and Yucca and Quillaja, and optionally comprises a probiotic, such as Bacillus coagulans. In certain embodiments, the combination comprises one or more metal chelates and: allicin, silica, mineral clay, glucan, and mannans; allicin, silica, mineral clay, glucan, mannans, and endoglucanohydrolase; allicin, Yucca, such as Yucca schidigera, and Quillaja, such as Quillaja saponaria; allicin, silica, mineral clay, glucan, mannans, Yucca, such as Yucca schidigera, and Quillaja, such as Quillaja saponaria; or allicin, silica, mineral clay, glucan, mannans, endoglucanohydrolase, Yucca, such as Yucca schidigera, and Quillaja, such as Quillaja saponaria. The metal chelate composition and/or combination may comprise from 0.1% to 99.9% one or more metal chelates, relative to the amounts of other components in the combination, such as from 1% to 99%, from 1% to 90%, from 1% to 80%, from 1% to 70%, from 1% to 60%, from 1% to 50%, from 1% to 40%, from 1% to 30%, from 1% to 25%, from 1% to 20%, or from 1% to 10% one or more metal chelates, or a combination thereof.

In some embodiments, the combination comprises silica, glucan, mannans and mineral clay, and may comprise silica, glucan, mannans and mineral clay in the following relative amounts: 1-40 wt % silica, 0.5-25 wt % glucan and mannans, and 40-92 wt % mineral clay, such as 1-40 wt % silica, 1-25 wt % glucan and mannans, and 40-92 wt % mineral clay; 5-40 wt % silica, 0.5-15 wt % glucan and mannans, and 40-80 wt % mineral clay, such as 5-40 wt % silica, 2-15 wt % glucan and mannans, 40-80 wt % mineral clay; 20-40 wt % silica, 0.5-10 wt % glucan and mannans, and 50-70 wt % mineral clay, such as 20-40 wt % silica, 4-10 wt % glucan and mannans, and 50-70 wt % mineral clay; 15-40 wt % silica, greater than zero to 15 wt % glucans such as 1-15 wt % glucans, 0-10 wt % mannans or greater than 0 to 10 wt % mannans, 50-81 wt % mineral clay; 15-40 wt % silica, 0.5-5.0 wt % glucans, 0.5-8.0 wt % mannans, and 50-81 wt % mineral clay, such as 15-40 wt % silica, 1.0-5.0 wt % glucans, 1.0-8.0 wt % mannans, 50-81 wt % mineral clay; 20-30 wt % silica, 0.5-3.5 wt % glucans, 0.5-6.0 wt % mannans, and 60-70 wt % mineral clay; or 20-30 wt % silica, 1.0-3.5 wt % glucans, 1.0-6.0 wt % mannans, 60-75 wt % mineral clay.

Since β-glucans and mannans may be obtained from yeast, such as from a yeast cell wall or an extract thereof, the combination may comprise metal chelates, silica, mineral clay, and yeast, yeast cell wall or an extract thereof in the following relative amounts: 1-40 wt % silica, 1-30 wt % yeast cell wall extract, and 40-92 wt % mineral clay; 10-40 wt % silica, 5-20 wt % yeast cell wall extract, 40-80 wt % mineral clay; or 15-30 wt % silica, 5-15 wt % yeast cell wall extract, 55-70 wt % mineral clay.

The combination and/or composition may further comprise an endoglucanohydrolase, such as β-1,3 (4)-endoglucanohydrolase. The combination may include from 0.05 wt % endoglucanohydrolase to 5 wt % endoglucanohydrolase or more, relative to an amount of silica, mineral clay, glucan and mannans, or yeast, yeast cell wall or an extract thereof, such as from 0.05 wt % to 3 wt % β-1,3 (4)-endoglucanohydrolase. In some examples, the combination comprises silica, mineral clay, glucan and mannans, or yeast, yeast cell wall or an extract thereof, and endoglucanohydrolase in the following relative amounts: 0.1-3 wt % β-1,3 (4)-endoglucanohydrolase, 20-40 wt % silica, 2-20 wt % glucan and mannans, 50-70 wt % mineral clay; 0.2-3 wt %, β-1,3 (4)-endoglucanohydrolase, 20-40 wt % silica, 4-10 wt % glucan and mannans, 50-70 wt % mineral clay; 0.05-0.3% β-1,3 (4)-endoglucanohydrolase, 1-40 wt % diatomaceous earth, 1-20 wt % yeast cell wall extract, 40-92% wt % mineral clay; 0.1-3 wt % β-1,3 (4)-endoglucanohydrolase, 5-40 wt % diatomaceous earth, 2-10 wt % yeast cell wall extract, 40-80 wt % mineral clay; 0.2-3 wt %, β-1,3 (4)-endoglucanohydrolase, 30-40 wt % diatomaceous earth, 4-6 wt % yeast cell wall extract, 50-65 wt % mineral clay; 0.1-3 wt %, β-1,3 (4)-endoglucanohydrolase, 20-40 wt % diatomaceous earth, 2-20 wt % 3-glucan and glucomannan, and 50-70 wt % mineral clay; 0.1-3 wt % β-1,3 (4)-endoglucanohydrolase, 20-40 wt % silica, 0.5-20 wt % glucan and mannans, and 50-70 wt % mineral clay; 0.1-3 wt %, β-1,3 (4)-endoglucanohydrolase, 20-40 wt % silica, 0.5-10 wt % glucan and mannans, and 50-70 wt % mineral clay; 0.1-3 wt % β-1,3 (4)-endoglucanohydrolase, 1-40 wt % silica, 5-30 wt % yeast cell wall or an extract thereof, and 40-92 wt % mineral clay; 0.1-3 wt % β-1,3 (4)-endoglucanohydrolase, 10-40 wt % silica, 5-20 wt % yeast cell wall or an extract thereof, and 40-80 wt % mineral clay; or 0.1-3 wt % β-1,3 (4)-endoglucanohydrolase, 15-30 wt % silica, 5-15 wt % yeast cell wall or an extract thereof, and 50-70 wt % mineral clay.

In some embodiments, disclosed compositions and/or combinations comprise one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) and a component 1 selected from: 1A) silica; 1B) mineral clay; 1C) glucan; 1D) mannans; 1E) yeast cell wall or an extract thereof; F) endoglucanohydrolase; 1G) silica and mineral clay; 1H) silica and glucan; 11) silica and mannans; 1J) silica and yeast cell wall or an extract thereof, 1K) silica and endoglucanohydrolase; 1L) mineral clay and glucan; 1M) mineral clay and mannans; 1N) mineral clay and yeast cell wall or an extract thereof, 10) mineral clay and endoglucanohydrolase; 1P) glucan and mannans; 1Q) glucan and yeast cell wall or an extract thereof, 1R) glucan and endoglucanohydrolase; 1 S) mannans and yeast cell wall or an extract thereof; T) mannans and endoglucanohydrolase; 1U) silica, mineral clay and glucan; 1V) silica, mineral clay and mannans; 1W) silica, mineral clay and yeast cell wall or an extract thereof; X) silica, mineral clay and endoglucanohydrolase; 1Y) silica, glucan and mannans; 1Z) silica, glucan and yeast cell wall extract or an extract thereof, 1AA) silica, glucan and endoglucanohydrolase; 1AB) silica, mannans and yeast cell wall or an extract thereof, 1AC) silica, mannans and endoglucanohydrolase; 1AD) silica, yeast cell wall or an extract thereof, and endoglucanohydrolase; 1AE) mineral clay, glucan and mannans; 1AF) mineral clay, glucan and yeast cell wall or an extract thereof, 1AG) mineral clay, glucan and endoglucanohydrolase; 1AH) glucan, mannans, and yeast cell wall or an extract thereof, 1AI) glucan, mannans and endoglucanohydrolase; 1AJ) mannans, yeast cell wall or an extract thereof, and endoglucanohydrolase; 1AK) silica, mineral clay, glucan and mannans; 1AL) silica, mineral clay, glucan and yeast cell wall or an extract thereof; 1AM) silica, mineral clay, glucan and endoglucanohydrolase; 1AN) mineral clay, glucan, mannans, and yeast cell wall or an extract thereof, 1AO) mineral clay, glucan, mannans, and endoglucanohydrolase; 1AP) glucan, mannans, yeast cell wall or an extract thereof, and endoglucanohydrolase; 1AQ) yeast cell wall or an extract thereof, and endoglucanohydrolase; 1AR) silica, mineral clay, glucan, mannans, and yeast cell wall or an extract thereof, 1AS) silica, mineral clay, glucan, mannans, and endoglucanohydrolase; 1AT) mineral clay, glucan, mannans, yeast cell wall or an extract thereof, and endoglucanohydrolase; 1AU) silica, mineral clay, glucan, mannans, yeast cell wall or an extract thereof, and endoglucanohydrolase; 1AV) allicin; 1AW) alliin; 1AX) allinase; 1AY) allicin and alliin; 1AZ) allicin and allinase; 1BA) alliin and allinase; 1BB) allicin, alliin, and allinase; 1BC) yeast; 1BD) polyphenol; 1BE) algae; 1BF) Yucca; 1BG) Quillaja; 1BH) Yucca schidigera; 1BJ) Quillaja saponaria; 1BL) Bacillus coagulans; IBM) Yucca schidigera and Bacillus coagulans; 1BN) Quillaja saponaria and Bacillus coagulans; 1BO) Yucca schidigera, and Quillaja saponaria; 1BP) Yucca schidigera, Quillaja saponaria and Bacillus coagulans; 1BQ) a probiotic; 1BR) an antimicrobial; 1BS) a vaccine; 1BT) sorbic acid or a salt thereof, 1BU) potassium sorbate; 1BV) one or more vitamins; 1BW) vitamin C; 1BX) vitamin D; 1BY) vitamin C and vitamin D; 1BZ) an antibiotic; 1CA) Virginamycin; 1CB) an antifubgal; 1CC) an antiparasitic; 1CD) an antiviral; or ICE) an anticoccidial.

A person of ordinary skill in the art will understand that the metal chelate may be combined with any of 1A to ICE, to form any and all compositions and/or combinations between such components

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may also include a component 2. With respect to the component 1 embodiments, the component 2 may be, in a combination with 1A to ICE: 2A) allicin; 2B) alliin; 2C) allinase; 2D) allicin and alliin; 2E) allicin and allinase; 2F) alliin and allinase; 2G) allicin, alliin, and allinase; 2H) yeast; 21) polyphenol; 2J) algae; 2K) Yucca; 2L) quillaj a; 2M) Yucca schidigera; 2N) Quillaja saponaria; 20) Bacillus coagulans; 2P) Yucca schidigera and Bacillus coagulans; 2Q) Quillaja saponaria and Bacillus coagulans; 2R) Yucca schidigera, and Quillaja saponaria; 2S) Yucca schidigera, Quillaja saponaria and Bacillus coagulans; 2T) a probiotic; 2U) an antimicrobial; 2V) a vaccine; 2W) sorbic acid or a salt thereof, 2X) potassium sorbate; 2Y) one or more vitamins; 2Z) vitamin C; 2AA) vitamin D; 2AB) vitamin C and vitamin D; 2AC) an antibiotic; 2AD) Virginiamycin; 2AE) an antifungal; 2AD) an antiparasitic; 2AE) an antiviral; or 2AF) an anticoccidial.

A person of ordinary skill in the art will understand that the metal chelate may be combined with any of 1A to ICE, and any of 2A to 2AF, to form any and all compositions and/or combinations between such components.

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may further comprise a component 3. With respect to the component 1 embodiments 1A to ICE and the component 2 embodiments 2A to 2AF, component 3 may be, in combination with 1A to ICE and 2A to 2AF: 3A) yeast; 3B) polyphenol; 3C) algae; 3D) Yucca; 3E) Quillaja; 3F) Yucca schidigera; 3G) Quillaja saponaria; 3H) Bacillus coagulans; 31) Yucca schidigera and Bacillus coagulans; 3J) Quillaja saponaria and Bacillus coagulans; 3K) Yucca schidigera, and Quillaja saponaria; 3L) Yucca schidigera, Quillaja saponaria and Bacillus coagulans; 3M) a probiotic; 3N) an antimicrobial; 30) a vaccine; 3P) sorbic acid or a salt thereof; 3Q) potassium sorbate; 3R) one or more vitamins; 3S) vitamin C; 3T) vitamin D; 3U) vitamin C and vitamin D; 3V) an antibiotic; 3W) Virginamycin; 3X) an antifungal; 3Y) an antiparasitic; 3Z) an antiviral; or 3AA) an anticoccidial.

A person of ordinary skill in the art will understand that the metal chelate may be combined with any of 1A to ICE, any of 2A to 2AF, and any of 3A to 3AA, to form any and all compositions and/or combinations between such components.

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may further comprise a component 4. With respect to the component 1 embodiments 1A to ICE, the component 2 embodiments 2A to 2AF, and the component 3 embodiments 3A to 3AA, component 4 may be, in combination with 1A to ICE, 2A to 2AF, and 3A to 3AA: 4A) yeast; 4B) polyphenol; 4C) algae; 4D an antimicrobial; 4E) a vaccine; 4F) sorbic acid or a salt thereof; 4G) potassium sorbate; 4H) one or more vitamins; 41) vitamin C; 4J) vitamin D; 4K) vitamin C and vitamin D; 4L) an antibiotic; 4M) Virginamycin; 4N) an antifungal; 40) an antiparasitic; 4P) an antiviral; or 4Q) an anticoccidial.

A person of ordinary skill in the art will understand that the metal chelate may be combined with any of 1A to ICE, any of 2A to 2AF, any of 3A to 3AA, and any of 4A to 4Q, to form any and all compositions and/or combinations between such components.

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may further comprise a component 5. With respect to the component 1 embodiments 1A to ICE, the component 2 embodiments 2A to 2AF, the component 3 embodiments 3A to 3AA, and the component 4 embodiments 4A to 4Q, component 5 may be, in combination with 1A to ICE, 2A to 2AF, 3A to 3AA, and 4A to 4Q: 5A) yeast; 5B) polyphenol; 5C) algae; 5D) an antimicrobial; 5E) a vaccine; 5F) sorbic acid or a salt thereof, 5G) potassium sorbate; 5H) an antibiotic; 51) Virginiamycin; 5J) an antifungal; 5K) an antiparasitic; 5L) an antiviral; or 5M) an anticoccidial.

A person of ordinary skill in the art will understand that the metal chelate may be combined with any of 1A to ICE, any of 2A to 2AF, any of 3A to 3AA, any of 4A to 4Q, and any of 5A to 5M may be combined with to form any and all compositions and/or combinations between such components.

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may further comprise a component 6. With respect to the component 1 embodiments 1A to ICE, the component 2 embodiments 2A to 2AF, the component 3 embodiments 3A to 3AA, the component 4 embodiments 4A to 4Q, and the component 5 embodiments 5A to 5M, component 6 may be, in combination with 1A to ICE, 2A to 2AF, 3A to 3AA, 4A to 4Q, and 5A to 5M: 6A) yeast; 6B) polyphenol; 6C) algae; 6D) a vaccine; 6E) sorbic acid or a salt thereof, or 6F) potassium sorbate.

A person of ordinary skill in the art will understand that the metal chelate may be combined with any of 1A to ICE, any of 2A to 2AF, any of 3A to 3AA, any of 4A to 4Q, any of 5A to 5M, and any of 6A to 6F, to form any and all compositions and/or combinations between such components.

Disclosed compositions and/or combinations comprising one or more metal chelates as defined herein (such as, iron (II) aliphatic hydroxy acid chelates, iron (II) cyclic hydroxy acids chelates, iron (II) proteinates, iron (II) amino acid chelates, iron (II) carbohydrate chelates, iron (II) peptide chelates, iron (III) aliphatic hydroxy acid chelates, iron (III) cyclic hydroxy acids chelates, iron (III) proteinates, iron (III) amino acid chelates, iron (III) carbohydrate chelates, iron (III) peptide chelates, etc.) may further comprise a component 7. With respect to the component 1 embodiments 1A to ICE, the component 2 embodiments 2A to 2AF, the component 3 embodiments 3A to 3AA, the component 4 embodiments 4A to 4Q, the component 5 embodiments 5A to 5M, and the component 6 embodiments 6A to 6F component 7 may be, in combination with 1A to ICE, 2A to 2AF, 3A to 3AA, 4A to 4Q, 5A to 5M, and 6A to 6F: 7A) yeast; 7B) polyphenol; 7C) algae; 7D) a vaccine; 7E) yeast and polyphenol; 7F) yeast and algae; 7G) yeast and a vaccine; 7H) polyphenol and algae; 71) polyphenol and a vaccine; 7J) algae and a vaccine; 7K) yeast, polyphenol, and algae; 7L) yeast, polyphenol, and a vaccine; 7M) yeast, algae and a vaccine; 7N) polyphenol, algae and a vaccine; or 70) yeast, polyphenol, algae and a vaccine.

A person of ordinary skill in the art will understand that the metal chelate may be combined with any of 1A to ICE, any of 2A to 2AF, any of 3A to 3AA, any of 4A to 4Q, any of 5A to 5M, any of 6A to 6F, and any of 7A to 70, to form any and all compositions and/or combinations between such components.

In any of the above embodiments, glucan may be β-glucan. In any of the above embodiments, endoglucanohydrolase may be β-1,3 (4)-endoglucanohydrolase.

Any combination of any of 1A to ICE, and any of 2A to 2AF, and optionally any of 3A to 3AA, any of 4A to 4Q, any of 5A to 5M, any of 6A to 6F, and/or any of 7A to 70, might further comprise one or more additional components, such as an adhesive agent and/or feedstuff, as disclosed herein.

The disclosed combination may comprise from less than 0.1% to greater than 99.9% component 1, such as from 1% to 99%, from 1% to 75%, from 1% to 60%, from 1% to 50%, component 1, and from less than 0.1% to greater than 99.9% component 2, such as from 1% to 99%, from 1% to 75%, from 1% to 60%, from 1% to 50%, component 2. The combination optionally may further comprise from less than 0.1% to greater than 99.9%, such as from 1% to 99%, from 1% to 75%, from 1% to 60%, from 1% to 50%, of any of component 3, component 4, component 5, component 6, component 7, and/or the one or more additional components, such as an adhesive agent and/or feedstuff, as disclosed herein. However, a person of ordinary skill in the art will appreciate that the total relative amounts of the components in the combination cannot exceed 100%.

D. Uses of the Combination

Disclosed compositions and/or combinations comprising one or more metal chelates as defined herein may be used to replace or supplement animal feedstuffs, or it may be administered separately from a feedstuff. In some embodiments, the feedstuff is a commercial feedstuff. Metal chelate compositions and/or combinations may be formulated in any form suitable for mixing with a feedstuff and/or replacing a feedstuff, including a powder, a granule, a pellet, a solution, or a suspension. Certain disclosed embodiments are formulated as a dry, free-flowing powder. This powder is suitable for direct inclusion into a commercially-available feed, food product or as a supplement to a total mixed ration or diet. The powder may be mixed with either solid or liquid feed and/or with water. In other embodiments, the combination and/or any components are formed into pellets, and in further embodiments, the combination and/or any components are formulated into granules, such as floating or sinking granules, suitable for feeding to aquatic animals.

In some embodiments, disclosed compositions and/or combinations comprising one or more metal chelates as defined herein have an average particle size selected to be compatible with a feedstuff to which it may be admixed. The term “compatible” as used herein means that the particle size is sufficiently similar to reduce or eliminate particle size segregation when the combination and/or composition, or one or more components of the combination and/or composition, is admixed with the feedstuff. For example, if the composition and/or combination is admixed with a feedstuff having an average particle size of 50-200 μm, the combination and/or composition, or one or more components of the combination and/or composition, may have a similar average particle size, e.g., from 80-120% of the feedstuff/component particle size with which the combination and/or composition, or one or more components of the combination and/or composition, is admixed.

Disclosed compositions and/or combinations comprising one or more metal chelates as defined herein may be administered to animals to obtain one or more beneficial results. Such benefits may include, but are not limited to, prevention and/or treatment of certain diseases or conditions, such as, diseases caused by mineral deficiencies (and in particular, diseases caused by iron deficiencies (such as, anemia, reduced growth, poor immune function, weakness, etc.)), infectious diseases, non-infectious diseases, stress and stress-related conditions and diseases; a beneficial effect on the animal's immune system; or helping increase longevity of the animal. Additionally, or alternatively, disclosed compositions and/or combinations comprising one or more metal chelates as defined herein may be administered to animals to treat microbial infections. In certain embodiments, the microbial infection may be caused by bacteria, such as gram positive bacteria, or gram negative bacteria. For example, the infection may be caused by bacteria selected from the group consisting of S. epidermidis, E. Faecalis, E. coli, S. aureus (including Vancomycin-resistant Staphylococcus aureus (VRSA) and Methicillin-resistant Staphylococcus aureus (MRSA)), H. pylori, Campylobacter, Enteropathogenic E. coli (EPEC), Uropathogenic E. coli (UPEC), Pseudomonas, Streptococcus pneumoniae, Streptococcus anginosus, Neisseria gonorrhoeae, Salmonella including drug-resistant Salmonella serotype typhi, Salmonella Enteritidis, Salmonella Typhimurium, Mycoplasma, Shigella, Vancomycin-resistant Enterococcus (VRE), Erythromycin-resistant Group A Streptococcus, Clindamycin-resistant Group B Streptococcus, Carbapenem-resistant Enterobacteriaceae (CRE), Eimeria, Enterococci, Brachyspira, and Clostridium perfringen, drug-resistant tuberculosis, Extended spectrum Enterobacteriaceae (ESBL), multidrug-resistant Acinetobacter (including MRAB), and Clostridium difficile.

Additionally, or alternatively, disclosed compositions and/or combinations comprising one or more metal chelates as defined herein may improve the feed conversion rate, and/or the Feed:Gain ratio, of an animal, such as an animal raised for consumption; improve the weight gain of the animal; and/or reduce mortality. A feed conversion rate, also known as a feed conversion ratio, is a measure of an animal's efficiency in converting feed mass into increased body mass. Animals with low feed conversion rates are considered efficient, as they require less feed to reach a desired weight. Feed conversion rates vary from species-to-species.

Disclosed compositions and/or combinations comprising one or more metal chelates as defined herein can be administered to aquatic animals to obtain one or more beneficial results. For example, embodiments of the combination may be used to prevent and/or treat certain aquatic diseases. Additionally, disclosed compositions and/or combinations comprising one or more metal chelates as defined herein may improve the feed conversion rate of an aquatic animal. Feed conversion rates for aquatic species vary from species-to-species. For example, tilapia typically have a feed conversion ratio of from 1.6 to 1.8, and farm raised salmon typically have a ratio of around 1.2. In some embodiments, the feed conversion rate may be enhanced by from 0.5% to 20% or more, such as from 1% to 20%, preferably from 2% to 10%, and in certain embodiments, from 3% to 5%.

Disclosed compositions and/or combinations comprising one or more metal chelates as defined herein may be administered daily to the animal at time intervals believed or determined to be effective for achieving a beneficial result. The combination may be administered in a single dose daily or in divided doses throughout the day. In some instances, one or more components may be administered to the animal at a first time, and remaining components may be administered individually or in combination at one or more subsequent times during the same day. Typically, a time period over which a composition or combination is administered is sufficient such that the animal received a benefit from the combination of components. In some embodiments, components of a combination may be administered to the animal in any order over a time period sufficient that an effective time period of a first component, or combination of first components, overlaps with an effective time period of a second component, or combination of second components, and any effective time periods of any subsequent components, or combinations of subsequent components. An “effective time period” is a time period during which the animal received a beneficial result from being administered the particular component, or combination of particular components.

E. Immune System Benefits

Without wishing to be bound by any particular theory, the combination may enhance the animal's immune system, such as the innate system or the adaptive immune system, or both. When administered to an animal, the combination may produce a concomitant change in a level of, for example, an immune system biomarker or an inflammation biomarker in the animal by at least 5%, at least 10%, at least 20%, at least 30%, at least 50%, at least 75%, at least 100%, at least 200%, or at least 500%, such as from 5-600%, from 10-500%, from 10-200%, or from 10-100%, compared to an average level of the biomarker in an animal that has not received the combination. The change may be an increase or a decrease, depending on the particular biomarker. For example, some embodiments of the combination affect levels of immune biomarkers including, but not limited to, neutrophil L-selectin, IL-113 and/or gene expression of Crp, Mbl2, Apcs, 115, Ifna1, Ccl12, Csf2, 1113, 1110, Gata3, Stat3, C3, Tlr3, Cc15, Mx2, Nfkb1, Nfkbia, Tlr9, Cxcl10, Cd4, 116, Ccl3, Ccr6, Cd40, Ddx58, 1118, Jun, Tnf, Traf6, Statl, Ifnbl, Cd80, Tlr1, Tlr6, Mapk8, Nod2, Ccr8, Irak1, Cdld1, Stat4, 11r1, Faslg, Irf3, Ifnar1, Slc11a1, Tlr4, Cd86, Casp1, Ccr5, Icam1, Camp, Tlr7, Irf7, Rorc, Cd40lg, Tbx21, Casp8, I123a, Cd14, Cd8a, Cxcr3, Foxp3, Lbp, Mapk1, Myd88, Stat6, Agrin and/or IL33. As disclosed in U.S. Pat. No. 8,142,798, which is incorporated herein by reference, some embodiments of the combination also augment an animal's adaptive immune system, e.g., by increasing response to a vaccine; antibody levels, such as IgG levels, may be increased, relative to an animal that has received a vaccine but has not been administered the combination. The combination also may reduce the effects of stress in the animal, potentially by ameliorating the effects of stress (e.g., heat stress, pregnancy stress, parturition stress, etc.) on the animal's immune system. Some embodiments of the combination affect levels of inflammation biomarkers, e.g., COX-2, IL-113, tumor necrosis factor alpha (TNF-α), interleukin-8 receptor (IL8R), and/or L-selectin.

In some embodiments concerning fish, administration of the combination may produce a concomitant change in a level of innate defense mechanisms of fish prior to exposure to a pathogen, or improve survival following exposure to a specific pathogen. Markers of improved innate immune response may include:

1. Total Leucocyte Count

Abnormal changes in total and differential blood cell counts in fish, such as anaemia, leukopaenia, leukocytosis and thrombocytopaenia, may result from diseases, but may also indicate stress, toxic exposure, hypoxia and changes in reproductive status.

Due to the nucleated nature of red blood cells (erythrocytes) in fish, white blood cells (leukocytes), which serve as an indicator of health, cannot be distinguished using automated cell counting procedures without lysis of erythrocytes and are usually manually counted using a haemocytometer. Differential leukocyte and haemocyte enumerations, which also serve as health indicators, are generally performed either on stained smears or with a haemocytometer in fish and crustacea, respectively. The disadvantage of manual enumeration is the statistical limitation associated with counting between 100 to 200 cells, the typical range in differential leukocyte procedures.

Flow cytometry is an instrumental technique in which a stream of suspended particles is interrogated by one or more lasers. Particles are analysed and differentiated on the basis of their light-scattering properties, auto- or labelled fluorescence, or a combination of both.

The major advantages of flow cytometry technology are the ability to differentiate and enumerate several thousands of particles per second, and to physically sort multiple populations simultaneously into collection vessels. In haematological applications, the capability to obtain accurate and precise total and 5 differential blood counts on so many more cells than practically achievable with manual methods, in a fraction of the time, is thus dependent only on the ability to accurately discriminate between cell types.

2. Respiratory Burst (Release of Superoxide Anion)

Several reactive oxygen species (ROS) are produced by fish phagocytes during the respiratory burst. Once bacteria or fungi are engulfed by leucocytes, the host's NADPH-oxidase is activated, which in turn increases oxygen consumption and subsequently produces ROS such as superoxide anion (O₂⁻), hydrogen peroxide (H₂O₂), hydroxyl radical (OH) and singlet oxygen (¹O₂). The release of superoxide anion is known as the respiratory burst, and the ROS released and/or formed may be are bactericidal.

3. Phagocytic Index and Activity

Phagocytosis is an essential component of the non-specific immune response against infectious agents in teleosts. This process involves the recognition and attachment of foreign particles, including pathogens, engulfment and digestion by the phagocyte. In vitro assays have been used for studying fish macrophage phagocytic activity, thereby providing an avenue for evaluating immunocompetence in fish. In vitro assays have also provided insight for non-specifically enhancing disease resistance in finfish aquaculture, and have served as immunological biomarker tests to assess aquatic environmental health.

4. Lysozyme Activity

Lysozyme found in cutaneous mucus, peripheral blood and certain tissues rich in leucocytes, is an enzyme which catalyzes the hydrolysis of N-acetyl muramic acid and N-acetyl glucosamine of peptidoglycan in bacterial cell walls. This protein plays a crucial role in the defense system.

In other embodiments concerning crustaceans, administration of the combination may produce a concomitant change in a level of innate defense mechanisms of crustaceans prior to exposure to a pathogen, or improve survival following exposure to a specific pathogen. Markers of improved innate immune response in crustaceans may include:

5. Total Hemocyte Count

Haemocytes play a central role in crustacean immune defense. They remove foreign particles in the hemocoel by phagocytosis, encapsulation and nodular aggregation. Additionally, haemocytes take part in wound healing by cellular clumping and initiation of coagulation processes through the release of factors required for plasma gelation.

The hemogram consists of the total haemocyte count (THC) and the differential haemocyte count (DHC). For the DHC, most researchers agree with the identification of three cell types in penaeid shrimp: large granule haemocytes (LGH), small granule haemocytes (SGH) and agranular haemocytes or hyaline cells (HC).

THC can be easily determined using a hemocytometer, whereas determination of DHC requires a more complex haemocyte identification. DHC can be determined by using morphological criteria such as size and shape of cells and the difference of haemocyte refractivity using a phase contrast microscope. Although this technique is rapid, it should be mentioned that when using this technique it is easy to obtain large variations in results possibly due to interpretation errors.

Different haemocyte types can be determined using cytochemical studies of enzyme activity detection or specific stains. The results obtained from cytochemical stains for penaeid shrimp indicate that these specific stainings can differentiate between the types of haemocytes and provide additional information on their functions. An alternative method for cell identification is the use of monoclonal antibodies (mAbs) in order to find antigenic markers of different cell types. Using mAbs against different subpopulations of haemocytes separated by isopycnic centrifugation on a Percoll gradient, it has been found in P. japonicus that HC share epitopes with SGH, and that an antigen was specifically expressed for LGH. Monoclonal antibodies could be considered as powerful tools for the development of haemocyte lineages and haemocyte proliferation studies, as well as for the isolation and study of plasma components.

6. Phagocytic Activity

Phagocytosis is the most common reaction of cellular defense. During phagocytosis, particles or microorganisms are internalized into the cell which later forms a digestive vacuole called the phagosome. The elimination of phagocyted particles involves the release of degradative enzymes into the phagosome and the generation of reactive oxygen intermediates (ROIs). This last process is known as the respiratory burst. The first ROI generated during this process is the superoxide anion. Subsequent reactions will produce other ROIs, such as hydrogen peroxide, hydroxyl radicals and singlet oxygen. Hydrogen peroxide can be converted to hypochlorous acid via the myeloperoxidase system, forming a potent antibacterial system.

Despite the limited number of studies focusing on respiratory burst in penaeid shrimp, the actual results have value as biomarkers of environmental disturbances. Furthermore, the importance of respiratory burst as a microbicidal mechanism in penaeid shrimp is strongly suggested by the fact that pathogenic bacteria of shrimp have developed ways of circumventing this mechanism. In P. Íannamei, O₂ generation is not produced when virulent Vibrio Íulnificus is used as elicitor, as opposed to strong stimulation generated by V. ginolyticus and other bacteria, such as Escherichia coli.

7. Phenoloxidase (PO) and Prophenoloxidase (ProPO) Activity

The PO is responsible for the melanization process in arthropods. The PO enzyme results from the activation of the ProPO enzyme. The ProPO activating system has been very well studied in crustaceans. Using these different approaches, the function of the ProPO system can be better understood in relation to the health status of shrimp. Some studies have shown that ProPO could be used as health and environmental markers because changes are correlated with infectious state and environmental variations, this issue which has recently been confirmed also at the gene expression level. Phenoloxidase, which has been detected in a wide range of invertebrates, is activated by several microbial polysaccharides, including β-1,3-glucan from fungal cell walls and peptidoglycans or lipopolysaccharides from bacterial cell walls.

8. Antibacterial Activity

Antibacterial peptides and proteins have been well studied in arthropods, mainly in insects and chelicerata, where the families of antimicrobial molecules have been isolated and characterized. In crustacean, some studies have shown the ability of crustacean haemolymph to inhibit bacterial growth. Several antibacterial proteins, active in vitro against Gram-positive and Gram-negative bacteria, were found in C. maenas.

In the literature there are reports showing that antibacterial activity in crustaceans can be considered as an environmental marker. Therefore, many researchers have developed quantitative antibacterial assays based on inhibition of bacterial growth on agar plate (zone inhibition assay and colony-forming units (CFU). inhibition assay), or in liquid medium on microtiter plates (turbidometric assay), to detect the antibacterial ability in crustacean haemolymph. Using the CFU inhibition technique, antibacterial activity has been found in granular haemocytes of the shore crab C. maenas and in other crustacean species. It has been reported that a potent antibacterial activity in the serum of Calsapidus, using the zone inhibition assay and turbidimetric test. Using the CFU inhibition assay, bactericidal activity against Gram negative bacteria have been described in the haemolymph of P. monodon. In P. Íannamei, strong antibacterial activity of plasma against different marine bacteria has been observed, using a turbidimetric assay.

9. Plasma Protein Concentration

In recent years blood metabolites have been investigated as a tool for monitoring physiological condition in wild or cultured crustaceans exposed to different environmental conditions. Hemocyanin is the major hemolymph constituent (>60%); the remaining proteins (in order of concentration) include coagulogen, apohemocyanin, hormones, and lipoproteins. Blood protein levels fluctuate with changes in environmental and physiological conditions and play fundamental roles in the physiology of crustaceans from O₂ transport to reproduction up to stress responses. In fact, moulting, reproduction, nutritional state, infection, hypoxia, and salinity variations are the major factors affecting the relative proportions and total quantities of the hemolymph proteins.

The shrimp immune system response is largely based on proteins. These are involved for example in recognizing foreign particles and in trapping foreign invading organisms and prevent blood loss upon wounding. Recently, it has been shown that shrimp are well adapted to use protein as a source of energy and molecules. Blood protein concentration has been found to be related to nutritional condition in a number of crustaceans. The concentration of protein in the blood is a possible index of nutritional condition, which decreases in starved prawns and lobsters. The moult cycle imposes constraints on protein levels, blood-proteins typically drop just before moulting as water is taken up and protein is used to synthesize the new exoskeleton. Protein levels then gradually build up again after ecdysis as water is replaced by tissue. Consequently, measuring the blood protein concentration of a crustacean sample group can provide valuable information to identify its condition. The concentration of protein in the blood is directly proportional to the refractive index of the blood. Measurements of the blood refractive index therefore offer potential as a field method for assessing the nutritional condition of prawns.

Colorimetric procedures are generally the preferred choice to measure serum protein concentration; however, they are expensive, time consuming, and not easily performed in the field. Because of ease, rapid mode of operation, and small amount of material required, measuring serum protein concentration using a refractometer provided a nondestructive field method to assess crustacean's physiological state (stress, immunoresponse, nutrition status, molt, etc.) without any need of laboratory facilities; the refractometer is a simple, small portable instrument that can be used in the field or on crustacean farms.

F. Amount Administered

Disclosed compositions and/or combinations comprising one or more metal chelates as defined herein may be administered or fed to an animal in a sufficient amount to provide a desired result. The amount of the composition and/or combination may be from greater than zero to 500 grams per animal per day, such as from 0.5 grams to 250 grams, from 5 grams to 200 grams, or from 10 grams to 70 grams per animal per day. Alternatively, the composition and/or combination may be fed or administered in an amount of from greater than zero to 1000 mgs or more per kilogram of the animal's body weight, such as from greater than zero to 500 mgs per kilogram body weight. In other embodiments, the composition and/or combination is fed or administered per weight of animal feed. The composition and/or combination may be fed or administered in an amount of from greater than zero to 150 kg per ton (2000 pounds) of feed, such as from 0.1 kg to 100 kg per ton of feed. Alternatively, the composition and/or combination may be fed or administered in an amount of from greater than zero to 20 grams per kilogram of feed, such as from greater than zero to 10 grams of feed.

In some embodiments, disclosed compositions and/or combinations comprise one or more metal chelates, and a composition 1 comprising silica, mineral clay, glucan and mannans. When incorporated directly into feeds, disclosed compositions and/or combinations comprising one or more metal chelates and a composition 1 may be added in amounts sufficient to provide an effective amount of the composition 1. An effective amount of the composition 1 may range from 0.1 to 100 kg per ton of feed. In some embodiments, the combination is added in sufficient amount such that composition 1 is added in amounts of from 0.1 to 50 kg per ton, such as from 0.1 to 20 kg per ton of feed, from 0.5 kg to 10 kg per ton of feed, or from 1 to 5 kg per ton of feed.

When expressed as a percentage of dry matter of feed, disclosed compositions and/or combinations comprising one or more metal chelates and a composition 1 are added in a sufficient amount such that composition 1 may be added to animal feedstuffs or to foods in amounts ranging from 0.01 to 2.5% by weight, such as from 0.0125% to 2% by weight, from 0.05 to 1.5% by weight, from 0.06% to 1% by weight, from 0.1 to 0.7% by weight, or from 0.125% to 0.5% by weight of feed.

Alternatively, disclosed compositions and/or combinations comprising one or more metal chelates and a composition 1 may be administered such that composition 1 may be fed directly to animals as a supplement in amounts of from greater than 0.01 gram to 20 gram per kilogram of live body weight, such as from 0.01 gram to 10 gram per kilogram of live body weight, from 0.01 gram to 1 gram per kilogram of live body weight, from 0.01 gram to 0.5 gram per kilogram of live body weight, or from 0.02 gram to 0.4 gram per kilogram of live body weight per day. In some embodiments, composition 1 may be provided for use with many mammalian species, including non-human mammals, in amounts of from 0.05 grams to 0.20 grams per kilogram of live body weight per day.

By way of example, for cattle, disclosed compositions and/or combinations comprising one or more metal chelates and a composition 1 may be provided in a sufficient amount such that composition 1 is provided in the range of from 10 grams per head per day to 70 grams per head per day, such as from 45 grams per head per day to 70 grams per head per day, or from 50 grams per head per day to 60 grams per head per day. A person of ordinary skill in the art will appreciate that the amount of composition I fed can vary depending upon a number of factors, including the animal species, size of the animal and type of the feedstuff to which composition 1 is added.

For some embodiments concerning aquatic animals, disclosed compositions and/or combinations comprising one or more metal chelates and a composition 1 may be administered based on body weight, such as grams of the combination per pound or kilogram body weight of fish per day, or in milligrams of the combination per pound or kilograms of body weight. In some embodiments, administration is sufficient to provide a desired amount of one or more of the components of the combination. In a particular example, when administered to fish, disclosed compositions and/or combinations comprising one or more metal chelates and a composition 1 may be administered in an amount of from greater than zero to 500 mg of composition 1 per kilogram of body weight per day, such as from 10 mg to 350 mg per kilogram of body weight per day or from 50 mg to 250 mg per kilogram of body weight per day.

Alternatively, disclosed compositions and/or combinations comprising one or more metal chelates and a composition 1 may be administered based on the amount of feed provided to the aquatic animals. In some embodiments, the amount of the combination provides composition 1 to the aquatic animals in an amount of from greater than zero to 10,000 mg composition 1 per kilogram of feed or more, such as from 500 mg to 7,500 mg per kilogram of feed, or from 1,000 mg to 5,000 mg per kilogram of feed.

A person of ordinary skill in the art will appreciate that disclosed that the amount of compositions and/or combinations comprising one or more metal chelates and a composition 1 administered can vary depending upon a number of factors, including the animal species, size of the animal, the age or growth stage of the animal, and type of the feedstuff to which the combination is added. In some embodiments, 100 mg of composition 1 per kilogram of body weight per day is administered, and in other embodiments, 200 mg of composition 1 per kilogram of body weight per day is administered. In certain embodiments, 1,000 mg, 2,000 mg or 4,000 mg of composition 1 per kilogram of feed is administered to the animals.

Disclosed compositions and/or combinations comprising one or more metal chelates and a composition 1 may also comprise a probiotic, for example a Bacillus species, such as Bacillus coagulans. The amount of such compositions and/or combinations administered or fed to the animal may be selected to provide a sufficient amount of the probiotic, such as Bacillus coagulans, to provide a desired and/or beneficial result or enhancement in the animal. In some embodiments, the Bacillus coagulans may be administered as Ganpro® or Provia 6086®. In poultry the amount of the administered may be sufficient to provide an amount of Bacillus coagulans of from about 0.5 to 2.5 grams per head per day, such as about 1 gram per head per day. In embodiments concerning cattle, the amount of disclosed compositions and/or combinations administered or fed to cattle is sufficient to provide an amount of Bacillus coagulans of from about 10 to about 50 grams per head per day, preferably from about 28 to 36 grams per head per day. And for swine the amount of disclosed compositions and/or combinations administered or fed may be sufficient to provide an amount of Bacillus coagulans of from about 2 to about 10 grams per head per day, preferably about 5.5 grams per head per day. In some examples, the Bacillus coagulans may be admixed with feedstuff at from about 0.5 grams per ton (2000 pounds) to about 10 grams per ton or more feed stuff. In certain embodiments, the Bacillus coagulans is admixed with feedstuff at about 7.5 grams per ton of feedstuff. In other embodiments, the amount of Bacillus coagulans, administered in certain embodiments as Ganpro® or Provia 6086®, is from about 0.5 grams to less than 7.5 grams per ton of feedstuff, such as from 2 grams to 7.25 grams per ton, or from 5 grams to 7 grams per ton. In other examples, the amount of Bacillus coagulans, administered in certain embodiments as Ganpro® or Provia 6086®, is from greater than 7.5 grams to greater than 10 grams per ton of feed stuff, such as from greater than 7.5 grams per ton to 10 grams per ton, or from 7.75 grams per ton to 8 grams per ton.

Disclosed combinations and/or compositions comprising one or more metal chelates may also comprise Yucca and/or Quillaja, such as Yucca schidigera and/or Quillaja saponaria. In some embodiments, such combinations and/or compositions are administered or fed to an animal in an amount sufficient to provide an amount of Yucca to the animal of from greater than 0 to greater than about 10 ounces per ton of feedstuff, preferably from about 1 to about 5 ounces. In other embodiments, a suitable combination or composition is administered or fed to an animal in an amount sufficient to provide an amount of Quillaja to the animal of from greater than 0 to greater than about 10 ounces per ton of feedstuff, preferably from about 1 to about 5 ounces. In certain embodiments, the combination and/or composition comprises both Yucca and Quillaja, and is administered to an animal in an amount sufficient to provide a combined amount of Yucca and Quillaja of from greater than 0 to greater than about 10 ounces per ton of feedstuff, preferably from about 2 to about 6 ounces.

In some embodiments, compositions and/or combinations comprising one or more metal chelates, may comprise a composition 2 comprising Yucca and Quillaja, typically Yucca schidigera and/or Quillaja saponaria. Composition 2 may be administered as Nutrafito® Plus. Compositions and/or combinations comprising one or more metal chelates and a composition 2 may be administered to an animal in a sufficient amount to provide an amount of composition 2 to the animal of from greater than 0 ppm to about 500 ppm, such as from about 50 ppm to about 500 ppm, from about 100 ppm to about 500 ppm, from about 50 ppm to about 400 ppm, or from about 100 ppm to about 300 ppm. In some embodiments, disclosed compositions and/or combinations are administered in an amount sufficient to provide an amount of composition 2 of from greater than 0 ppm to less than 125 ppm, such as from greater than 0 ppm to 124 ppm or from greater than 0 ppm to 100 ppm. And disclosed compositions and/or combinations may be administered in an amount sufficient to provide an amount of composition 2 of from greater than 125 ppm to 500 ppm, such as from about 126 ppm to 400 ppm, or from 150 ppm to 300 ppm. In certain embodiments, a sufficient amount of disclosed compositions and/or combinations is administered or fed to avians to provide an amount of Yucca schidigera and Quillaja saponaria as Nutrafito® Plus, of from about 2 to about 6 ounces per ton of feedstuff. In other embodiments, combination and/or compositions comprising Nutrafito® Plus are administered to avians in a sufficient amount to provide about 125 ppm (parts per million) or about 4 ounces of Nutrafito® Plus per ton of feedstuff.

Additional information concerning embodiments of a combination comprising Yucca, Quillaja and Bacillus can be found in U.S. application Ser. No. 14/699,740, which is incorporated herein by reference in its entirety.

Disclosed compositions and/or combinations comprising at least one metal chelate may also comprise an antimicrobial or antibiotic. The amount of the antimicrobial or antibiotic may be selected to be within the amounts stated below but may depend on the particular antimicrobial or antibiotic used as will be understood by a person of ordinary skill in the art. In some embodiments, the amount of the antibiotic or antimicrobial that is used can be a therapeutically effective amount that is at an approved or authorized dosage level for a particular antibiotic. In some embodiments, the amount of antibiotic or antimicrobial used can range from greater than 0 ppm to 100,000 ppm, such as 0.25 ppm to 5,000 ppm, or 0.5 ppm to 2,500 ppm, or 0.75 ppm to 2,000 ppm, or 1 ppm to 1,500 ppm, or 5 ppm to 1,000 ppm, or 10 ppm to 500 ppm, or 25 ppm to 300 ppm. In yet additional embodiments, the amount of antibiotic or antimicrobial used can range from greater than 0 mg/kg of body weight to 100,000 mg/kg of body weight, such as 0.5 mg/kg to 2,500 mg/kg, or 1 mg/kg to 1,500 mg/kg, or 5 mg/kg to 1,000 mg/kg, or 10 mg/kg to 500 mg/kg m, or 25 mg/kg to 300 mg/kg, or 10-20 mg/kg.

In some embodiments, the amount of the antimicrobial or antibiotic that is included disclosed compositions and/or combinations can range from at least 1 g/ton of feed to 230 g/ton of feed (or at least 1.1 ppm to 256 ppm), such as at least 1 g/ton of feed to 220 g/ton of feed (or at least 1.1 ppm to 243 ppm), at least 1 g/ton of feed to 100 g/ton of feed (or at least 1.1 ppm to 110 ppm), at least 1 g/ton of feed to 50 g/ton of feed (or at least 1.1 ppm to 55 ppm), or at least 1 g/ton of feed to 10 g/ton of feed (or at least 1.1 ppm to 11 ppm). Particular antimicrobials or antibiotics that can be used, and dosage amounts of such antimicrobials and antibiotics include, but are not limited to, the following: Virginiamycin in an amount ranging from 5 g/ton of feed to 25 g/ton of feed (or 5 ppm to 27 ppm, such as 22 ppm); Bacitracin MD in an amount ranging from 40 g/ton of feed to 220 g/ton of feed (or 44 ppm to 242 ppm, or 50 ppm to 250 ppm in some other embodiments); Zinc Bacitracin in an amount ranging from 40 g/ton of feed to 220 g/ton of feed (or 44 ppm to 242 ppm); Tylosin in an amount ranging from 1 g/ton of feed to 1000 g/ton of feed (or 1 ppm to 1100 ppm); Lincomycin in an amount ranging from 1 g/ton of feed to 5 g/ton of feed (or 1 ppm to 6 ppm); Flavomycin in an amount ranging from 1 g/ton of feed to 5 g/ton of feed (or 1 ppm to 6 ppm); or combinations thereof.

The amount of an anticoccidial agent, as will be understood by a person of ordinary skill in the art (e.g., a veterinarian), can be selected depending on the particular anticoccidial agent used. In some embodiments, the amount of anticoccidial agent used can be a therapeutically effective amount for a particular animal species. In some embodiments, the amount of anticoccidial agent used can range from greater than 0 ppm to 100,000 ppm, such as 0.25 ppm to 5,000 ppm, or 0.5 ppm to 2,500 ppm, or 0.75 ppm to 2,000 ppm, or 1 ppm to 1,500 ppm, or 5 ppm to 1,000 ppm, or 10 ppm to 500 ppm, or 25 ppm to 300 ppm. In yet additional embodiments, the amount of antibiotic or antimicrobial used can range from greater than 0 mg/kg of body weight to 100,000 mg/kg of body weight, such as 0.5 mg/kg to 2,500 mg/kg, or 1 mg/kg to 1,500 mg/kg, or 5 mg/kg to 1,000 mg/kg, or 10 mg/kg to 500 mg/kg m, or 25 mg/kg to 300 mg/kg, or 10-20 mg/kg.

### V. Exemplary Embodiments

The following numbered paragraphs illustrate exemplary embodiments of the disclosed technology.

Paragraph 1. A metal chelate, having a structure satisfying a formula

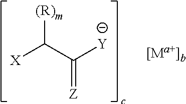

wherein
m can be 0, 1, or 2;
a is 2 or 3;
b is 1 or 2;
c is 1, 2, or 3;

X is —C(R¹)₃, OH, CO₂R¹, CO₂H, OR², NH₂, NR²H, NR²R³, —(C(R¹)₂)ₙONO₂, —(C(R¹)₂)ₙNO₂, SH, SR² wherein each R¹, R² and R³ independently is selected from hydrogen, aliphatic, haloaliphatic, haloheteroaliphatic, heteroaliphatic, aromatic, aliphatic-aromatic, heteroaliphatic-aromatic or any combination thereof, and n is 1 to 6;

Y is selected from NH₂, NHR³, NR³R⁴, SH, OR³, OH wherein R³ and R⁴ can independently be selected from aliphatic, haloaliphatic, haloheteroaliphatic, heteroaliphatic, aromatic, aliphatic-aromatic, heteroaliphatic-aromatic or any combination thereof;

Z is selected from O, S, NH, NR⁵ wherein R⁵ can be selected from aliphatic, haloaliphatic, haloheteroaliphatic, heteroaliphatic, aromatic, aliphatic-aromatic, heteroaliphatic-aromatic or any combination thereof; and

each R can independently be selected from halogen, aliphatic, haloaliphatic, haloheteroaliphatic, heteroaliphatic, aromatic, aliphatic-aromatic, heteroaliphatic-aromatic or any combination thereof; and

M can be at least a biologically or a nutritionally relevant metal selected from iron, copper, zinc, manganese, chromium, calcium, potassium, sodium, magnesium, cobalt, nickel, molybdenum, vanadium, strontium, selenium, or any combination thereof.

Paragraph 2. A metal chelate, having a structure satisfying any one or more formulas:

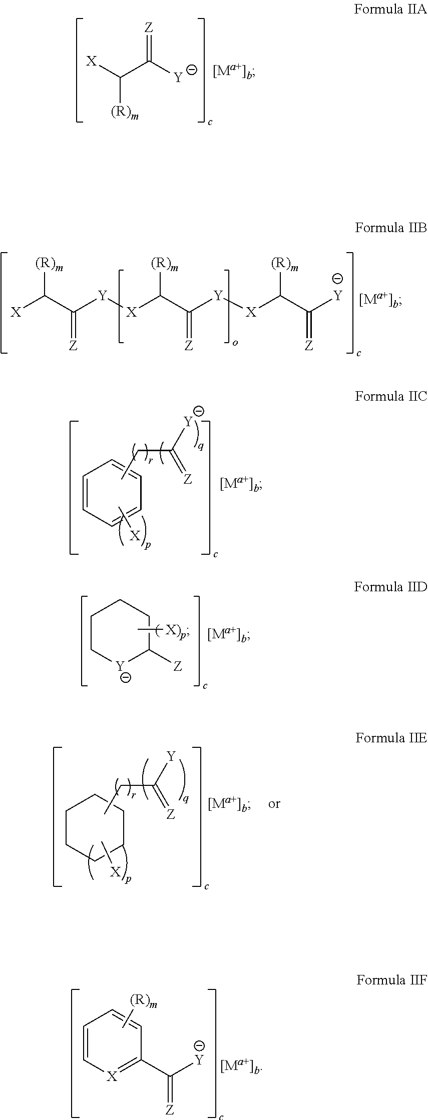

wherein
m can be 0, 1, or 2;
a is 2 or 3;
b is 1 or 2;
c is 1, 2, or 3;
each r, p and q independently is 0, 1, 2, 3, 4, or 5; and
each o is 0, 1, 2, 3, 4, 5, 6, 7, 8, 9, 10, 11, 12, 13, 14, 15, 16, 17, 18, 19 or 20;

X is —C(R¹)₃, OH, CO₂R¹, CO₂H, OR², NH₂, NR²H, NR²R³, —(C(R¹)₂)ₙONO₂, —(C(R¹)₂)ₙNO₂, SH, SR² wherein each R¹, R² and R³ independently is selected from hydrogen, aliphatic, haloaliphatic, haloheteroaliphatic, heteroaliphatic, aromatic, aliphatic-aromatic, heteroaliphatic-aromatic or any combination thereof, and n is 1 to 6;

Y is NH, NR³, NH₂, NHR³, NR³R⁴, SH, OR³, OH wherein R³ and R⁴ can independently be selected from aliphatic, haloaliphatic, haloheteroaliphatic, heteroaliphatic, aromatic, aliphatic-aromatic, heteroaliphatic-aromatic or any combination thereof; or —Y—X— is —NR¹-bond-;

Z can be selected from O, S, NH, NR⁵ wherein R⁵ can be selected from hydrogen, halogen, aliphatic, haloaliphatic, haloheteroaliphatic, heteroaliphatic, aromatic, aliphatic-aromatic, heteroaliphatic-aromatic or any combination thereof; and

each R can independently be selected from halogen, aliphatic, haloaliphatic, haloheteroaliphatic, heteroaliphatic, aromatic, aliphatic-aromatic, heteroaliphatic-aromatic or any combination thereof; and

M can be at least a biologically or a nutritionally relevant metal selected from iron, copper, zinc, manganese, chromium, calcium, potassium, sodium, magnesium, cobalt, nickel, molybdenum, vanadium, strontium, selenium, or any combination thereof.

Paragraph 3. The metal chelate of paragraphs 1-2, wherein M is a metal ion having a valency of at least two.

Paragraph 4. The metal chelate of paragraphs 1-3, wherein M is selected from an iron (II) ion, or an iron (III) ion.

Paragraph 5. The metal chelate of paragraphs 1-4, wherein a ligand is selected from an aliphatic hydroxy acid, cyclic hydroxy acid, carbohydrate, partially hydrolyzed or hydrolyzed protein, amino acid, oligopeptide, or any combinations thereof.

Paragraph 6. The metal chelate of paragraph 5, wherein the oligopeptide comprises from two amino acids to twenty amino acids.

Paragraph 7. The metal chelate of paragraph 6, wherein the oligopeptide comprises from two amino acids to eight amino acids.

Paragraph 8. A combination, comprising a metal chelate of paragraphs 1-7, and an additional component.

Paragraph 9. The combination of paragraph 8, wherein M is a metal ion having a valency of at least two.

Paragraph 10. The combination of paragraphs 8-9, wherein M is selected from iron (II) metal ion, or iron (III) metal ion.

Paragraph 11. The combination of paragraph 8, wherein a ligand of the metal chelate is selected from an aliphatic hydroxy acid, cyclic hydroxy acid, carbohydrate, partially hydrolyzed or hydrolyzed protein, amino acid, oligopeptide, or any combination thereof.

Paragraph 12. The combination of paragraph 11, wherein the oligopeptide of the ligand comprises from two amino acids to twenty amino acids.

Paragraph 13. The combination of paragraph 12, wherein the oligopeptide of the ligand comprises from two amino acids to eight amino acids.

Paragraph 14. The combination of paragraph 8, wherein the additional component is selected from a carrier, a copper salt, a probiotic, a vitamin, a feed, a feed supplement, a growth promotant, a preservative, an antimicrobial, a vaccine, or any combination thereof.

Paragraph 15. The combination of paragraph 14, wherein the carrier comprises plant material, a carbonate, sulfate, lactate, oxide, propionate, stearate, phosphate, mineral, copper species, sugar, salt, animal protein product, forage product, grain product, plant protein product, processed grain product, roughage product, molasses product, or combinations thereof.

Paragraph 16. The combination of paragraph 14, wherein the vitamin is selected from vitamin A, vitamin B₁, vitamin B₂, vitamin B₃, vitamin B₅, vitamin B₆, vitamin B₁₂, vitamin C, vitamin D, vitamin E, vitamin K, or a combination thereof.

Paragraph 17. The combination of paragraph 14, wherein the probiotic is a Bacilli combination.

Paragraph 18. The combination of paragraph 17, wherein the Bacilli combination comprises three or four Bacilli species selected from Bacillus coagulans, Bacillus subtilis, Bacillus licheniformis and Bacillus amyloliquefaciens.

Paragraph 19. The combination of paragraph 14, wherein the copper salt is copper chloride, copper bromide, copper iodide, copper sulfate, copper sulfite, copper bisulfite, copper thiosulfate, copper phosphate, monobasic copper phosphate, dibasic copper phosphate, copper hypophosphite, copper dihydrogen pyrophosphate, copper tetraborate, copper borate, copper carbonate, copper bicarbonate, copper metasilicate, copper citrate, copper malate, copper methionate, copper succinate, copper lactate, copper formate, copper acetate, copper butyrate, copper propionate, copper benzoate, copper tartrate, copper ascorbate, copper gluconate, or a combination thereof.

Paragraph 20. The combination of paragraph 14, wherein the feed supplement comprises:
Yucca;
Quillaja;
endoglucanohydrolase;
Yucca and Quillaja;
silica, mineral clay, glucan, and mannans; or
a combination thereof.

Paragraph 21. The combination of paragraph 20, wherein the feed supplement further comprises: allicin, alliin, alliinase, yeast, polyphenols, or a combination thereof.

Paragraph 22. The combination of claim 14, wherein the preservative is selected from sorbic acid, or a salt thereof.

Paragraph 23. The combination of paragraph 14, wherein the antimicrobial is an antibiotic, an antifungal, an antiparasitic, an anticoccidal, an antiviral, or a combination thereof.

Paragraph 24. The combination of paragraphs 8-14, wherein the combination is formulated for administration to an animal.

Paragraph 25. The combination of paragraph 24, wherein the animal is a non-human animal.

Paragraph 26. The combination of paragraph 25, wherein the animal is a land animal.

Paragraph 27. The combination of paragraph 26, wherein the land animal is a mammal.

Paragraph 28. The combination of paragraph 27, wherein the mammal is a ruminant or ungulate.

Paragraph 29. The combination of paragraphs 27-28, wherein the mammal is a sheep, a goat, a cow, a deer, a bison, an elk, an alpaca, a camel, a llama, a horse, a donkey, or a pig.

Paragraph 30. The combination of paragraph 25, wherein the animal is an aquatic animal.

Paragraph 31. The combination of paragraph 30, wherein the aquatic animal is a fish, crustacean, or a mollusk.

Paragraph 32. The combination of paragraph 31, wherein the fish is a salmon, trout, tilapia, sea bream, carp, cod, halibut, snapper, herring, catfish, flounder, hake, smelt, anchovy, lingcod, moi, perch, orange roughy, bass, tuna, mahi mahi, mackerel, eel, barracuda, marlin, Atlantic ocean perch, Nile perch, Arctic char, haddock, hoki, Alaskan Pollock, turbot, freshwater drum, walleye, skate, sturgeon, Dover sole, common sole, wolfish, sablefish, American shad, John Dory, grouper, monkfish, pompano, lake whitefish, tilefish, wahoo, cusk, bowfin, kingklip, opah, mako shark, swordfish, cobia, croaker, or hybrids thereof.

Paragraph 33. The combination of paragraph 31, wherein the crustacean is a lobster, shrimp, prawns, crab, krill, crayfish, barnacles, or copepods.

Paragraph 34. The combination of paragraph 31, wherein the mollusk is a squid, octopus, abalone, conch, rock snail, whelk, clam, oyster, mussel, or cockle.

Paragraph 35. The combination of paragraph 25, wherein the animal is an avian.

Paragraph 36. The combination of paragraph 35, wherein the avian is a laying hen, chicken, turkey, goose, duck, Cornish game hen, quail, partridge, pheasant, guinea-fowl, ostrich, emu, swan, or pigeon.

Paragraph 37. A method, comprising administering the metal chelates of paragraphs 1-7, or the combination of paragraph 8 to an animal.

Paragraph 38. The method of paragraph 37, wherein the animal is a non-human animal.

Paragraph 39. The method of paragraph 38, wherein the animal is a land animal.

Paragraph 40. The method of paragraph 39, wherein the land animal is a mammal.

Paragraph 41. The method of paragraph 40, wherein the mammal is a ruminant or ungulate.

Paragraph 42. The method of paragraphs 40-41, wherein the mammal is a sheep, a goat, a cow, a deer, a bison, an elk, an alpaca, a camel, a llama, a horse, a donkey, or a pig.

Paragraph 43. The method of paragraph 38, wherein the animal is an aquatic animal.

Paragraph 44. The method of paragraph 43, wherein the aquatic animal is a fish, crustacean, or a mollusk.

Paragraph 45. The method of paragraph 44, wherein the fish is a salmon, trout, tilapia, sea bream, carp, cod, halibut, snapper, herring, catfish, flounder, hake, smelt, anchovy, lingcod, moi, perch, orange roughy, bass, tuna, mahi mahi, mackerel, eel, barracuda, marlin, Atlantic ocean perch, Nile perch, Arctic char, haddock, hoki, Alaskan Pollock, turbot, freshwater drum, walleye, skate, sturgeon, Dover sole, common sole, wolfish, sablefish, American shad, John Dory, grouper, monkfish, pompano, lake whitefish, tilefish, wahoo, cusk, bowfin, kingklip, opah, mako shark, swordfish, cobia, croaker, or hybrids thereof.

Paragraph 46. The method of paragraph 44, wherein the crustacean is a lobster, shrimp, prawns, crab, krill, crayfish, barnacles, or copepods.

Paragraph 47. The method of paragraph 44, wherein the mollusk is a squid, octopus, abalone, conch, rock snail, whelk, clam, oyster, mussel, or cockle.

Paragraph 48. The method of paragraph 38, wherein the animal is an avian.

Paragraph 49. The method of paragraph 48, wherein the avian is a laying hen, chicken, turkey, goose, duck, Cornish game hen, quail, partridge, pheasant, guinea-fowl, ostrich, emu, swan, or pigeon.

Paragraph 50. A method, comprising making the metal chelate of paragraphs 1-7, wherein the method comprises the steps of:

reacting a metal complex with a ligand in the presence of a base.

Paragraph 51. The method of paragraph 50, wherein the ligand is selected from aliphatic hydroxy acids, cyclic hydroxy acids, carbohydrates, partially hydrolyzed or hydrolyzed proteins, amino acids, oligopeptides, or any combinations thereof.

Paragraph 52. The method of paragraph 50, wherein the metal complex is selected from iron (II) ion, or iron (III) ion.

Paragraph 53. A method, comprising:

reacting a metal complex with a ligand in the presence of a base to form a metal chelate, wherein
the ligand is selected from aliphatic hydroxy acids, cyclic hydroxy acids, carbohydrates, partially hydrolyzed or hydrolyzed proteins, amino acids, oligopeptides, or any combinations thereof;
the metal complex comprises a metal ion having a valency of at least two, the metal ion being selected from an iron (II) ion or an iron (III) ion; and
the metal chelate has a structure satisfying any one or more formulas:

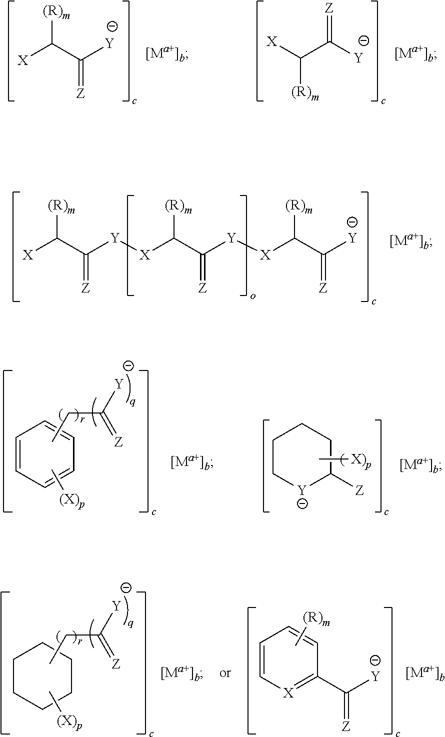

and, wherein
m can be 0, 1, or 2;
r, p and q can independently be 0, 1, 2, 3, 4, or 5; and
o is 0, 1, 2, 3, 4, 5, 6, 7, 8, 9, 10, 11, 12, 13, 14, 15, 16, 17, 18, 19 or 20;
a is 2 or 3;
b is 1 or 2;
c is 1, 2, or 3;
X can be selected from —C(R¹)₃, OH, CO₂¹, CO₂H, OR², NH₂, NR²H, NR²R³, —(C(R¹)₂)ONO₂, —(C(R¹)₂)ₙNO₂, SH, SR² wherein each R¹, R² and R³ independently is selected from hydrogen, aliphatic, haloaliphatic, haloheteroaliphatic, heteroaliphatic, aromatic, aliphatic-aromatic, heteroaliphatic-aromatic or any combination thereof, and n is 1 to 6;
Y is NH, NR³, NH₂, NHR³, NR³R⁴, SH, OR³, OH wherein R³ and R⁴ can independently be selected from aliphatic, haloaliphatic, haloheteroaliphatic, heteroaliphatic, aromatic, aliphatic-aromatic, heteroaliphatic-aromatic or any combination thereof, or —Y—X— is —NR¹-bond-;
Z can be selected from O, S, NH, NR⁵ wherein R⁵ can be selected from hydrogen, halogen, aliphatic, haloaliphatic, haloheteroaliphatic, heteroaliphatic, aromatic, aliphatic-aromatic, heteroaliphatic-aromatic or any combination thereof, and
each R can independently be selected from halogen, aliphatic, haloaliphatic, haloheteroaliphatic, heteroaliphatic, aromatic, aliphatic-aromatic, heteroaliphatic-aromatic or any combination thereof, and
M can be at least a biologically or a nutritionally relevant metal selected from iron, copper, zinc, manganese, chromium, calcium, potassium, sodium, magnesium, cobalt, nickel, molybdenum, vanadium, strontium, selenium, or any combination thereof,

combining the metal chelate with at least one additional component, wherein the additional component is selected from a carrier, a copper salt, a probiotic, a vitamin, a feed, a feed supplement, a growth promotant, a preservative, an antimicrobial, a vaccine, or any combination thereof, and

administering the combination to an animal to provide a beneficial result in the animal compared to an animal not administered the combination, wherein the beneficial result comprises:
prevention of a mineral-deficiency disease, infectious disease, a non-infectious disease, stress, a stress-related condition or disease;
treatment of a mineral-deficiency disease, infectious disease, a non-infectious disease, stress, a stress-related condition or disease;
a beneficial effect on the animal's immune system;
an increase in the longevity of the animal; or
a combination thereof.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A combination and/or composition comprising silica, mineral clay, glucan, mannans, Yucca, Quillaja, a probiotic, or a combination thereof, and a metal chelate.

2. The combination and/or composition of claim 1, wherein the metal chelate is ferric tyrosinate, ferric citrate, ferric lactate, ferric lysine, ferric proteinate with hydrolyzed soy protein, or a combination thereof.

3. The combination and/or composition of claim 2, comprising silica, mineral clay, glucan, and mannans.

4. The combination and/or composition of claim 3, further comprising an endoglucanohydrolase.

5. The combination and/or composition of claim 2, comprising Yucca and Quillaja.

6. The combination and/or composition of claim 2, comprising a Bacillus species.

7. The combination and/or composition of claim 6, wherein the Bacillus species comprises Bacillus subtilis, Bacillus licheniformis, and Bacillus amyloliquefaciens.
